(19) United States
(12) Patent Application Publication
(10) Pub. No.: US 2022/0100110 A1
(43) Pub. Date: Mar. 31, 2022

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Yuko IWASHITA, Osaka-shi (JP); Kazunari HAMASAKI, Osaka-shi (JP)

(73) Assignee: KYOCERA Document Solutions Inc., Osaka (JP)

(21) Appl. No.: 17/481,401

(22) Filed: Sep. 22, 2021

(30) Foreign Application Priority Data
Sep. 28, 2020 (JP) 2020-162013
Sep. 28, 2020 (JP) 2020-162014
Sep. 28, 2020 (JP) 2020-162015

(51) Int. Cl. G03G 5/047; G03G 5/05; G03G 5/06

(52) U.S. Cl. CPC G03G 5/047; G03G 5/0564; G03G 5/0631; G03G 2215/0402; G03G 5/06142; G03G 2215/00962; G03G 5/0675

(57) ABSTRACT

An electrophotographic photosensitive member includes a conductive substrate and a photosensitive layer. The photosensitive layer is a single layer, and contains a charge generating material, an electron transport material, a binder resin, and a hole transport material.

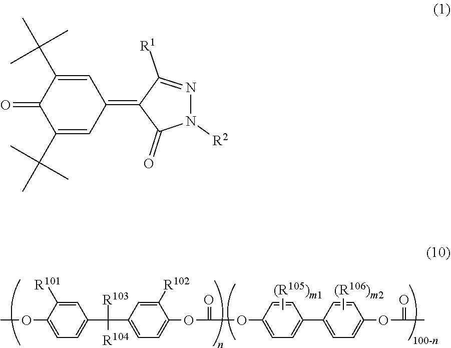

The electron transport material includes a compound represented by general formula (1). The binder resin includes a polycarbonate resin having an end group and a main chain represented by general formula (10).

### INCORPORATION BY REFERENCE

The present application claims priority under 35 U.S.C. § 119 to Japanese Patent Applications No. 2020-162013, filed on Sep. 28, 2020, No. 2020-162014, filed on Sep. 28, 2020, and No. 2020-162015, filed on Sep. 28, 2020. The contents of these applications are incorporated herein by reference in their entirety.

### BACKGROUND

The present disclosure relates to an electrophotographic photosensitive member, a process cartridge, and an image forming apparatus.

An electrophotographic image forming apparatus (e.g., a printer or a multifunction peripheral) includes an electrophotographic photosensitive member as an image bearing member. The electrophotographic photosensitive member includes a photosensitive layer. An image forming apparatus is known that includes an electrophotographic photosensitive member including a photosensitive layer that is at least a surface layer thereof containing a bisphenol Z polycarbonate resin that is a binder resin.

### SUMMARY

An electrophotographic photosensitive member according to an aspect of the present disclosure includes a conductive substrate and a photosensitive layer. The photosensitive layer is a single layer, and contains a charge generating material, an electron transport material, a binder resin, and a hole transport material. The electron transport material includes a compound represented by general formula (1). The binder resin includes a polycarbonate resin having an end group and a main chain represented by general formula (10).

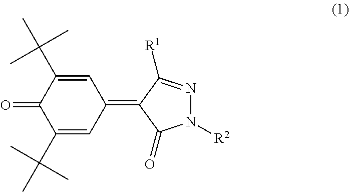

In general formula (1), R¹ and R² each represent, independently of one another, a hydrogen atom, an alkyl group, a heterocyclic group, an alkoxy group, an aralkyl group, an allyl group, or an aryl group optionally substituted with at least 1 and no more than 5 substituents selected from the group consisting of a halogen atom, an alkyl group, and an alkoxy group.

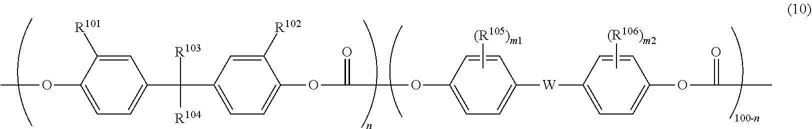

In general formula (10), R¹⁰¹, R¹⁰², R¹⁰³, and R¹⁰⁴ each represent, independently of one another, a hydrogen atom, an alkyl group having a carbon number of at least 1 and no greater than 3 that is optionally substituted with a halogen atom, or an aryl group having a carbon number of at least 6 and no greater than 14. R¹⁰³ and R¹⁰⁴ may be bonded to each other to represent a bivalent group represented by general formula (X). R¹⁰⁵ and R¹⁰⁶ each represent an alkyl group having a carbon number of at least 1 and no greater than 3. m1 and m2 each represent, independently of one another, 0 or 1. W represents a single bond, —O—, or —CO—. n represents a number of greater than 0 and no greater than 100. Where n represents 100, the end group is a first end group having a halogen atom. Where n represents a number of greater than 0 and less than 100, the end group is the first end group having a halogen atom or a second end group having no halogen atom.

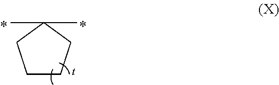

In general formula (X), t represents an integer of at least 1 and no greater than 3.

A process cartridge according to another aspect of the present disclosure includes the aforementioned electrophotographic photosensitive member and at least one selected from the group consisting of a charger, a light exposure device, a development device, a transfer device, a cleaning member, and a static eliminator.

An image forming apparatus according to still another aspect of the present disclosure includes an image bearing member, a charger, a light exposure device, a development device, and a transfer device. The charger charges a surface of the image bearing member to a positive polarity. The light exposure device exposes the charged surface of the image bearing member to light to form an electrostatic latent image on the surface of the image bearing member. The development device develops the electrostatic latent image into a toner image. The transfer device transfers the toner image to a transfer target from the image bearing member. The image bearing member is the aforementioned electrophotographic photosensitive member.

### BRIEF DESCRIPTION OF THE DRAWINGS

FIG. 1 is a partial cross-sectional view of an example of an electrophotographic photosensitive member according to a first embodiment of the present disclosure.

FIG. 2 is a partial cross-sectional view of an example of the electrophotographic photosensitive member according to the first embodiment of the present disclosure.

FIG. 3 is a partial cross-sectional view of an example of the electrophotographic photosensitive member according to the first embodiment of the present disclosure.

FIG. 4 is a cross-sectional view of an example of an image forming apparatus according to a second embodiment of the present disclosure.

FIG. 5 is a diagram illustrating an image bearing member and a cleaning member each illustrated in FIG. 4, and a controller.

FIG. 6 is a time chart illustrating control of the cleaning member in a printing mode and a cleaning mode.

FIG. 7 is a flowchart depicting control of the image forming apparatus illustrated in FIG. 4.

### DETAILED DESCRIPTION

The following describes embodiments of the present disclosure in detail. The present disclosure is not in any way limited by the following embodiments and appropriate alterations may be made in practice within the intended scope of the present disclosure. In the following description, the term “-based” may be appended to the name of a chemical compound to form a generic name encompassing both the chemical compound itself and derivatives thereof. When the term “-based” is appended to the name of a chemical compound used in the name of a polymer, the term indicates that a repeating unit of the polymer originates from the chemical compound or a derivative thereof. The words “each represent, independently of one another” in description of general formulas mean representing the same as or different from one another. In addition, in general formulas and chemical formulas represents a bond. Any one type of each component described in the present specification may be used independently or any two or more types of the component may be used in combination.

Description will be made first of substituents used in the present specification. Examples of a halogen atom (halogen group) include a fluorine atom (fluoro group), a chlorine atom (chloro group), a bromine atom (bromo group), and an iodine atom (iodine group).

An alkyl group having a carbon number of at least 1 and no greater than 8, an alkyl group having a carbon number of at least 1 and no greater than 6, an alkyl group having a carbon number of at least 1 and no greater than 4, and an alkyl group having a carbon number of at least 1 and no greater than 3 each are an unsubstituted straight chain or branched chain alkyl group unless otherwise stated. Examples of the alkyl group having a carbon number of at least 1 and no greater than 8 include a methyl group, an ethyl group, an n-propyl group, an isopropyl group, an n-butyl group, a sec-butyl group, a tert-butyl group, an n-pentyl group, a 1-methyl butyl group, a 2-methyl butyl group, a 3-methyl butyl group, a 1-ethyl propyl group, a 2-ethyl propyl group, a 1,1-dimethyl propyl group, a 1,2-dimethyl propyl group, a 2,2-dimethyl propyl group, an n-hexyl group, a 1-methyl pentyl group, a 2-methyl pentyl group, a 3-methyl pentyl group, a 4-methyl pentyl group, a 1,1-dimethyl butyl group, a 1,2-dimethyl butyl group, a 1,3-dimethyl butyl group, a 2,2-dimethyl butyl group, a 2,3-dimethyl butyl group, a 3,3-dimethyl butyl group, a 1,1,2-trimethyl propyl group, a 1,2,2-trimethyl propyl group, a 1-ethyl butyl group, a 2-ethyl butyl group, and a 3-ethyl butyl group, a straight chain or branched chain heptyl group, and a straight chain or branched chain octyl group. Examples of the alkyl group having a carbon number of at least 1 and no greater than 6, examples of the alkyl group having a carbon number of at least 1 and no greater than 4, and examples of the alkyl group having a carbon number of at least 1 and no greater than 3 are groups having a corresponding carbon number among the groups listed as the examples of the alkyl group having a carbon number of at least 1 and no greater than 8.

An alkoxy group having a carbon number of at least 1 and no greater than 8, an alkoxy group having a carbon number of at least 1 and no greater than 6, and an alkoxy group having a carbon number of at least 1 and no greater than 3 each are an unsubstituted straight chain or branched chain alkoxy group unless otherwise stated. Examples of the alkoxy group having a carbon number of at least 1 and no greater than 8 include a methoxy group, an ethoxy group, an n-propoxy group, an isopropoxy group, an n-butoxy group, a sec-butoxy group, a tert-butoxy group, an n-pentoxy group, a 1-methyl butoxy group, a 2-methyl butoxy group, a 3-methyl butoxy group, a 1-ethyl propoxy group, a 2-ethyl propoxy group, a 1,1-dimethyl propoxy group, a 1,2-dimethyl propoxy group, a 2,2-dimethyl propoxy group, an n-hexyloxy group, a 1-methyl pentyloxy group, a 2-methyl pentyloxy group, a 3-methyl pentyloxy group, a 4-methyl pentyloxy group, a 1,1-dimethyl butoxy group, a 1,2-dimethyl butoxy group, a 1,3-dimethyl butoxy group, a 2,2-dimethyl butoxy group, a 2,3-dimethyl butoxy group, a 3,3-dimethyl butoxy group, a 1,1,2-trimethyl propoxy group, a 1,2,2-trimethyl propoxy group, a 1-ethyl butoxy group, a 2-ethyl butoxy group, a 3-ethyl butoxy group, a straight chain or branched chain heptyloxy group, and a straight chain or branched chain octyloxy group. Examples of the alkoxy group having a carbon number of at least 1 and no greater than 6 and examples of the alkoxy group having a carbon number of at least 1 and no greater than 3 are groups having a corresponding carbon number among the groups listed as the examples of the alkoxy group having a carbon number of at least 1 and no greater than 8.

An aryl group having a carbon number of at least 6 and no greater than 14 and an aryl group having a carbon number of at least 6 and no greater than 10 each are an unsubstituted aryl group unless otherwise stated. Examples of the aryl group having a carbon number of at least 6 and no greater than 14 include a phenyl group, a naphthyl group, an indacenyl group, a biphenylenyl group, an acenaphthylenyl group, an anthryl group, and a phenanthryl group. Examples of the aryl group having a carbon number of at least 6 and no greater than 10 include a phenyl group and a naphthyl group.

An aralkyl group having a carbon number of at least 7 and no greater than 20 and an aralkyl group having a carbon number of at least 7 and no greater than 13 each are an unsubstituted aralkyl group unless otherwise stated. The aralkyl group having a carbon number of at least 7 and no greater than 20 is an alkyl group having a carbon number of at least 1 and no greater than 6 that is substituted with an aryl group having a carbon number of at least 6 and no greater than 14, for example. The aralkyl group having a carbon number of at least 7 and no greater than 13 is an alkyl group having a carbon number of at least 1 and no greater than 3 that is substituted with an aryl group having a carbon number of at least 6 and no greater than 10, for example.

A heterocyclic group having at least 5 members and no more than 14 members and a heterocyclic group having at least 5 members and no more than 6 members each are an unsubstituted heterocyclic group unless otherwise stated. Examples of the heterocyclic group having at least 5 members and no more than 14 members include: a monocyclic heterocyclic group having at least 5 members and no more than 6 members with at least 1 and no more than 3 hetero atoms besides carbon atoms; a heterocyclic group in which two monocyclic heterocycle rings such as above have been fused together; a heterocyclic group in which a monocyclic heterocyclic ring such as above and a monocyclic hydrocarbon ring having at least 5 members and no more than 6 members have been fused together; a heterocyclic group in which three monocyclic heterocyclic rings such as above have been fused together; a heterocyclic group in which two monocyclic heterocyclic rings such as above and one monocyclic hydrocarbon ring having at least 5 members and no more than 6 members have been fused together; and a heterocyclic group in which one monocyclic heterocyclic ring such as above and two monocyclic heterocyclic rings having at least 5 members and no more than 6 members have been fused together. Specific examples of the heterocyclic group having at least 5 members and no more than 14 members include a piperidinyl group, a piperazinyl group, a morpholinyl group, a thiophenyl group, a furanyl group, a pyrrolyl group, an imidazolyl group, a pyrazolyl group, an isothiazolyl group, an isoxazolyl group, an oxazolyl group, an isoxazolyl group, a thiazolyl group, an isothiazolyl group, a furazanyl group, a pyranyl group, a pyridyl group, a pyridazinyl, a pyrimidinyl group, a pyrazinyl group, an indolyl group, a 1H-indazolyl group, an isoindolyl group, a chromenyl group, a quinolinyl group, an isoquinolinyl group, a purinyl group, a pteridinyl group, a triazolyl group, a tetrazolyl group, a 4H-quinolizinyl group, a naphthyridinyl group, a benzofuranyl group, a 1,3-benzodioxolyl group, a benzoxazolyl group, a benzothiazolyl group, a benzimidazolyl group, a carbazolyl group, a phenanthridinyl group, an acridinyl group, a phenazinyl group, and a phenanthrolinyl group. Examples of the heterocyclic group having at least 5 members and no more than 6 members include groups having a corresponding ring member among the groups listed as the examples of the heterocyclic group having at least 5 members and no more than 14 members. The substituents used in the present specification have been described so far.

### First Embodiment: Electrophotographic Photosensitive Member

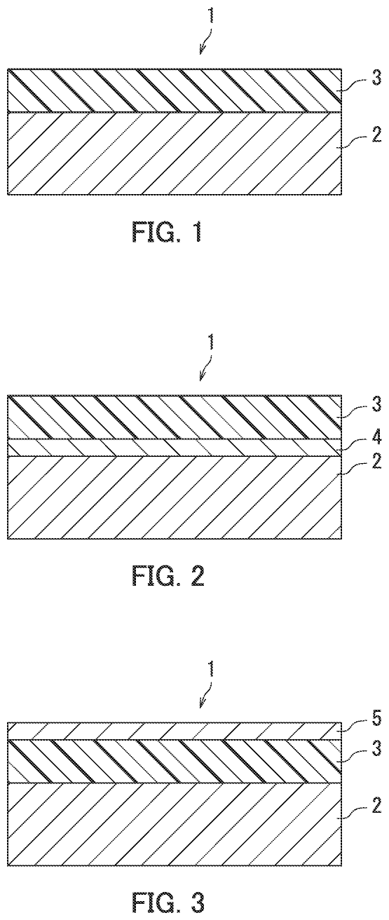

A first embodiment of the present disclosure relates to an electrophotographic photosensitive member (also referred to below as a photosensitive member). The following describes a structure of a photosensitive member 1 according to the first embodiment with reference to FIGS. 1 to 3. FIGS. 1 to 3 each are a partial cross-sectional view of the photosensitive member 1.

As illustrated in FIG. 1, the photosensitive member 1 includes a conductive substrate 2 and a photosensitive layer 3. The photosensitive layer 3 is a single layer. The photosensitive member 1 is a single-layer electrophotographic photosensitive member including the single-layer photosensitive layer 3.

As illustrated in FIG. 2, the photosensitive member 1 may further include an intermediate layer 4 (undercoat layer) in addition to the conductive substrate 2 and the photosensitive layer 3. The intermediate layer 4 is disposed between the conductive substrate 2 and the photosensitive layer 3. As illustrated in FIG. 1, the photosensitive layer 3 may be disposed directly on the conductive substrate 2. Alternatively, the photosensitive layer 3 may be disposed on the conductive substrate 2 with the intermediate layer 4 therebetween as illustrated in FIG. 2.

As illustrated in FIG. 3, the photosensitive member 1 may further include a protective layer 5 in addition to the conductive substrate 2 and the photosensitive layer 3. The protective layer 5 is disposed on the photosensitive layer 3. As illustrated in FIGS. 1 and 2, the photosensitive layer 3 may be provided as an outermost layer of the photosensitive member 1. Alternatively, the protective layer 5 may be provided as an outermost layer of the photosensitive member 1 as illustrated in FIG. 3.

The thickness of the photosensitive layer 3 is not limited specifically, but is preferably at least 5 μm and no greater than 100 μm, and more preferably at least 10 μm and no greater than 50 μm. The structure of the photosensitive member 1 has been described so far with reference to FIGS. 1 to 3.

Hereinafter, the photosensitive member will be described in detail. The photosensitive layer contains a charge generating material, an electron transport material, a binder resin, and a hole transport material. The photosensitive layer may contain an n-type pigment and an additive as necessary. The charge generating material, the electron transport material, the binder resin, the hole transport material, the n-type pigment, and the additive is described below.

(Charge Generating Material)

Examples of the charge generating material include phthalocyanine-based pigments, perylene-based pigments, bisazo pigments, trisazo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridon-based pigments.

Examples of the phthalocyanine-based pigments include metal-free phthalocyanine and metal phthalocyanine. Examples of the metal phthalocyanine include titanyl phthalocyanine, hydroxygallium phthalocyanine, and chlorogallium phthalocyanine. Metal-free phthalocyanine is represented by chemical formula (CGM-1). Titanyl phthalocyanine is represented by chemical formula (CGM-2).

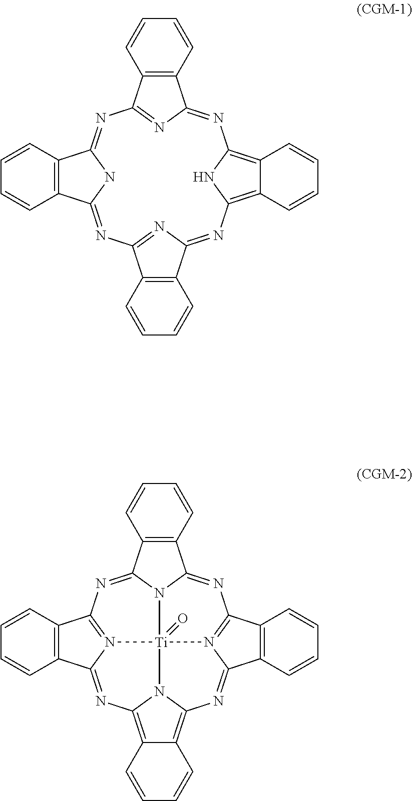

The phthalocyanine-based pigments may be crystalline or non-crystalline. An example of crystalline metal-free phthalocyanine is metal-free phthalocyanine having an X-form crystal structure (also referred to below as X-form metal-free phthalocyanine). An example of crystalline titanyl phthalocyanine is titanyl phthalocyanine having an α-form, β-form, or Y-form crystal structure (also referred to below as α-form, β-form, and Y-form titanyl phthalocyanine, respectively).

For example, in a digital optical image forming apparatus (e.g., a laser beam printer or facsimile machine that uses a light source such as a semiconductor laser), a photosensitive member that is sensitive to light in a wavelength range of 700 nm or longer is preferably used. Because a high quantum yield can be attained in a wavelength range of 700 nm or longer, the charge generating material is preferably a phthalocyanine-based pigment, more preferably metal-free phthalocyanine or titanyl phthalocyanine, further preferably X-form metal-free phthalocyanine or Y-form titanyl phthalocyanine, and particularly preferably Y-form titanyl phthalocyanine.

Y-form titanyl phthalocyanine exhibits a main peak at a Bragg angle (20±0.2°) of 27.2° in a CuKα characteristic X-ray diffraction spectrum, for example. The term main peak in a CuKα characteristic X-ray diffraction spectrum refers to a most intense or second most intense peak within a range of Bragg angles (20±0.2°) from 3° to 40°. Y-form titanyl phthalocyanine has no peak at 26.2° C. in the CuKα characteristic X-ray diffraction spectrum.

The CuKα characteristic X-ray diffraction spectrum can be measured by the following method, for example. First, a sample (titanyl phthalocyanine) is loaded into a sample holder of an X-ray diffraction spectrometer (e.g., “RINT (registered Japanese trademark) 1100”, product of Rigaku Corporation) and an X-ray diffraction spectrum is measured using a Cu X-ray tube under conditions of a tube voltage of 40 kV, a tube current of 30 mA, and a wavelength of CuKα characteristic X-rays of 1.542 Å. The measurement range (20) is for example 3° to 40° (start angle 3°, stop angle 40°), and the scanning speed is for example 10°/min. A main peak in the obtained X-ray diffraction spectrum is determined and a Bragg angle of the main peak is read from the X-ray diffraction spectrum.

The content of the charge generating material is preferably at least 0.1 parts by mass and no greater than 50 parts by mass relative to 100 parts by mass of the binder resin, and more preferably at least 1 part by mass and no greater than 10 parts by mass.

(Electron Transport Material)

The electron transport material includes a compound represented by general formula (1) (also referred to below as electron transport material (1)).

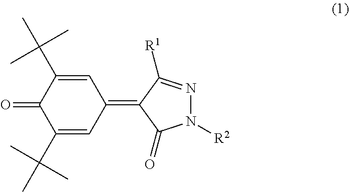

In general formula (1), R¹ and R² each represent, independently of one another, a hydrogen atom, an alkyl group, a heterocyclic group, an alkoxy group, an aralkyl group, an allyl group, or an aryl group optionally substituted with at least 1 and no more than 5 substituents selected from the group consisting of a halogen atom, an alkyl group, and an alkoxy group.

As a result of the photosensitive layer containing the electron transport material (1), the photosensitive member can be favorably charged to a positive polarity even when positive charging and negative charging of the photosensitive member alternately transition. A photosensitive member such as above is especially favorably applicable to a later-described image forming apparatus according to a second embodiment. Specifically, it is particularly favorably applicable to an image forming apparatus with a configuration in which a charger charges the surface of a photosensitive member to a positive polarity and a negative first voltage (voltage of opposite polarity to the charge polarity of a toner) is applied to a cleaning member in a printing mode. When such an image forming apparatus is provided with a photosensitive member, alternate transition occurs in the printing mode between charging of the surface of the photosensitive member to the positive polarity by the charger and decrease in potential of the photosensitive member to the negative polarity due to the surface of the photosensitive member being in contact with the cleaning member to which the negative first voltage is applied. As such, the photosensitive member alternately repeats positive charging and negative charging. As described previously, the photosensitive member of the first embodiment is favorably charged to the positive polarity even when positive charging and negative charging alternately transition. Therefore, the photosensitive member of the first embodiment can be favorably charged to a desired positive potential in charging for image formation even when provided in the image forming apparatus of the second embodiment.

The aryl group represented by R¹ or R² in general formula (1) is an aryl group having a carbon number of at least 6 and no greater than 14, for example. The aryl group having a carbon number of at least 6 and no greater than 14 is preferably a phenyl group or a naphthyl group. The naphthyl group is preferably a 1-naphthyl group or a 2-naphthyl group.

The aryl group represented by R¹ or R² may be substituted with at least 1 and no more than 5 substituents selected from the group consisting of a halogen atom, an alkyl group, and an alkoxy group. The halogen atom being a substituent is preferably a chlorine atom or a bromine atom. The alkyl group being a substituent is preferably an alkyl group having a carbon number of at least 1 and no greater than 6, more preferably an alkyl group having a carbon number of at least 1 and no greater than 3, and further preferably a methyl group. The alkoxy group being a substituent is preferably an alkoxy group having a carbon number of at least 1 and no greater than 6, more preferably an alkoxy group having a carbon number of at least 1 and no greater than 3, and further preferably a methoxy group. The group consisting of a halogen atom, an alkyl group, and an alkoxy group is preferably a group consisting of a halogen atom, an alkyl group having a carbon number of at least 1 and no greater than 6, and an alkoxy group having a carbon number of at least 1 and no greater than 6, more preferably a group consisting of a halogen atom, an alkyl group having a carbon number of at least 1 and no greater than 3, and an alkoxy group having a carbon number of at least 1 and no greater than 3, and particularly preferably a group consisting of a chlorine atom, a bromine atom, a methyl group, and a methoxy group. The number of substituents that the aryl group represented by R¹ or R² has is preferably 1 or 2.

The alkyl group represented by R¹ or R² is an alkyl group having a carbon number of at least 1 and no greater 6, for example. The alkyl group having a carbon number of at least 1 and no greater than 6 is preferably an alkyl group having a carbon number of at least 1 and no greater than 4, and more preferably a methyl group, an n-propyl group, or a tert-butyl group.

The heterocyclic group represented by R¹ or R² is a heterocyclic group having a least 5 members and no more than 14 members, for example. The heterocyclic group having at least 5 members and no more than 14 members is preferably a heterocyclic group having at least 5 members and no more than 14 members with at least 1 hetero atom besides at least a carbon atom, more preferably a heterocyclic group having at least 5 members and no more than 6 members with at least 1 hetero atom besides at least a carbon atom, and further preferably a monocyclic heterocyclic group having at least 5 members and no more than 6 members with at least 1 hetero atoms besides at least a carbon atom. The hetero atom is preferably at least one selected from the group consisting of a nitrogen atom, a sulfur atom, and an oxygen atom, more preferably at least one selected from the group consisting of a sulfur atom and an oxygen atom, and further preferably a sulfur atom or an oxygen atom. The heterocyclic group having at least 5 members and no more than 14 members is further preferably a thiophenyl group or a furanyl group, and particularly preferably a 2-thiophenyl group or a 2-furanyl group.

The alkoxy group represented by R¹ or R² is an alkoxy group having a carbon number of at least 1 and no greater 6, for example. The alkoxy group having a carbon number of at least 1 and no greater than 6 is preferably an alkoxy group having a carbon number of at least 1 and no greater than 3, and is more preferably a methoxy group.

The aralkyl group represented by R¹ or R² is an aralkyl group having a carbon number of at least 7 and no greater 20, for example. The aralkyl group having a carbon number of at least 7 and no greater than 20 is preferably an aralkyl group having a carbon number of at least 7 and no greater than 13, and more preferably a benzyl group, a phenylethyl group, or a naphthylmethyl group.

The allyl group represented by R¹ or R² is represented by chemical formula “CH₂═CH—CH₂—”.

In order to increase abrasion resistance and positive chargeability when positive charging and negative charging alternately transition, preferably, R¹ and R² in general formula (1) each represent, independently of one another: an aryl group having a carbon number of at least 6 and no greater than 14 that is optionally substituted with at least 1 and no more than 5 substituents selected from the group consisting of a halogen atom, an alkyl group having a carbon number of at least 1 and no greater than 6, and an alkoxy group having a carbon number of at least 1 and no greater than 6; an alkyl group having a carbon number of at least 1 and no greater than 6; or a heterocyclic group having at least 5 members and no more than 14 members. For the same purpose as above, it is more preferable that R¹ in general formula (1) represents: an aryl group having a carbon number of at least 6 and no greater than 14; an alkyl group having a carbon number of at least 1 and no greater than 6; or a heterocyclic group having at least 5 members and no more than 14 members, and R² represents: an aryl group having a carbon number of at least 6 and no greater than 14 that is optionally substituted with 1 or 2 substituents selected from the group consisting of a halogen atom, an alkyl group having a carbon number of at least 1 and no greater than 6, and an alkoxy group having a carbon number of at least 1 and no greater than 6; or an alkyl group having a carbon number of at least 1 and no greater than 6.

In order to increase abrasion resistance and positive chargeability when positive charging and negative charging alternately transition, preferably, R¹ and R² in general formula (1) each represent, independently of one another: an aryl group having a carbon number of at least 6 and no greater than 14 that is optionally substituted with 1 or 2 halogen atoms; or an alkyl group having a carbon number of at least 1 and no greater than 6. For the same purpose as above, it is more preferable in general formula (1) that R¹ represents: an aryl group having a carbon number of at least 6 and no greater than 14; or an alkyl group having a carbon number of at least 1 and no greater than 6, and R² represents: an aryl group having a carbon number of at least 6 and no greater than 14 that is optionally substituted with 1 or 2 halogen atoms; or an alkyl group having a carbon number of at least 1 and no greater than 6.

Preferable examples of the electron transport material (1) to increase abrasion resistance and positive chargeability when positive charging and negative charging alternately transition includes compounds represented by chemical formulas (ETM1) to (ETM31) (also referred to below as electron transport materials (ETM1) to (ETM31), respectively).

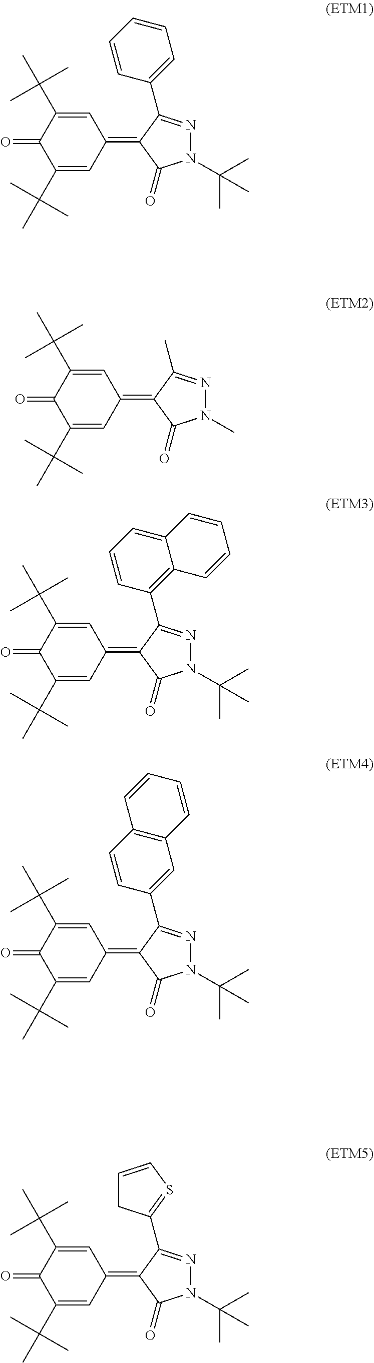

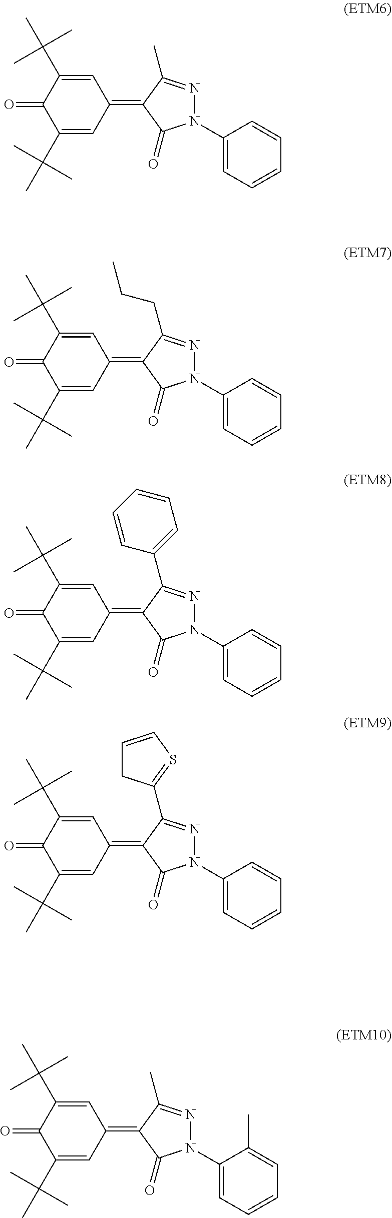

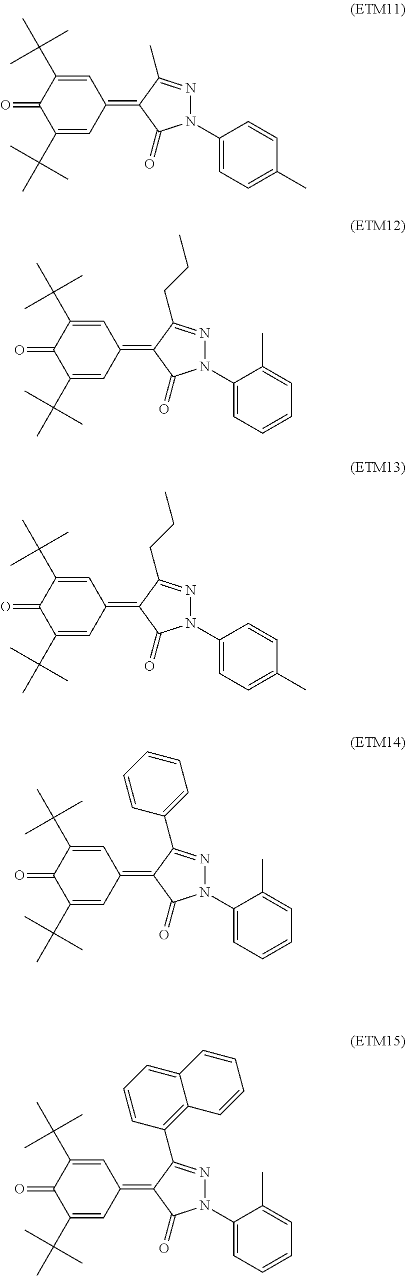 [SMILES: CC1=NN(c2ccc(C)cc2)C(=O)C1=C1C=C(C(C)(C)C)C(=O)C(C(C)(C)C)=C1 ; CCCC1=NN(c2ccccc2C)C(=O)C1=C1C=C(C(C)(C)C)C(=O)C(C(C)(C)C)=C1 ; CCCC1=NN(c2ccc(C)cc2)C(=O)C1=C1C=C(C(C)(C)C)C(=O)C(C(C)(C)C)=C1 ; Cc1ccccc1N1N=C(c2ccccc2)C(=C2C=C(C(C)(C)C)C(=O)C(C(C)(C)C)=C2)C1=O ; Cc1ccccc1N1N=C(c2cccc3ccccc23)C(=C2C=C(C(C)(C)C)C(=O)C(C(C)(C)C)=C2)C1=O]

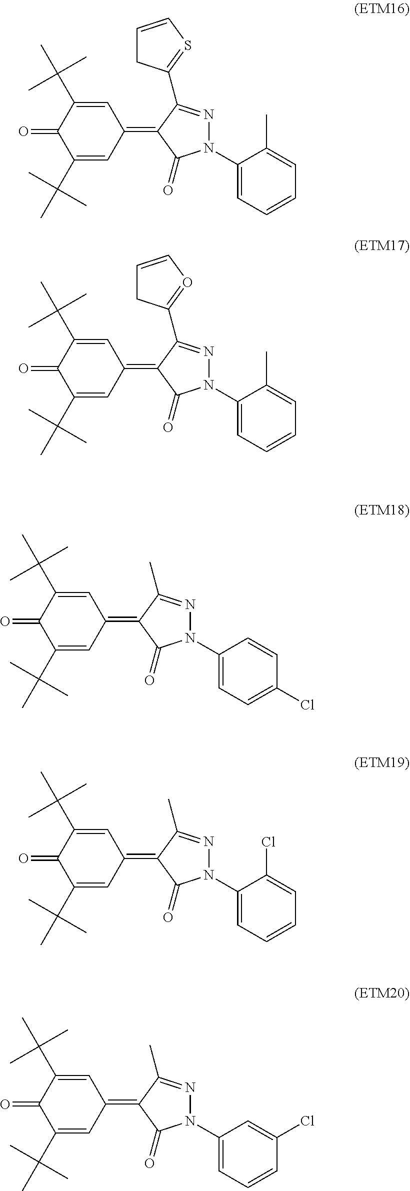

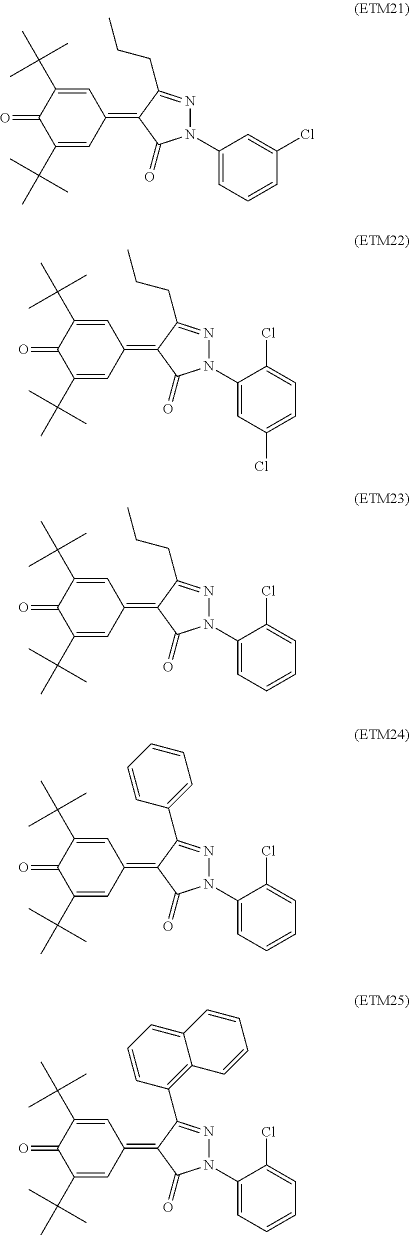 [SMILES: CCCC1=NN(c2cccc(Cl)c2)C(=O)C1=C1C=C(C(C)(C)C)C(=O)C(C(C)(C)C)=C1 ; CCCC1=NN(c2cc(Cl)ccc2Cl)C(=O)C1=C1C=C(C(C)(C)C)C(=O)C(C(C)(C)C)=C1 ; CCCC1=NN(c2ccccc2Cl)C(=O)C1=C1C=C(C(C)(C)C)C(=O)C(C(C)(C)C)=C1 ; CC(C)(C)C1=CC(=C2C(=O)N(c3ccccc3Cl)N=C2c2ccccc2)C=C(C(C)(C)C)C1=O ; CC(C)(C)C1=CC(=C2C(=O)N(c3ccccc3Cl)N=C2c2cccc3ccccc23)C=C(C(C)(C)C)C1=O]

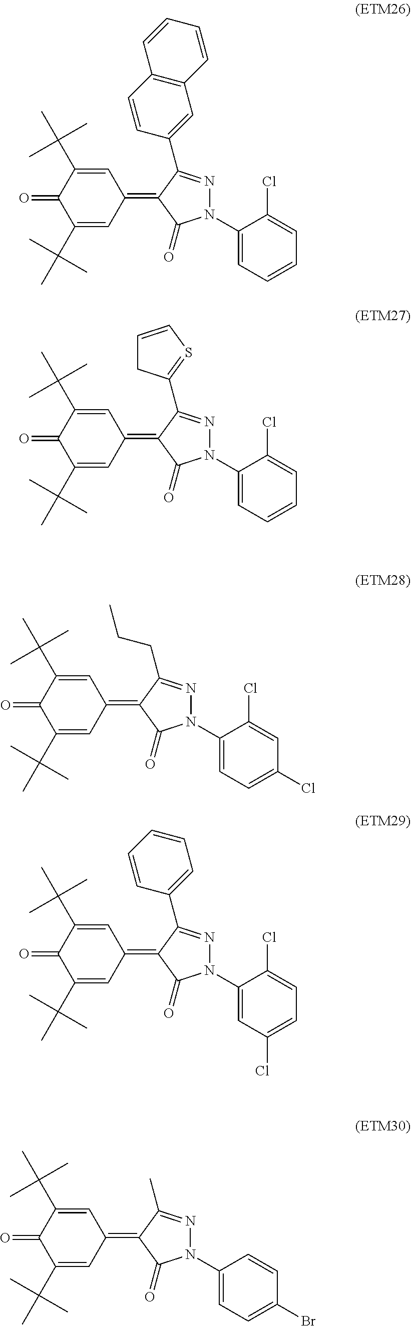

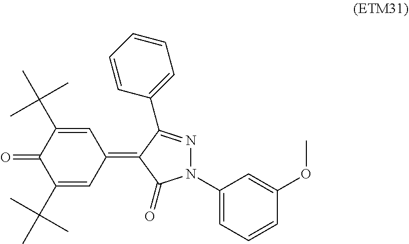 [SMILES: COc1cccc(N2N=C(c3ccccc3)C(=C3C=C(C(C)(C)C)C(=O)C(C(C)(C)C)=C3)C2=O)c1]

Further preferable examples of the electron transport material (1) to increase abrasion resistance and positive chargeability when positive charging and negative charging alternately transition include the electron transport materials (ETM1), (ETM2), (ETM6), (ETM7), (ETM8), (ETM19), (ETM22), (ETM23), (ETM24), (ETM28), and (ETM29).

The content of the electron transport material is preferably at least 5 parts by mass and no greater than 150 parts by mass relative to 100 parts by mass of the binder resin, more preferably at least 10 parts by mass and no greater than 80 parts by mass, and further preferably at least 20 parts by mass and no greater than 60 parts by mass.

The photosensitive layer may contain only the electron transport material (1) as the electron transport material. Alternatively, the photosensitive layer may further contain, in addition to the electron transport material (1), an electron transport material other than the electron transport material (1) as the electron transport material. Examples of the electron transport material other than the electron transport material (1) include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds.

(Binder Resin)

The binder resin includes a polycarbonate resin having an end group and a main chain represented by general formula (10).

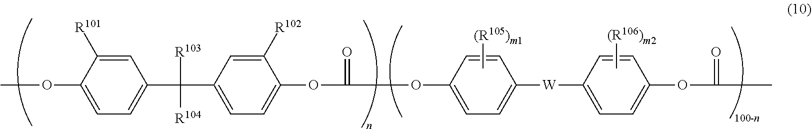

In general formula (10), R¹⁰¹, R¹⁰², R¹⁰³, and R¹⁰⁴ each represent, independently of one another, a hydrogen atom, an aryl group having a carbon number of at least 6 and no greater than 14, or an alkyl group having a carbon number of at least 1 and no greater than 3 that is optionally substituted with a halogen atom. R¹⁰³ and R¹⁰⁴ may be bonded to each other to represent a bivalent group represented by general formula (X). R¹⁰⁵ and R¹⁰⁶ each represent an alkyl group having a carbon number of at least 1 and no greater than 3. m1 and m2 each represent, independently of one another, 0 or 1. W represents a single bond, —O—, or —CO—. n represents a number of greater than 0 and no greater than 100. Where n represents 100, the end group is a first end group having a halogen atom. Where n represents a number of greater than 0 and less than 100, the end group is the first end group having a halogen atom or a second end group having no halogen atom. In general formula (X), t represents an integer of at least 1 and no greater than 3.

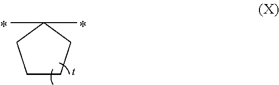

In the following, the “main chain represented by general formula (10)” may be also referred to below as “main chain (10)”. Furthermore, the “polycarbonate having an end group and a main chain represented by general formula (10), the end group being the first group having a halogen atom where n in general formula (10) represents 100, the end group being the first end group having a halogen atom or the second end group having no halogen atom where n represents a number of greater than 0 and less than 100” may be also referred to below as “polycarbonate resin (PC)”. A “repeating unit represented by general formula (11)” and a “repeating unit represented by general formula (12)” each included in the general formula (10) may be also referred to below as “repeating unit (11)” and “repeating unit “12”, respectively. In general formulas (11) and (12), R¹⁰¹ to R¹⁰⁶, m1, m2, and W are respectively the same as R¹⁰¹ to R¹⁰⁶, m1, m2, and W defined in general formula (10).

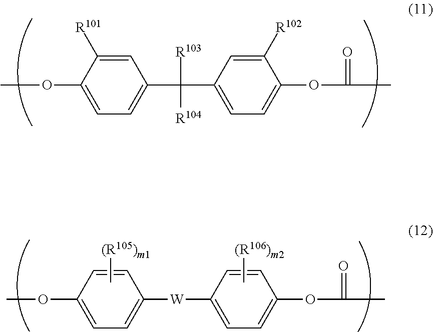

As a result of the photosensitive layer containing the polycarbonate resin (PC), abrasion resistance of the photosensitive member is increased. Furthermore, as a result of the photosensitive layer containing the polycarbonate resin (PC) in addition to the electron transport material (1), positive chargeability of the photosensitive member when positive charging and negative charging alternately transition is increased.

The following describes the main chain (10). In general formula (10), an alkyl group having a carbon number of at least 1 and no greater than 3 that is represented by R¹⁰¹, R¹⁰², R¹⁰³, or R¹⁰⁴ may be preferably a methyl group or an ethyl group. An alkyl group having a carbon number of at least 1 and no greater than 3 that is represented by R¹⁰¹, R¹⁰², R¹⁰³ or R¹⁰⁴ may be substituted with a halogen atom.

In general formula (10), an aryl group having a carbon number of at least 6 and no greater than 14 that is represented by R¹⁰¹, R¹⁰², R¹⁰³, or R¹⁰⁴ is preferably an aryl group having a carbon number of at least 6 and no greater than 10, and more preferably a phenyl group.

In general formula (10), a bivalent group represented by general formula (X) that is represented by R¹⁰³ and R¹⁰⁴ being bonded to each other to form a ring is a bivalent group represented by chemical formula (X-1), (X-2), or (X-3). A bivalent group such as above is preferably a bivalent group represented by chemical formula (X-2). That is, t in general formula (X) preferably represents 2. In chemical formulas (X-1), (X-2) and (X-3), * represents a bond, and more specifically a bond to a phenylene group to which a carbon atom bonds, R¹⁰³ and R¹⁰⁴ bonding to the carbon atom.

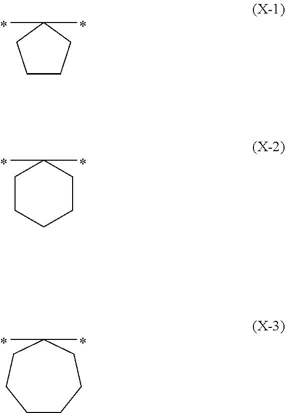

In general formula (10), an alkyl group having a carbon number of at least 1 and no greater than 3 that is represented by R¹⁰⁵ or R¹⁰⁶ is preferably a methyl group.

Preferably, m1 and m2 each represent 0. Alternatively, m1 and m2 each preferably represent 1.

Preferably, W represents a single bond or —O—.

As described previously, n represents a number of greater than 0 and no greater than 100. As a result of n being greater than 0, the polycarbonate resin (PC) necessarily includes the repeating unit (11). Where n represents 100, the polycarbonate resin (PC) is a homopolymer without the repeating unit (12). Where n represents a number of greater than 0 and less than 100, that is, where n is not 100, the polycarbonate resin (PC) is a copolymer including the repeating unit (12). Where n is not 100, n preferably represents a number of at least 20, and more preferably a number of at least 40. Where n is not 100, n preferably represents a number of no greater than 80, and more preferably a number of no greater than 60. n indicates a percentage (unit: % by mol) of the repeating unit (11) relative to the total number of the repeating units (11) and (12). In order to increase abrasion resistance of the photosensitive member, the main chain (10) preferably includes only the repeating units (11) and (12).

In general formula (10), preferably, R¹⁰¹ and R¹⁰² each represent, independently of one another, a hydrogen atom or an alkyl group having a carbon number of at least 1 and no greater than 3. More preferably, R¹⁰¹ and R¹⁰² represent the same group as one another. Preferably, R¹⁰¹³ and R¹⁰⁴ each represent, independently of one another, a hydrogen atom or an alkyl group having a carbon number of at least 1 and no greater than 3. It is also preferable that R¹⁰³ and R¹⁰⁴ be bonded to each other to represent a bivalent group represented by general formula (X-2). That is, t in general formula (X) preferably represents 2. Preferably, R¹⁰⁵ and R¹⁰⁶ each represent a methyl group. Preferably, m1 and m2 are the same as each other and each represent 0 or 1. Preferably, W represents a single bond or —O—. Preferably, n represents 100 or a number of at least and no greater than 80.

The repeating unit (11) of the main chain (10) is preferably a repeating unit represented by any of repeating units represented by chemical formulas (11-1) to (11-6). The repeating unit represented by any of chemical formulas (12-1) to (12-4) is preferable as the repeating unit (12) of the main chain (10).

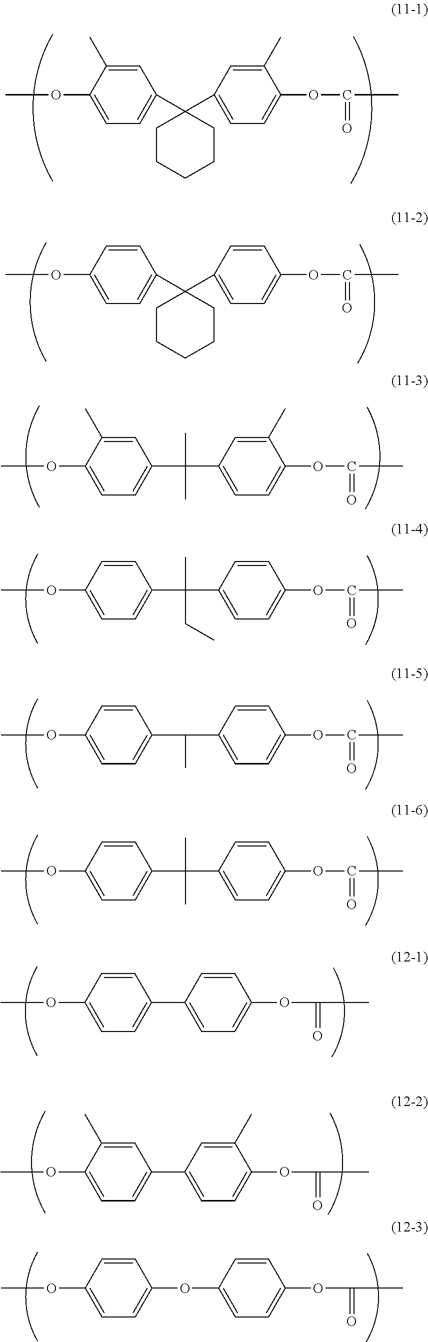

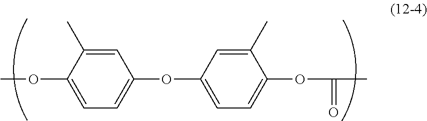

Where n in general formula (10) represents a number of greater than 0 and less than 100, the main chain (10) is preferably a main chain represented by any of main chains represented by general formulas (10-1) to (10-6) (also referred to below as main chains (10-1) to (10-6), respectively). Where n in general formula (10) represents 100, the main chain (10) is preferably a main chain represented by either of general formulas (10-A) and (10-B) (also referred to below as main chains (10-A) and (10-B), respectively).

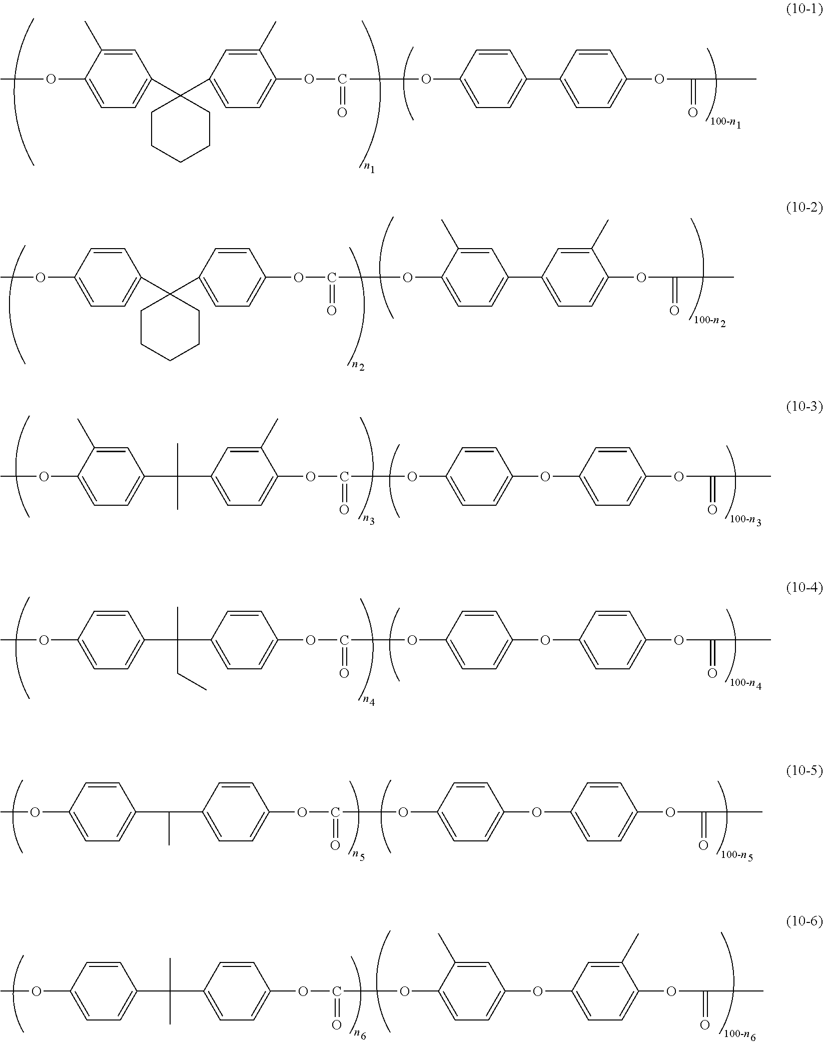

n₁ in general formula (10-1), n₂ in general formula (10-2), n₃ in general formula (10-3), n₄ in general formula (10-4), n₅ in general formula (10-5), and n₆ in general formula (10-6) each represent a number of greater than 0 and less than 100. Preferable examples of n₁, n₂, n₃, n₄, n₅, and n₆ are the same as the aforementioned preferable examples of n in general formula (10).

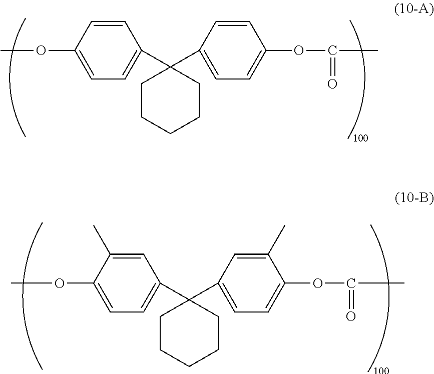

The main chain (10) has been described so far.

The first end group and the second end group are described next. The first end group has a halogen atom. The second end group has no halogen atom. As described previously, where n in general formula (10) represents 100 (i.e., where the polycarbonate resin (PC) is a homopolymer), the end group is the first end group. As described previously, where n represents a number of greater than 0 and less than 100 (i.e., the polycarbonate resin (PC) is a copolymer), the end group is the first end group or the second end group. In order to increase abrasion resistance and positive chargeability when positive charging and negative charging alternately transition, the end group is preferably the first end group or the second end group, and more preferably the first end group.

The first end group is described first. A halogen atom of the first end group is preferably a fluorine atom, a chlorine atom, or a bromine atom, and more preferably a fluorine atom. An example of the first end group is an end group represented by general formula (T1) (also referred to below as end group (T1)).

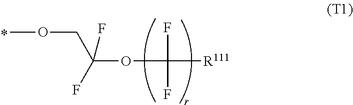

In general formula (T1), R¹¹¹ represents a hydrogen atom, a fluorine atom, or a methyl group, r represents an integer of at least 1 and no greater than 10.

In general formula (T1), R¹¹¹ preferably represents a fluorine atom, r represents preferably an integer of at least 5 and no greater than 10, and more preferably an integer of at least 6 and no greater than 8.

The end group (T1) is preferably an end group represented by chemical formula (T1-1) (also referred to below as end group (T1-1)).

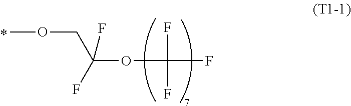

Another example of the first end group is an end group represented by general formula (T2) (also referred to below as end group (12)).

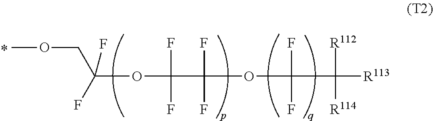

In general formula (T2), R¹¹², R¹¹³, and R¹¹⁴ each represent, independently of one another, a hydrogen atom, a fluorine atom, a methyl group, or a trifluoromethyl group, p and q each represent, independently of one another, an integer of at least 1 and no greater than 10.

In general formula (T2), preferably, R¹¹², R¹¹³, and R¹¹⁴ each represent, independently of one another, a fluorine atom or a trifluoromethyl group. It is further preferable that two of R¹¹², R¹¹³, and R¹¹⁴ each represent a trifluoromethyl group and the other one of R¹¹², R¹¹³, and R¹¹⁴ represents a fluorine atom, p and q each represent, independently of one another, preferably an integer of at least 1 and no greater than 5, and more preferably 1 or 2.

The end group (T2) is preferably an end group represented by chemical formula (T2-1) (also referred to below as an end group (T2-1)).

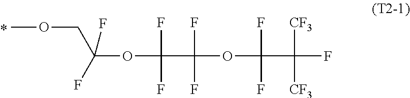 [SMILES: COCC(F)(F)OC(F)(F)C(F)(F)OC(F)(F)C(F)(C(F)(F)F)C(F)(F)F]

The second end group is described next. An example of the second end group is an end group represented by chemical formula (T3) (also referred to below as end group (T3)).

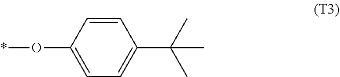 [SMILES: *Oc1ccc(C(C)(C)C)cc1]

Note that * in general formulas (T1) and (T2) and chemical formulas (T1-1), (T2-1), and (T3) represents a bond to the main chain (10). The bond represented by * is directly bonded to a —CO— group that is one of the ends of the main chain (10). Further, the bond represented by * is also boned to a —O— group that is the other of the ends of the main chain (10) with a carbonyl group therebetween. The first end group and the second end group have been described so far.

Preferable examples of the polycarbonate resin (PC) include polycarbonate resins (PC-A) to (PC-K) shown below.

In the polycarbonate resin (PC-A), the main chain (10) is the main chain (10-1), the end group is the first end group, and the first end group is the end group (T2-1).

In the polycarbonate resin (PC-B), the main chain (10) is the main chain (10-12), the end group is the first end group, and the first end group is the end group (T2-1).

In the polycarbonate resin (PC-C), the main chain (10) is the main chain (10-13), the end group is the first end group, and the first end group is the end group (T2-1).

In the polycarbonate resin (PC-D), the main chain (10) is the main chain (10-1), the end group is the first end group, and the first end group is the end group (T1-1).

In the polycarbonate resin (PC-E), the main chain (10) is the main chain (10-1), the end group is the second end group, and the second end group is the end group (T3).

In the polycarbonate resin (PC-F), the main chain (10) is the main chain (10-2), the end group is the second end group, and the second end group is the end group (T3).

In the polycarbonate resin (PC-G), the main chain (10) is the main chain (10-4), the end group is the second end group, and the second end group is the end group (T3).

In the polycarbonate resin (PC-H), the main chain (10) is the main chain (10-5), the end group is the second end group, and the second end group is the end group (T3).

In the polycarbonate resin (PC-I), the main chain (10) is the main chain (10-6), the end group is the second end group, and the second end group is the end group (T3).

>In the polycarbonate resin (PC-J), the main chain (10) is the main chain (10-A), the end group is the first end group, and the first end group is the end group (T1-1).

In the polycarbonate resin (PC-K), the main chain (10) is the main chain (10-B), the end group is the first end group, and the first end group is the end group (T2-1).

Further preferable examples of the polycarbonate resin (PC) include polycarbonate resins represented by chemical formulas (R1) to (R13) (also referred to below as polycarbonate resins (R1) to (R13), respectively). In chemical formulas (R1) to (R13), Rt represents an end group represented by chemical formula located on the right side of “Rt=”.

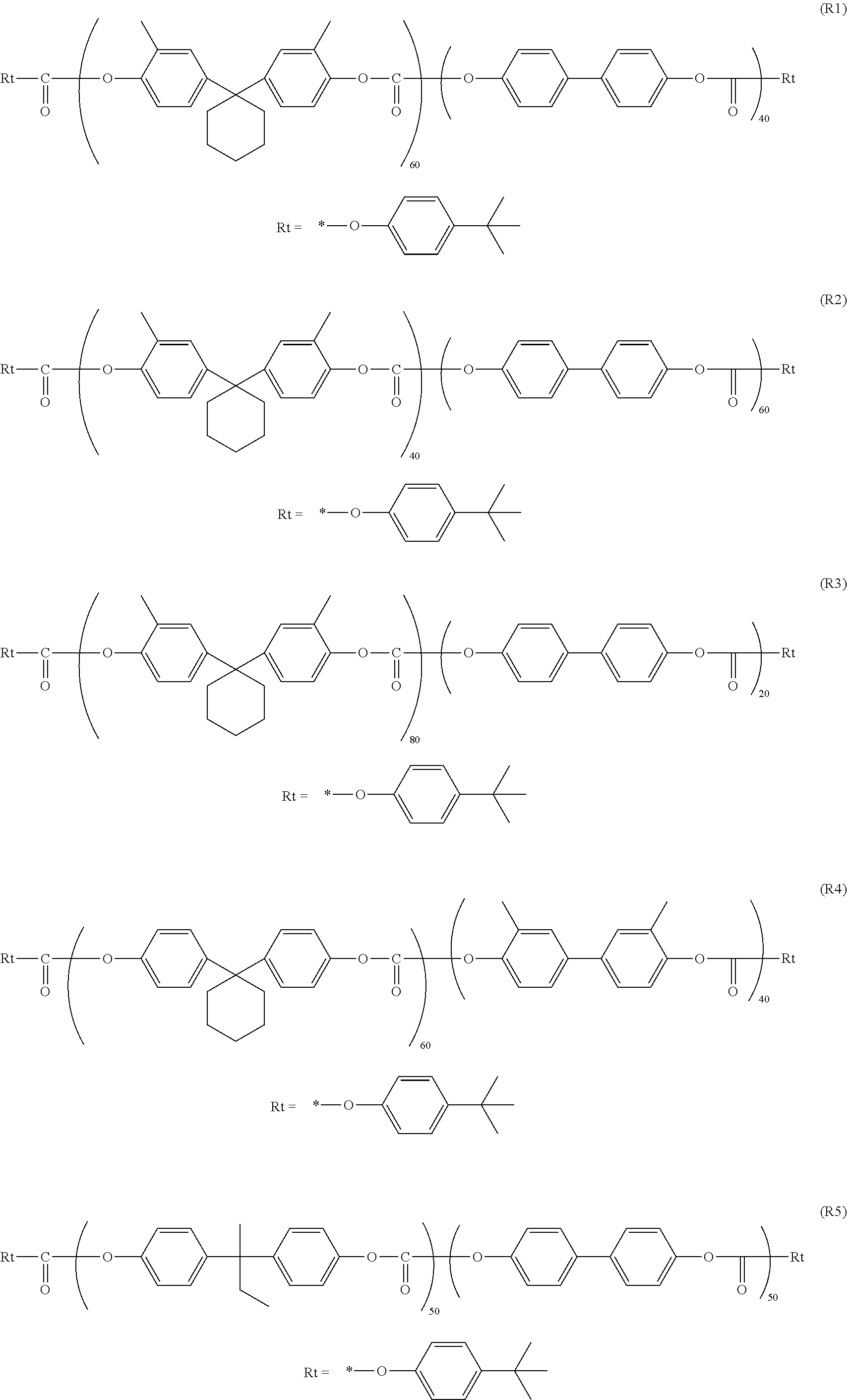

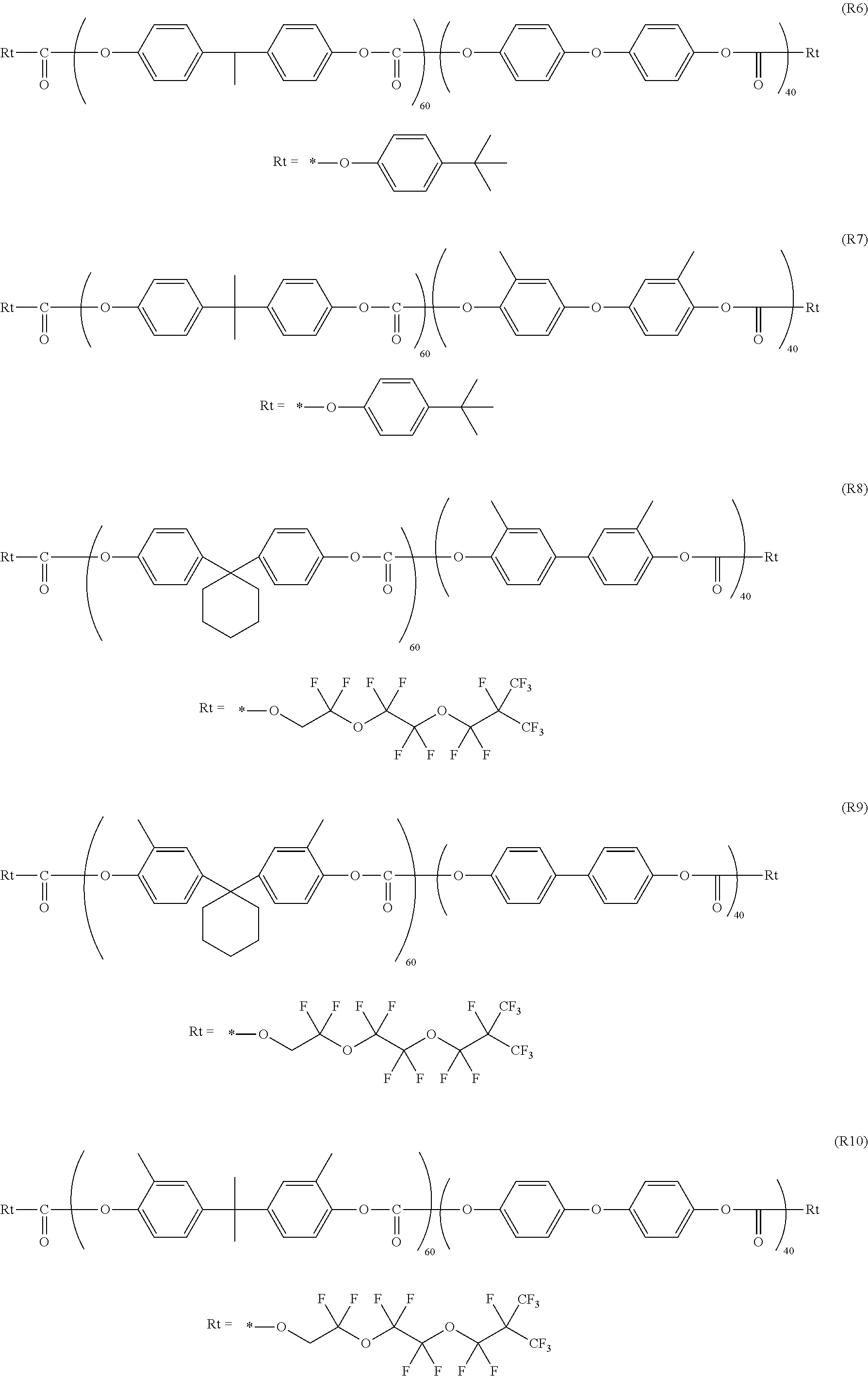

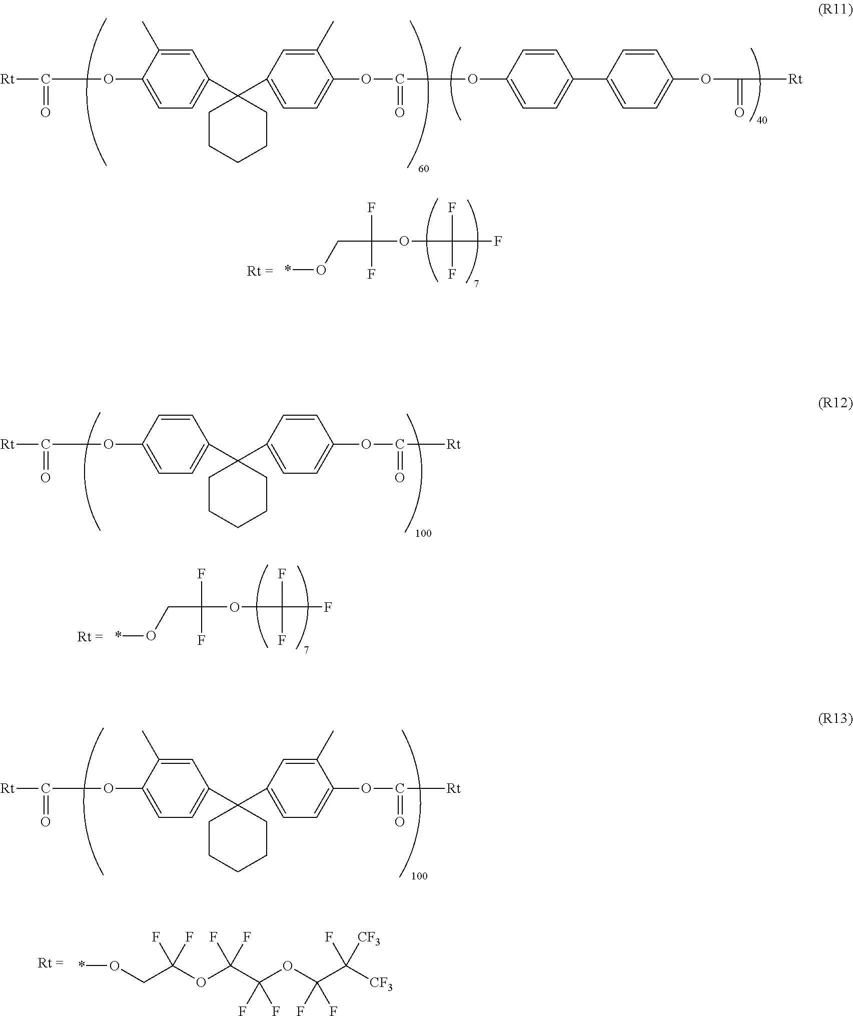

Where the polycarbonate resin (PC) is a copolymer, the polycarbonate resin (PC) may be a random copolymer, an alternating copolymer, a block copolymer, or a periodic copolymer.

The polycarbonate resin (PC) has a viscosity average molecular weight of preferably at least 10,000, further preferably at least 20,000, and particularly preferably at least 30,000. As a result of the polycarbonate resin (PC) having a viscosity average molecular weight of at least 10,000, abrasion resistance of the photosensitive member increases. By contrast, the polycarbonate resin (PC) has a viscosity average molecular weight of preferably no greater than 80,000, and more preferably no greater than 70,000. As a result of the polycarbonate resin (PC) having a viscosity average molecular weight of no greater than 80,000, the binder resin readily dissolves in a solvent for photosensitive layer formation.

The photosensitive layer may contain only the polycarbonate resin (PC) as the binder resin or further contain a binder resin other than the polycarbonate resin (PC). Examples of the binder resin other than the polycarbonate resin (PC) include thermoplastic resins (specific examples include polycarbonate resins other than the polycarbonate resin (PC), polyarylate resins, styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, and polyether resins), thermosetting resins (specific examples include silicone resins, epoxy resins, phenolic resins, urea resins, melamine resins, and cross-linkable thermosetting resins other than these), and photocurable resins (specific examples include epoxy-acrylate-based resins and urethane-acrylate copolymers).

(Hole Transport Material)

Examples of the hole transport material include oxadiazole-based compounds (e.g., 2,5-di(4-methylaminophenyl)-1,3,4-oxadiazole), styryl compounds (e.g., 9-(4-diethylaminostyryl)anthracene), carbazole compounds (e.g., polyvinyl carbazole), organic polysilane compounds, pyrazoline-based compounds (e.g., 1-phenyl-3-(p-dimethylaminophenyl)pyrazoline), hydrazone compounds, indole-based compounds, oxazole-based compounds, isoxazole-based compounds, thiazole-based compounds, thiadiazole-based compounds, imidazole-based compounds, pyrazole-based compounds, and triazole-based compounds.

In order to increase photosensitivity, abrasion resistance, and positive chargeability when positive charging and negative charging alternately transition, the hole transport material preferably includes a compound represented by general formula (21), (22), (23), (24), (25), (26), or (27). Hereinafter, the compounds represented by general formulas (21) to (27) may be referred to as hole transport materials (21) to (27), respectively.

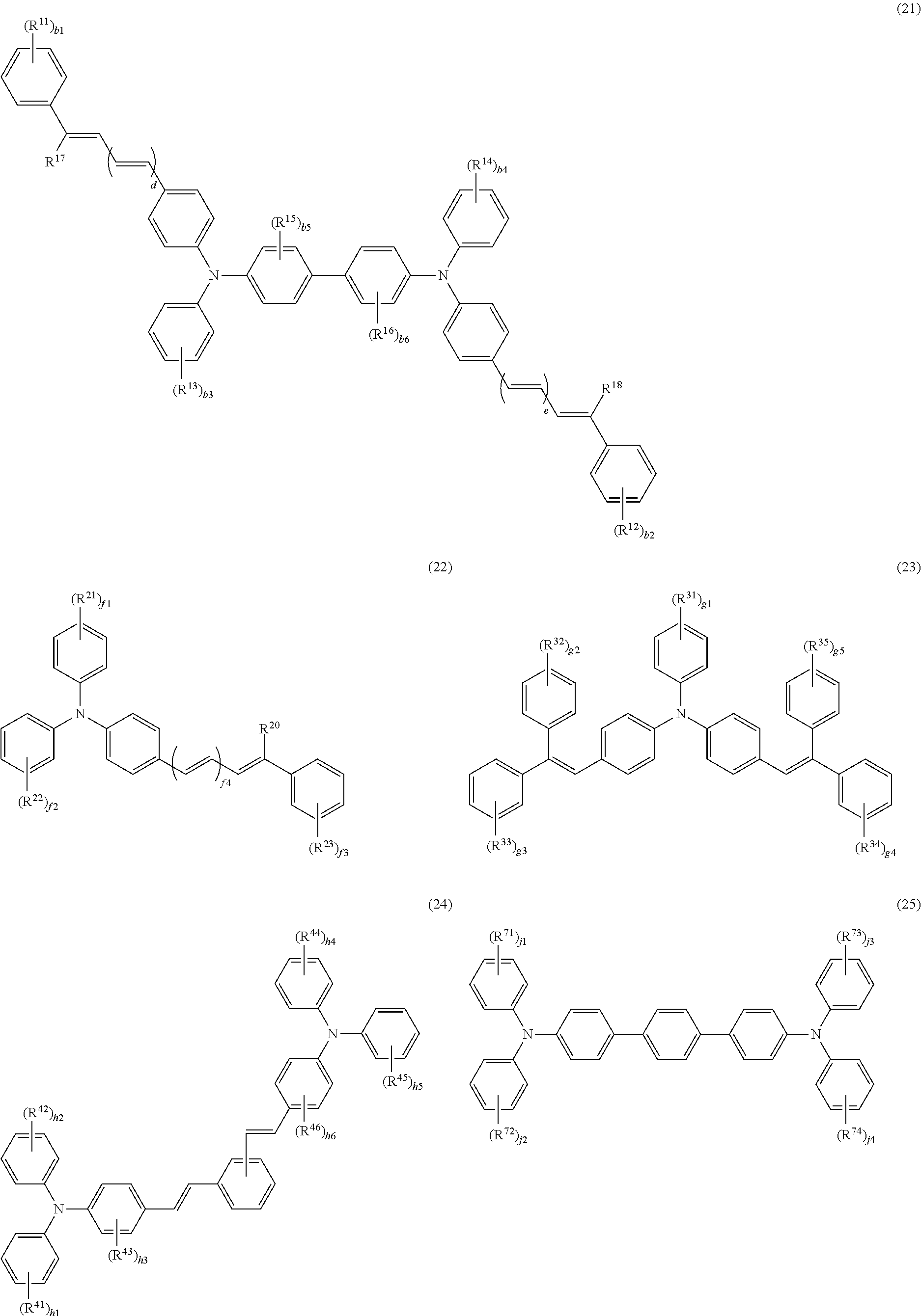

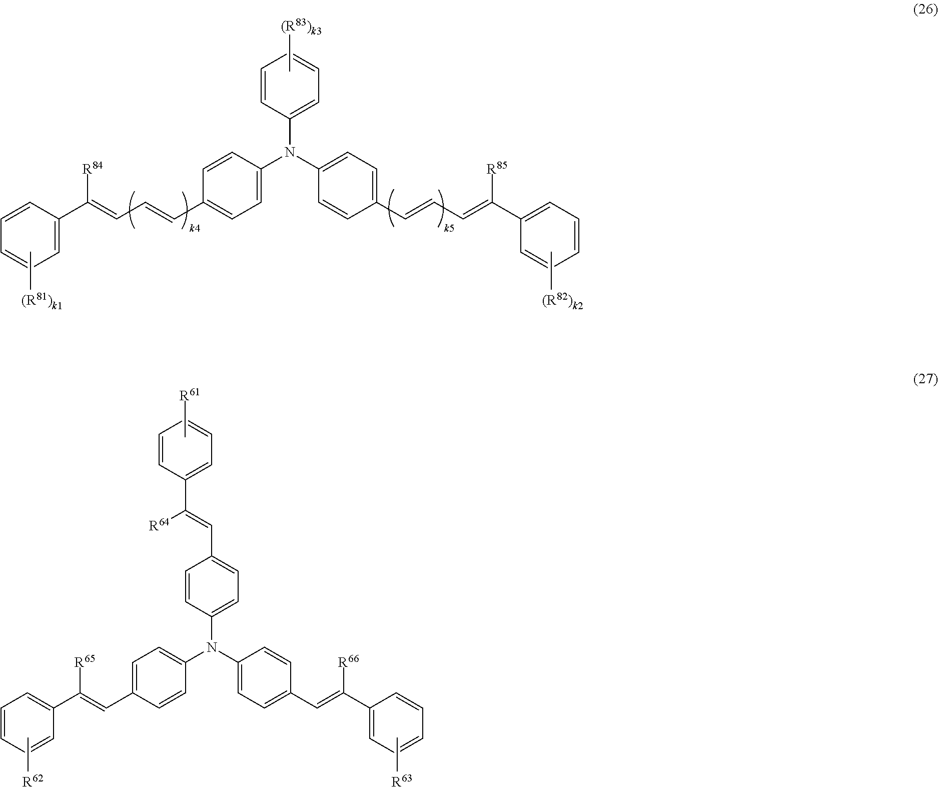

In general formula (21), R¹¹, R¹², R¹³, R¹⁴, R¹⁵, and R¹⁶ each represent, independently of one another, a phenyl group or an alkyl group having a carbon number of at least 1 and no greater than 8. R¹⁷ and R¹⁸ each represent, independently of one another, a hydrogen atom, a phenyl group, or an alkyl group having a carbon number of at least 1 and no greater than 8. b1, b2, b3, and b4 each represent, independently of one another, an integer of at least 0 and no greater than 5. b5 and b6 each represent, independently of one another, an integer of at least 0 and no greater than 4. d and e each represent, independently of one another, 0 or 1.

In general formula (21), chemical groups R¹¹ may be the same as or different from one another when b1 represents an integer of at least 2 and no greater than 5. Chemical groups R¹² may be the same as or different from one another when b2 represents an integer of at least 2 and no greater than 5. Chemical groups R¹³ may be the same as or different from one another when b3 represents an integer of at least 2 and no greater than 5. Chemical groups R¹⁴ may be the same as or different from one another when b4 represents an integer of at least 2 and no greater than 5. Chemical groups R¹⁵ may be the same as or different from one another when b5 represents an integer of at least 2 and no greater than 4. Chemical groups R¹⁶ may be the same as or different from one another when b6 represents an integer of at least 2 and no greater than 4.

In general formula (21), R¹¹, R¹², R¹³, R¹⁴, R¹⁵, and R¹⁶ each represent, independently of one another, preferably, an alkyl group having a carbon number of at least 1 and no greater than 8, more preferably an alkyl group having a carbon number of at least 1 and no greater than 3, and further preferably a methyl group or an ethyl group. Preferably, R¹⁷ and R¹⁸ each represent a hydrogen atom. Preferably, b1 and b2 each represent 0. Preferably, b3 and b4 each represent 2. Preferably, b5 and b6 each represent 0. Preferably, d and e each represent 0.

In general formula (22), R²⁰ represents a hydrogen atom, an alkyl group having a carbon number of at least 1 and no greater than 8, an alkoxy group having a carbon number of at least 1 and no greater than 8, or a phenyl group optionally substituted with an alkyl group having a carbon number of at least 1 and no greater than 8. R²¹, R²², and R²³ each represent, independently of one another, an alkyl group having a carbon number of at least 1 and no greater than 8, or an alkoxy group having a carbon number of at least 1 and no greater than 8. f1, f2, and f3 each represent, independently of one another, an integer of at least 0 and no greater than 5. f4 represents 0 or 1.

In general formula (22), chemical groups R²¹ may be the same as or different from one another when f1 represents an integer of at least 2 and no greater than 5. Chemical groups R²² may be the same as or different from one another when f2 represents an integer of at least 2 and no greater than 5. Chemical groups R²³ may be the same as or different from one another when f3 represents an integer of at least 2 and no greater than 5.

In general formula (22), R²⁰ preferably represents a phenyl group. R²¹, R²², and R²³ each represent, independently of one another, preferably an alkyl group having a carbon number of at least 1 and no greater than 8, more preferably an alkyl group having a carbon number of at least 1 and no greater than 3, and further preferably a methyl group. Preferably, f1 and f2 each represent 1. Preferably, f3 represents 0. As previously described, f4 represents 0 or 1.

In general formula (23), R³¹, R³², R³³, R³⁴, and R³⁵ each represent, independently of one another, an alkyl group having a carbon number of at least 1 and no greater than 8, or an alkoxy group having a carbon number of at least 1 and no greater than 8. g1, g2, g3, g4, and g5 each represent, independently of one another, an integer of at least 0 and no greater than 5.

In general formula (23), chemical groups R³¹ may be the same as or different from one another when g1 represents an integer of at least 2 and no greater than 5. Chemical groups R³² may be the same as or different from one another when g2 represents an integer of at least 2 and no greater than 5. Chemical groups R³³ may be the same as or different from one another when g3 represents an integer of at least 2 and no greater than 5. Chemical groups R³⁴ may be the same as or different from one another when g4 represents an integer of at least 2 and no greater than 5. Chemical groups R³⁵ may be the same as or different from one another when g5 represents an integer of at least 2 and no greater than 5.

In general formula (23), R³¹, R³², R³³, R³⁴, and R³⁵ each represent, independently of one another, preferably an alkyl group having a carbon number of at least 1 and no greater than 8, more preferably an alkyl group having a carbon number of at least 1 and no greater than 3, and further preferably a methyl group. Preferably, g1, g2, g3, g4, and g5 each represent 1.

In general formula (24), R⁴¹, R⁴², R⁴³, R⁴⁴, R⁴⁵, and R⁴⁶ each represent, independently of one another, a phenyl group, an alkyl group having a carbon number of at least 1 and no greater than 8, or an alkoxy group having a carbon number of at least 1 and no greater than 8. h1, h2, h4, and h5 each represent, independently of one another, an integer of at least 0 and no greater than 5. h3 and h6 each represent, independently of one another, an integer of at least 0 and no greater than 4.

In general formula (24), chemical groups R⁴¹ may be the same as or different from one another when h1 represents an integer of at least 2 and no greater than 5. Chemical groups R⁴² may be the same as or different from one another when h2 represents an integer of at least 2 and no greater than 5. Chemical groups R⁴⁴ may be the same as or different from one another when h4 represents an integer of at least 2 and no greater than 5. Chemical groups R⁴⁵ may be the same as or different from one another when h5 represents an integer of at least 2 and no greater than 5. Chemical groups R⁴³ may be the same as or different from one another when h3 represents an integer of at least 2 and no greater than 4. Chemical groups R⁴⁶ may be the same as or different from one another when h6 represents an integer of at least 2 and no greater than 4.

In general formula (24), R⁴¹, R⁴², R⁴³, R⁴⁴, R⁴⁵, and R⁴⁶ each represent, independently of one another, preferably an alkyl group having a carbon number of at least 1 and no greater than 8, more preferably an alkyl group having a carbon number of at least 1 and no greater than 3, and further preferably a methyl group or an ethyl group. Preferably, h1, h2, h4, and h5 each represent, independently of one another, an integer of at least 0 and no greater than 2. Preferably, h3 and h6 each represent 0.

In general formula (25), R⁷¹, R⁷², R⁷³, and R⁷⁴ each represent, independently of one another, an alkyl group having a carbon number of at least 1 and no greater than 8. j1, j2, j3, and j4 each represent, independently of one another, an integer of at least 0 and no greater than 5.

In general formula (25), chemical groups R⁷¹ may be the same as or different from one another when j1 represents an integer of at least 2 and no greater than 5. Chemical groups R⁷² may be the same as or different from one another when j2 represents an integer of at least 2 and no greater than 5. Chemical groups R⁷³ may be the same as or different from one another when j3 represents an integer of at least 2 and no greater than 5. Chemical groups R⁷⁴ may be the same as or different from one another when j4 represents an integer of at least 2 and no greater than 5.

In general formula (25), R⁷¹, R⁷², R⁷³, and R⁷⁴ each represent, independently of one another, preferably an alkyl group having a carbon number of at least 1 and no greater than 3, and more preferably a methyl group or an ethyl group. Preferably, j1, j2, j3, and j4 each represent, independently of one another, 0 or 1.

In general formula (26), R⁸¹, R⁸², and R⁸³ each represent, independently of one another, a phenyl group, an alkyl group having a carbon number of at least 1 and no greater than 8, or an alkoxy group having a carbon number of at least 1 and no greater than 8. R⁸⁴ and R⁸⁵ each represent, independently of one another, a hydrogen atom, a phenyl group optionally substituted with an alkyl group having a carbon number of at least 1 and no greater than 8, an alkyl group having a carbon number of at least 1 and no greater than 8, or an alkoxy group having a carbon number of at least 1 and no greater than 8. k1, k2, and k3 each represent, independently of one another, an integer of at least 0 and no greater than 5. k4 and k5 each represent, independently of one another, 1 or 2.

In general formula (26), chemical groups R⁸¹ may be the same as or different from one another when k1 represents an integer of at least 2 and no greater than 5. Chemical groups R⁸² may be the same as or different from one another when k2 represents an integer of at least 2 and no greater than 5. Chemical groups R⁸³ may be the same as or different from one another when k3 represents an integer of at least 2 and no greater than 5.

In general formula (26), R⁸¹, R⁸², and R⁸³ each represent, independently of one another, preferably an alkoxy group having a carbon number of at least 1 and no greater than 8, more preferably an alkoxy group having a carbon number of at least 1 and no greater than 6, and further preferably an ethoxy group. Preferably, R⁸⁴ and R⁸⁵ each represent a hydrogen atom. Preferably, k1 and k2 each represent 0. Preferably, k3 represents 1. Preferably, k4 and k5 each represent 1.

In general formula (27), R⁶¹, R⁶², and R⁶³ each represent, independently of one another, an alkyl group having a carbon number of at least 1 and no greater than 8. R⁶⁴, R⁶⁵, and R⁶⁶ each represent, independently of one another, a hydrogen atom or an alkyl group having a carbon number of at least 1 and no greater than 8.

In general formula (27), R⁶¹, R⁶², and R⁶³ each represent, independently of one another, preferably an alkyl group having a carbon number of at least 1 and no greater than 8, more preferably an alkyl group having a carbon number of at least 1 and no greater than 3, and further preferably a methyl group. Preferably, R⁶⁴, R⁶⁵, and R⁶⁶ each represent a hydrogen atom.

More preferable examples of the hole transport material include compounds represented by chemical formulas (HTM1) to (HTM10) (also referred to below as hole transport materials (HTM1) to (HTM10), respectively).

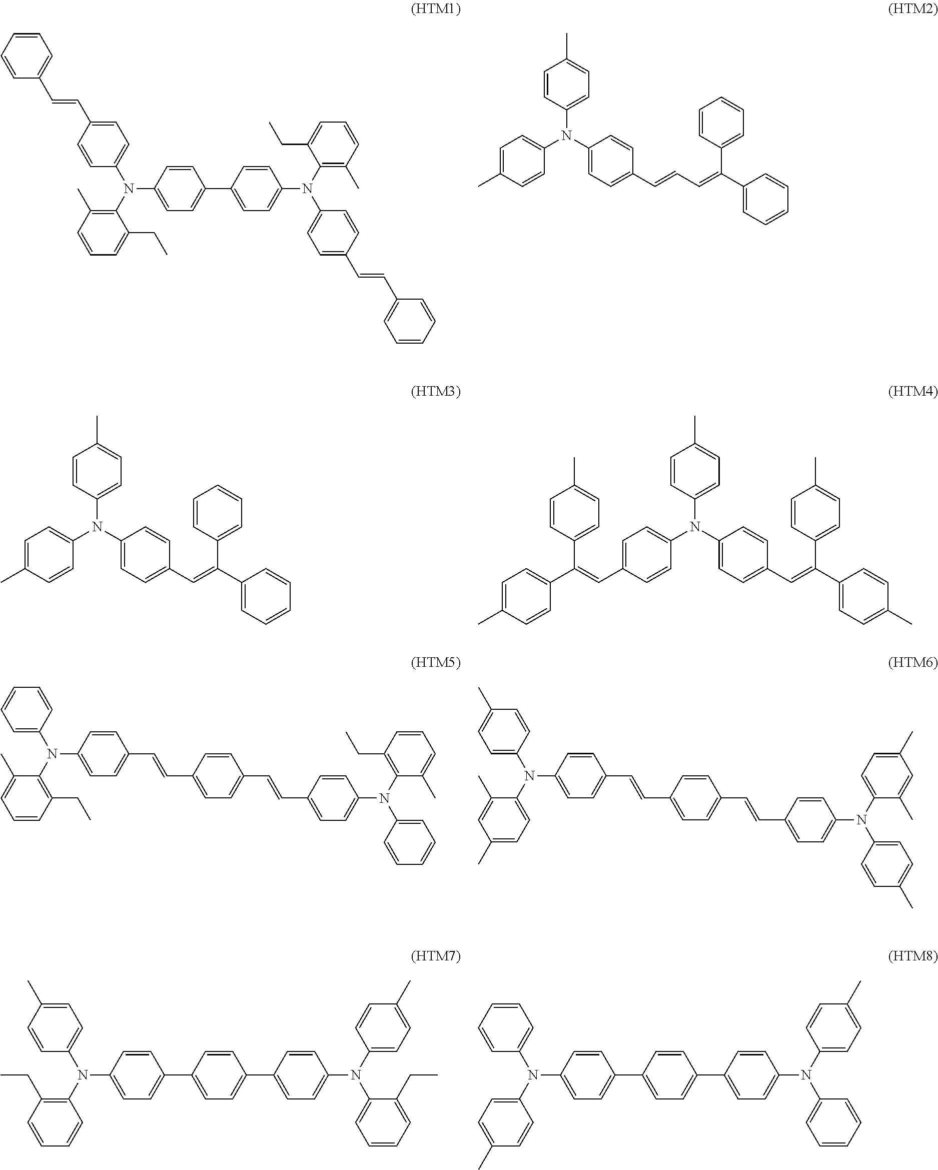

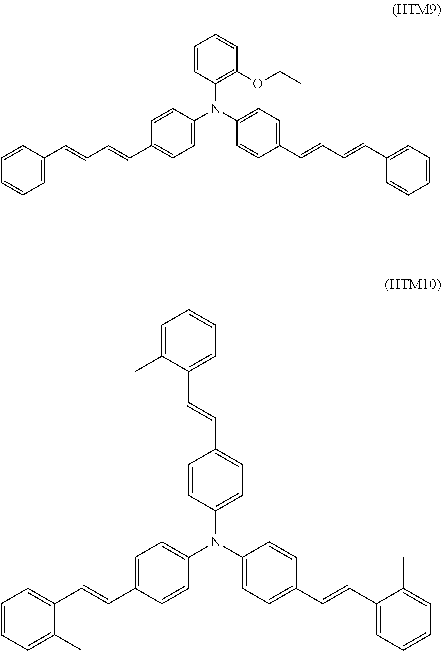 [SMILES: CCOc1ccccc1N(c1ccc(/C=C/C=C/c2ccccc2)cc1)c1ccc(/C=C/C=C/c2ccccc2)cc1 ; Cc1ccccc1/C=C/c1ccc(N(c2ccc(/C=C/c3ccccc3C)cc2)c2ccc(/C=C/c3ccccc3C)cc2)cc1]

The content of the hole transport material is preferably at least 10 parts by mass and no greater than 300 parts by mass relative to 100 parts by mass of the binder resin, and more preferably at least 10 parts by mass and no greater than 150 parts by mass.

(n-Type Pigment)

An n-type pigment is a pigment in which electrons mainly work as charge carriers. Note that a p-type pigment is a pigment in which holes mainly work as charge carriers. An n-type pigment tends to coordinate at a moiety represented by chemical formula “═N−N<” in the electron transport material (1). Therefore, as a result of the photosensitive layer containing an n-type pigment in addition to the electron transport material (1), photosensitivity of the photosensitive member increases. Furthermore, as a result of the photosensitive layer containing an n-type pigment, dispersibility of the charge generating material in the photosensitive layer increases.

Preferable examples of the n-type pigment to increase photosensitivity, abrasion resistance, and positive chargeability of the photosensitive member when positive charging and negative charging alternately transition include azo pigments, perylene pigments, and isoindoline pigments.

An azo pigment used as the n-type pigment is described below. The azo pigment is a pigment having an azo group (—N═N—) in a structure thereof. Examples of the azo pigment include monoazo pigments and polyazo pigments (e.g., bisazo pigments, trisazo pigments, and tetrakisazo pigments). The azo pigment may be a tautomer of a compound having an azo group. Also, the azo pigment may have a chlorine atom (chloro group) in addition to the azo group.

As the azo pigment, any of known azo pigments may be used, for example. Preferable examples of the azo pigment include Pigment Yellow (14, 17, 49, 65, 73, 83, 93, 94, 95, 128, 166, or 77), Pigment Orange (1, 2, 13, 34, or 36), and Pigment Red (30, 32, 61, or 144).

Preferable examples of the azo pigment when included in the n-type pigment include compounds represented by chemical formulas (A1), (A2), (A3), (A4), and (A5) (also referred to below as azo pigments (A1), (A2), (A3), (A4), and (A5), respectively).

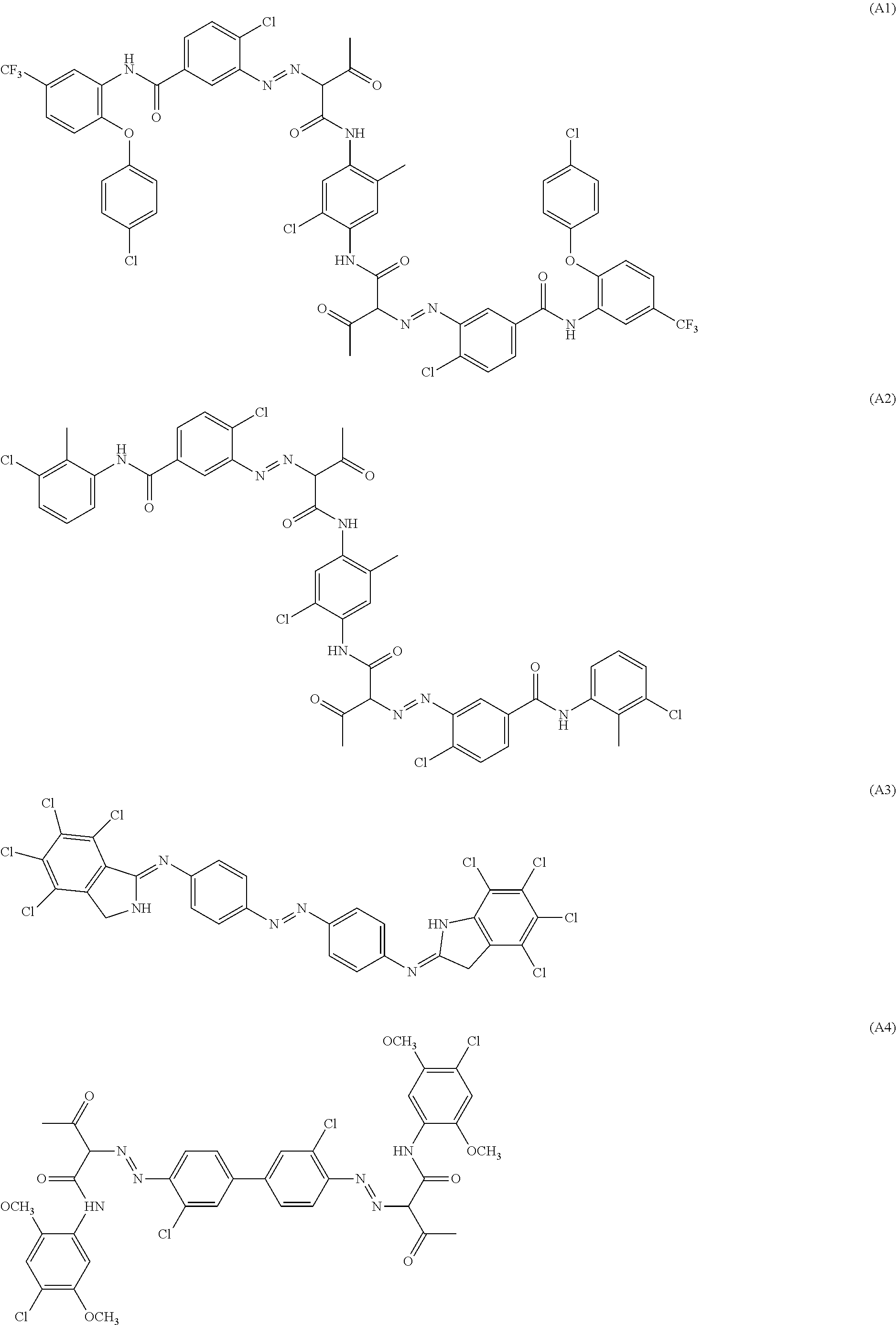 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C ; Clc1c(Cl)c(Cl)c2c(c1Cl)C/C(=N/c1ccc(/N=N/c3ccc(/N=C4\NCc5c(Cl)c(Cl)c(Cl)c(Cl)c54)cc3)cc1)N2 ; COc1cc(NC(=O)C(/N=N/c2ccc(-c3ccc(/N=N/C(C(C)=O)C(=O)Nc4cc(OC)c(Cl)cc4OC)c(Cl)c3)cc2Cl)C(C)=O)c(OC)cc1Cl]

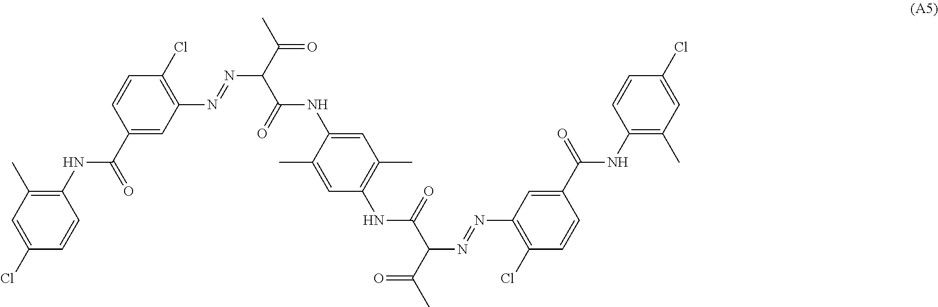 [SMILES: CC(=O)C(/N=N/c1cc(C(=O)Nc2ccc(Cl)cc2C)ccc1Cl)C(=O)Nc1cc(C)c(NC(=O)C(/N=N/c2cc(C(=O)Nc3ccc(Cl)cc3C)ccc2Cl)C(C)=O)cc1C]

A perylene pigment used as the n-type pigment is described next. The perylene pigment has a perylene skeleton represented by general formula (P-I). In general formula (P-I), Q⁴⁰ and Q⁴¹ each represent, independently of one another, a bivalent organic group.

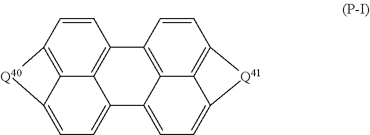

A first specific example of the perylene pigment is a perylene pigment represented by general formula (P-II).

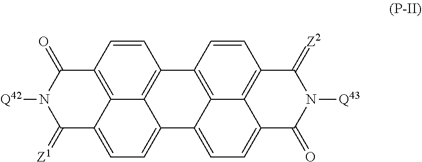

In general formula (P-II), Q⁴² and Q⁴³ each represent, independently of one another, a hydrogen atom or a monovalent organic group. Z¹ and Z² each represent, independently of one another, an oxygen atom or a nitrogen atom.

Examples of the monovalent organic group represented by Q⁴² or Q⁴³ in general formula (P-II) include an aliphatic hydrocarbon group, an alkoxy group, an optionally substituted aralkyl group, an optionally substituted aryl group, and an optionally substituted heterocyclic group.

In general formula (P-II), the aliphatic hydrocarbon group represented by Q⁴² or Q⁴³ may be a straight chain group, a branched chain group, a cyclic group, or a combination structure of the foregoing. The aliphatic hydrocarbon group is a saturated or unsaturated aliphatic hydrocarbon group, and preferably a saturated aliphatic hydrocarbon group. In general formula (P-II), the aliphatic hydrocarbon group represented by Q⁴² or Q⁴³ is preferably an aliphatic hydrocarbon group having a carbon number of at least 1 and no greater than 20, and more preferably an aliphatic hydrocarbon group having a carbon number of at least 1 and no greater than 10. The aliphatic hydrocarbon group having a carbon number of at least 1 and no greater than 10 is preferably an alkyl group having a carbon number of at least 1 and no greater than 8, more preferably an alkyl group having a carbon number of at least 1 and no greater than 6, further preferably an alkyl group having a carbon number of at least 1 and no greater than 3, and particularly preferably a methyl group or an ethyl group.

In general formula (P-II), the alkoxy group represented by Q⁴² or Q⁴³ is preferably an alkoxy group having a carbon number of at least 1 and no greater than 6, more preferably an alkoxy group having a carbon number of at least 1 and no greater than 3, and further preferably a methoxy group or an ethoxy group.

In general formula (P-II), the aralkyl group represented by Q⁴² or Q⁴³ is preferably an aralkyl group having a carbon number of at least 7 and no greater than 13, more preferably a benzyl group, a phenethyl group, an α-naphthylmethyl group, or a β-naphthylmethyl group, and further preferably a benzyl group or a phenethyl group.

In general formula (P-II), the aryl group represented by Q⁴² or Q⁴³ is preferably an aryl group having a carbon number of at least 6 and no greater than 14, more preferably an aryl group having a carbon number of at least 6 and no greater than 10, and further preferably a phenyl group.

In general formula (P-II), the heterocyclic group represented by Q⁴² or Q⁴³ is preferably a heterocyclic group having a carbon number of at least 5 and no greater than 14, more preferably a heterocyclic group having a carbon number of at least 5 and no greater than 14 with a nitrogen atom as a hetero atom, and further preferably a pyridyl group.

In general formula (P-II), the aralkyl group, the aryl group, and the heterocyclic group represented by Q⁴² or Q⁴³ may be substituted with a substituent. A substituent such as above is preferably a phenyl group, a halogen atom, a hydroxy group, a cyano group, a nitro group, a phenyl azo group, an alkyl group having a carbon number of at least 1 and no greater than 6, or an alkoxy group having a carbon number of at least 1 and no greater than 6, more preferably a halogen atom (e.g., a chlorine atom), a phenyl azo group, or an alkyl group having a carbon number of at least 1 and no greater than 6 (e.g., a methyl group).

In general formula (P-II), Q⁴² and Q⁴³ preferably represent: a hydrogen atom; an alkyl group having a carbon number of at least 1 and no greater than 6; a heterocyclic group having a carbon number of at least 5 and no greater than 14; an aralkyl group having a carbon number of at least 7 and no greater than 13; an alkoxy group having a carbon number of at least 1 and no greater than 6; or an aryl group having a carbon number of at least 6 and no greater than 14 that is optionally substituted with a halogen atom, a phenyl azo group, or an alkyl group having a carbon number of at least 1 and no greater than 6. In general formula (P-II), Q⁴² and Q⁴³ each more preferably represent a methyl group, an ethyl group, a pyridyl group, a benzyl group, a phenylethyl group, an ethoxy group, a methoxy group, a phenyl group, a dimethyl phenyl group (more preferably, a 3,5-dimethylphenyl group), a chlorophenyl group (more preferably, a 4-chlorophenyl group), a phenylazophenyl group (more preferably, a 4-phenylazophenyl group), or a hydrogen atom. Preferably, Q⁴² and Q⁴³ represent the same group as one another.

In general formula (P-II), Q⁴² and Q⁴³ preferably represents: an alkyl group having a carbon number of at least 1 and no greater than 6; or an aryl group having a carbon number of at least 6 and no greater than 14 that is optionally substituted with an alkyl group having a carbon number of at least 1 and no greater than 6. In general formula (P-II), Q⁴² and Q⁴³ each more preferably represent a methyl group, a phenyl group, or a dimethyl phenyl group (more preferably, a 3,5-dimethylphenyl group). Preferably, Q⁴² and Q⁴³ represent the same group as one another.

A second specific example of the perylene pigment is a compound represented by general formula (P-III).

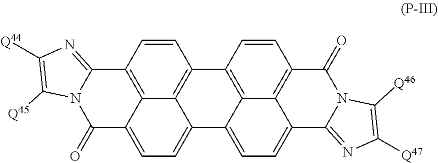

In general formula (P-III), Q⁴⁴ to Q⁴⁷ each represent, independently of one another, a hydrogen atom or a monovalent organic group. Q⁴⁴ and Q⁴⁵ may be bonded to each other to form a ring. Q⁴⁶ and Q⁴⁷ may be bonded to each other to form a ring.

The monovalent organic group represented by any of Q⁴⁴ to Q⁴⁷ in general formula (P-III) is the same as defined for the monovalent organic group represented by Q⁴² and Q⁴³ in general formula (P-II).

Examples of the ring formed through Q⁴⁴ and Q⁴⁵ being bonded to each other and the ring formed through Q⁴⁶ and Q⁴⁷ being bonded to each other include aromatic hydrocarbon rings, aromatic heterocyclic rings, alicyclic hydrocarbon rings, and alicyclic heterocyclic rings. Each of the ring formed through Q⁴⁴ and Q⁴⁵ being bonded to each other and the ring formed through Q⁴⁶ and Q⁴⁷ being bonded to each other is preferably a benzene ring, a naphthalene ring, a pyridine ring, or a tetrahydronaphthalene ring, and more preferably a benzene ring or a naphthalene ring. Each of the benzene ring and the naphthalene ring formed through Q⁴⁴ and Q⁴⁵ being bonded to each other is fused with an imidazole ring to which Q⁴⁴ and Q⁴⁵ are bonded. Each of the benzene ring and the naphthalene ring formed through Q⁴⁶ and Q⁴⁷ being bonded to each other is fused with an imidazole ring to which Q⁴⁶ and Q⁴⁷ are bonded.

Each of the ring formed through Q⁴⁴ and Q⁴⁵ being bonded to each other and the ring formed through Q⁴⁶ and Q⁴⁷ being bonded to each other may be substituted with a substituent. A substituent such as above is preferably a halogen atom, and more preferably a chlorine atom or a fluorine atom.

In general formula (P-III), Q⁴⁴ and Q⁴⁵ are preferably bonded to each other to form an aromatic hydrocarbon ring having a carbon number of at least 6 and no greater than 10 that is optionally substituted with a halogen atom. Preferably, Q⁴⁶ and Q⁴⁷ are bonded to each other to form an aromatic hydrocarbon ring having a carbon number of at least 6 and no greater than 10 that is optionally substituted with a halogen atom.

In general formula (P-III), Q⁴⁴ and Q⁴⁵ are preferably bonded to each other to form a benzene ring, a chlorobenzene ring, a fluorobenzene ring, or a naphthalene ring. Q⁴⁶ and Q⁴⁷ are preferably bonded to each other to form a benzene ring, a chlorobenzene ring, a fluorobenzene ring, or a naphthalene ring.

Further preferable examples of the perylene pigment include compounds represented by chemical formulas (P1) to (P17) (also referred to below as perylene pigments (P1) to (P17), respectively). Note that no particular limitations are placed on the substitution site of each of the pyridyl group in chemical formula (P5) and the fluoro group in chemical formula (P12).

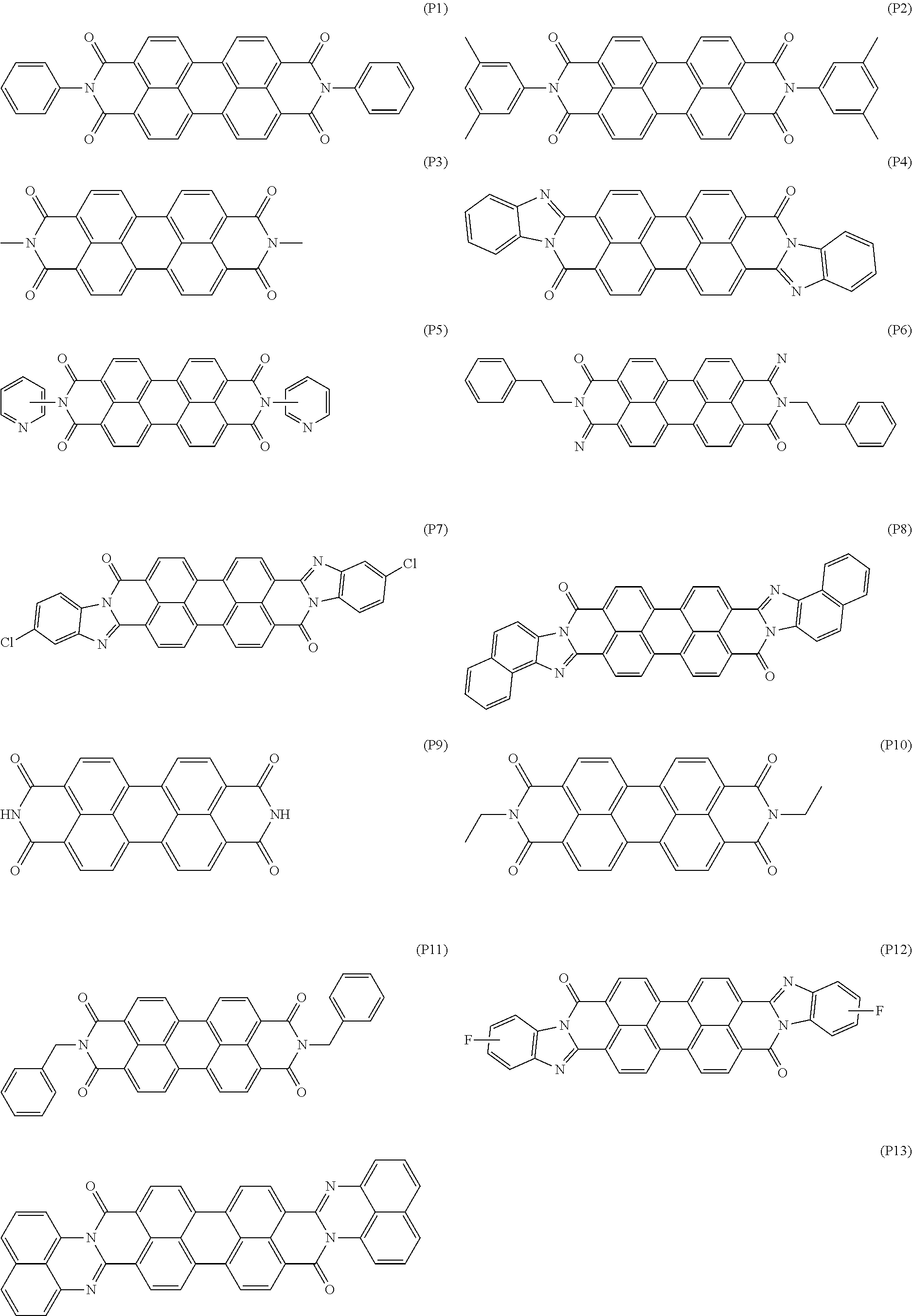

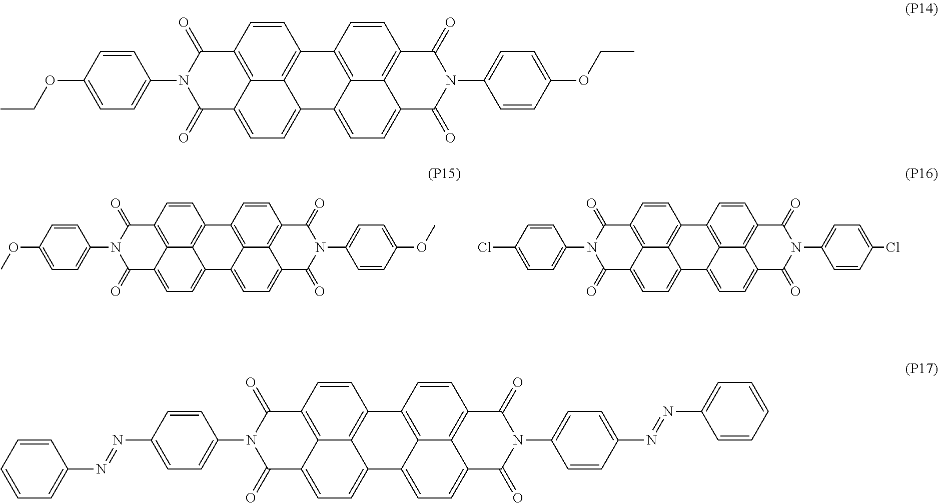

Further preferable examples of the perylene pigment when included in the n-type pigment include the perylene pigments (P1), (P2), (P3), and (P4).

An isoindoline pigment used as the n-type pigment is described next. The isoindoline pigment is a pigment with an isoindoline structure. The isoindoline structure is a structure represented by the following chemical formula (IA). A substituent may be bonded to a carbon atom in the structure represented by chemical formula (IA).

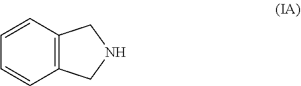

Preferable examples of the isoindoline pigment when included in the n-type pigment include compounds represented by chemical formulas (I1) and (I2).

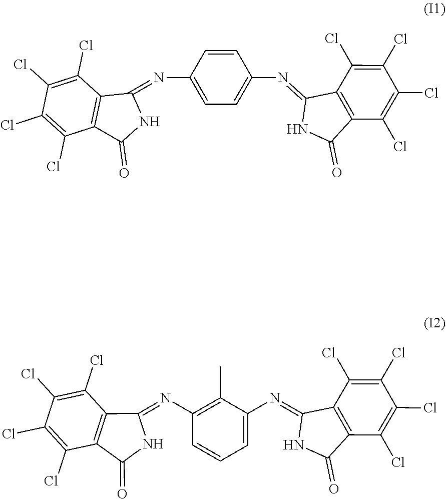 [SMILES: O=C1N/C(=N\c2ccc(/N=C3\NC(=O)c4c(Cl)c(Cl)c(Cl)c(Cl)c43)cc2)c2c(Cl)c(Cl)c(Cl)c(Cl)c21 ; Cc1c(/N=C2\NC(=O)c3c(Cl)c(Cl)c(Cl)c(Cl)c32)cccc1/N=C1\NC(=O)c2c(Cl)c(Cl)c(Cl)c(Cl)c21]

Note that the n-type pigment may include an n-type pigment other than any of the azo pigment, the perylene pigment, and the isoindoline pigment described above. Examples of the n-type pigment other than any of the azo pigment, the perylene pigment, and the isoindoline pigment include polycyclic quinone-based pigments, squarylium-based pigments, pyranthrone-based pigments, perinone-based pigments, quinacridone-based pigments, pyrazoline-based pigments, and benzimidazolone-based pigments.

The content of the n-type pigment is preferably greater than 0.0 parts by mass relative to 100.0 parts by mass of the binder resin, and more preferably at least 0.5 parts by mass. The content of the n-type pigment is preferably no greater than 10.0 parts by mass relative to 100.0 parts by mass of the binder resin, and more preferably no greater than 5.0 parts by mass.

(Additive)

The additive includes a compound represented by any of general formulas (31), (32), and (33) (also referred to below as additives (31), (32), and (33), respectively). In the following, “any of the additives (31), (32), and (33)” may be also referred to below as “specific additive”. As a result of the photosensitive layer containing the charge transport material (1) and the specific additive, positive chargeability of the photosensitive member when positive charging and negative charging alternately transition can be particularly increased. Furthermore, as a result of the photosensitive layer containing the charge transport material (1) and the specific additive, transformation of the photosensitive layer and deformation of the photosensitive layer due to contact with a member of the image forming apparatus (e.g., a cleaning member) can be inhibited even in a high-temperature environment. An image forming apparatus including a photosensitive member such as above is less likely to produce defects even under transportation, storage, or installation in a high-temperature environment. Furthermore, as a result of the photosensitive layer containing the charge transport material (1) and the specific additive, abrasion resistance of the photosensitive member can be increased.

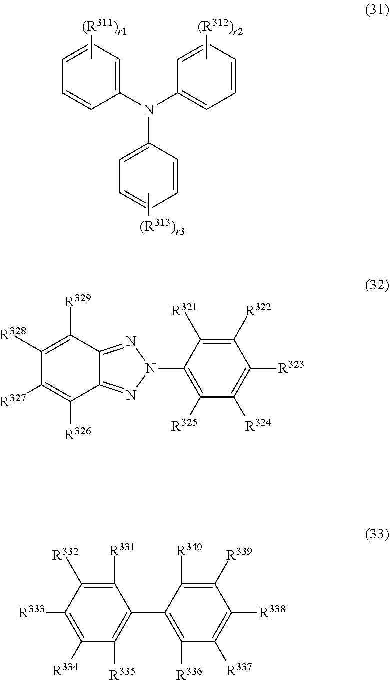

In general formula (31), R³¹¹, R³¹², and R³¹³ each represent, independently of one another, an alkyl group having a carbon number of at least 1 and no greater than 6 or an alkoxy group having a carbon number of at least 1 and no greater than 6. r1, r2, and r3 each represent, independently of one another, an integer of at least 0 and no greater than 5.

Where r1 represents an integer of at least 2 and no greater than 5, chemical groups R³¹¹ may represent the same as or different from one another. Where r2 represents an integer of at least 2 and no greater than 5, chemical groups R³¹² may be the same as or different from one another. Where r3 represents an integer of at least 2 and no greater than 5, chemical groups R³¹³ may be the same as or different from one another. No particular limitations are placed on the bonding site of each of R³¹¹, R³¹², and R³¹³. R³¹¹ may be located at any of the ortho position, the meta position, and the para position of the phenyl group, and preferably located at the para position thereof. R³¹² may be located at any of the ortho position, the meta position, and the para position of the phenyl group, and preferably located at the para position thereof. R³¹³ may be located at any of the ortho position, the meta position, and the para position of the phenyl group, and preferably located at the para position thereof.

In general formula (31), R³¹¹, R³¹², and R³¹³ each represent preferably an alkyl group having a carbon number of at least 1 and no greater than 6, more preferably an alkyl group having a carbon number of at least 1 and no greater than 3, and further preferably a methyl group. Preferably, r1, r2, and r3 each represent 0 or 1.

In general formula (32), R³²¹, R³²², R³²³, R³²⁴, R³²⁵, R³²⁶, R³²⁷, R³²⁸, and R³²⁹ each represent, independently of one another, a hydrogen atom, a hydroxy group, a halogen atom, or an alkyl group having a carbon number of at least 1 and no greater than 6.

A halogen atom represented by any of R³²¹, R³²², R³²³, R³²⁴, R³²⁵, R³²⁶, R³²⁷, R³²⁸, and R³²⁹ in general formula (32) is preferably a chlorine atom.

An alkyl group having a carbon number of at least 1 and no greater than 6 that is represented by any of R³²¹, R³²², R³²³, R³²⁴, R³²⁵, R³²⁶, R³²⁷, R³²⁸, and R³²⁹ in general formula (32) is preferably an alkyl group having a carbon number of at least 1 and no greater than 4, and more preferably a methyl group or a tert-butyl group.

In general formula (32), preferably, R³²¹, R³²², R³²³, R³²⁴, R³²⁵, R³²⁶, R³²⁷, R³²⁸, and R³²⁹ each represent, independently of one another, a hydrogen atom, a hydroxy group, a halogen atom, or an alkyl group having a carbon number of at least 1 and no greater than 4.

In general formula (33), R³³¹, R³³⁵, R³³⁶, and R³⁴⁰ each represent, independently of one another, a hydrogen atom, a nitro group, or an alkyl group having a carbon number of at least 1 and no greater than 6 that is optionally substituted with an aryl group having a carbon number of at least 6 and no greater than 14. R³³², R³³³, R³³⁴, R³³⁷, R³³⁸, and R³³⁹ each represent, independently of one another, a hydrogen atom, a nitro group, an alkyl group having a carbon number of at least 1 and no greater than 6 that is optionally substituted with an aryl group having a carbon number of at least 6 and no greater than 14, or an aryl group having a carbon number of at least 6 and no greater than 14.

An aryl group having a carbon number of at least 6 and no greater than 14 that is represented by any of R³³², R³³³, R³³⁴, R³³⁷, R³³⁸, and R³³⁹ in general formula (33) is preferably a phenyl group.

An alkyl group having a carbon number of at least 1 and no greater than 6 that is represented by any of R³³¹ to R³⁴⁰ in general formula (33) is preferably an alkyl group having a carbon number of at least 1 and no greater than 3, and more preferably a methyl group. The alkyl group having a carbon number of at least 1 and no greater than 6 may be substituted with an aryl group having a carbon number of at least 6 and no greater than 14.

Preferably, R³³¹, R³³⁵, R³³⁶, and R³⁴⁰ in general formula (33) each represent a hydrogen atom. Preferably, R³³², R³³³, R³³⁴, R³³⁷, R³³⁸, and R³³⁹ each represent, independently of one another, a hydrogen atom, an alkyl group having a carbon number of at least 1 and no greater than 3, or an aryl group having a carbon number of at least 6 and no greater than 10.

In order to increase abrasion resistance, positive chargeability of the photosensitive member when positive charging and negative charging alternately transition, and storability in a high-temperature environment, the additive (31) is preferably a compound represented by chemical formula (AD1) or (AD6). The additive (32) is preferably a compound represented by chemical formula (AD2) or (AD3). The additive (33) is preferably a compound represented by chemical formula (AD4) or (AD5). In the following, the compounds represented by chemical formulas (AD1) to (AD6) may be also referred to below as additives (AD1) to (AD6), respectively.

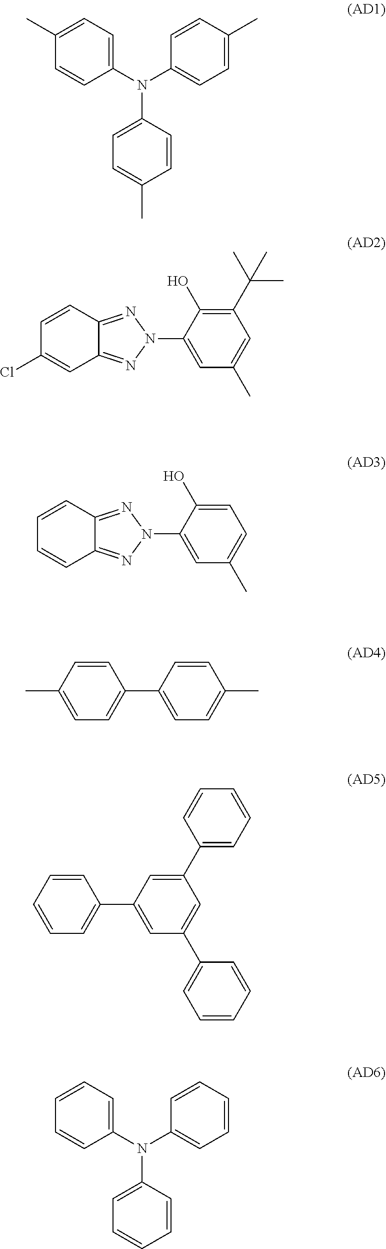

The specific additive has a melting point of preferably at least 90° C. and no higher than 300° C., more preferably at least 100° C. and no higher than 200° C., and further preferably at least 117° C. and no higher than 173° C. Usually, when a low-molecular compound such as an additive is mixed with a binder resin, the glass transition point of the resultant mixture tends to be lower than the glass transition point of the binder resin itself. However, when the melting point of the specific additive is at least 90° C. and no higher than 300° C., the glass transition point of the resultant mixture can be inhibited from being lower than that of the binder resin. Therefore, as a result of the photosensitive layer containing the binder resin and the specific additive having a melting point of at least 90° C. and no higher than 300° C., the glass transition point of the photosensitive layer can be inhibited from being lower than that of the binder resin.

Therefore, transformation and deformation of the photosensitive layer can be particularly inhibited even in a high-temperature environment, thereby increasing storability of the photosensitive member in a high-temperature environment. The melting point of the specific additive is measured using a differential scanning calorimeter (“DSC7020”, product of Hitachi High-Tech Science Corporation), for example. A start point of a measured melt peak is taken to be a melting point.

The content of the specific additive is preferably greater than 0.0 parts by mass relative to 100.0 parts by mass of the binder resin, and more preferably at least 0.5 parts by mass. The content of the specific additive is preferably no greater than 50.0 parts by mass relative to 100.0 parts by mass of the binder resin, and more preferably no greater than 30.0 parts by mass.

The additive may include only the specific additive. Alternatively, the additive may further include an additive other than the specific additive described above. Examples of the additive other than the specific additive include a radical scavenger, a singlet quencher, a softener, a surface modifier, an extender, a thickener, a dispersion stabilizer, a wax, a donor, a surfactant, a plasticizer, a sensitizer, an electron acceptor compound, and a leveling agent.

(Material Combination)

In order to increase abrasion resistance and positive chargeability when positive charging and negative charging alternately transition, a combination of the electron transport material and the binder resin is preferably any of combinations Nos. a-1 to a-28 and b-1 to b-30 shown in Table 1. For the same purpose as above, it is more preferable that the combination of the electron transport material and the binder resin be any of the combinations Nos. a-1 to a-28 and b-1 to b-30 shown in Table 1 and the charge generating material be Y-form titanyl phthalocyanine.

In order to increase photosensitivity, abrasion resistance, and positive chargeability when positive charging and negative charging alternately transition, a combination of the n-type pigment, the electron transport material, and the binder resin is preferably any of combinations Nos. c-1 to c-36 and d-1 to d-38 shown in Tables 2 and 3. For the same purpose as above, it is more preferable that the combination of the n-type pigment, the electron transport material, and the binder resin be any of the combinations Nos. c-1 to c-36 and d-1 to d-38 shown in Tables 2 and 3 and the charge generating material be Y-form titanyl phthalocyanine.

In order to increase photosensitivity, abrasion resistance, and positive chargeability when positive charging and negative charging alternately transition, a combination of the n-type pigment, the hole transport material, the electron transport material, and the binder resin is preferably any of combinations Nos. e-1 to e-48 and f-1 to f-50 shown in Tables 4 and 5. For the same purpose as above, it is more preferable that the combination of the n-type pigment, the hole transport material, the electron transport material, and the binder resin be any of the combinations Nos. e-1 to e-48 and f-1 to f-50 shown in Tables 4 and 5 and the charge generating material be Y-form titanyl phthalocyanine.

In order to increase abrasion resistance and positive chargeability when positive charging and negative charging alternately transition, a combination of the hole transport material, the electron transport material, and the binder resin is preferably any of combinations Nos. 2c-1 to 2c-37 and 2d-1 to 2d-39 shown in Tables 6 and 7. For the same purpose as above, it is more preferable that the combination of the hole transport material, the electron transport material, and the binder resin be any of the combinations Nos. 2c-1 to 2c-37 and 2d-1 to 2d-39 shown in Tables 6 and 7 and the charge generating material be Y-form titanyl phthalocyanine.

In order to increase abrasion resistance, positive chargeability when positive charging and negative charging alternately transition, and storability in a high-temperature environment, a combination of the specific additive, the electron transport material, and the binder resin is preferably any of combinations Nos. 3a-1 to 3a-30 and 3b-1 to 3b-32 shown in Tables 8 and 9. For the same purpose as above, it is more preferable that the combination of the specific additive, the electron transport material, and the binder resin be any of the combinations Nos. 3a-1 to 3a-30 and 3b-1 to 3b-32 shown in Tables 8 and 9 and the charge generating material be Y-form titanyl phthalocyanine.

In order to increase abrasion resistance, positive chargeability when positive charging and negative charging alternately transition, and storability in a high-temperature environment, a combination of the specific additive, the hole transport material, the electron transport material, and the binder resin is preferably any of combinations Nos. 3c-1 to 3c-43 and 3d-1 to 3d-45 shown in Tables 10 and 11. For the same purpose as above, it is more preferable that the combination of the specific additive, the hole transport material, the electron transport material, and the binder resin be any of the combinations Nos. 3c-1 to 3c-43 and 3d-1 to 3d-45 shown in Tables 10 and 11 and the charge generating material be Y-form titanyl phthalocyanine.

Note that the terms in Tables 1 to 11 below are as follows. “No.” refers to the number of a combination. “HTM” refers to hole transport material. “ETM” refers to electron transport material. “Resin” refers to binder resin (more specifically, polycarbonate resin).

TABLE 1

| No. | ETM | Resin |
|---|---|---|
| a-1 | ETM1 | PC-E |
| a-2 | ETM2 | PC-E |
| a-3 | ETM6 | PC-E |
| a-4 | ETM7 | PC-E |
| a-5 | ETM8 | PC-E |
| a-6 | ETM19 | PC-E |
| a-7 | ETM22 | PC-E |
| a-8 | ETM23 | PC-E |
| a-9 | ETM24 | PC-E |
| a-10 | ETM28 | PC-E |
| a-11 | ETM29 | PC-E |
| a-12 | ETM1 | PC-F |
| a-13 | ETM1 | PC-G |
| a-14 | ETM1 | PC-H |
| a-15 | ETM1 | PC-I |
| a-16 | ETM1 | PC-B |
| a-17 | ETM1 | PC-A |
| a-18 | ETM1 | PC-C |
| a-19 | ETM1 | PC-D |
| a-20 | ETM1 | PC-J |
| a-21 | ETM1 | PC-K |
| a-22 | ETM29 | PC-A |
| a-23 | ETM6 | PC-D |
| a-24 | ETM7 | PC-A |
| a-25 | ETM19 | PC-A |
| a-26 | ETM6 | PC-B |
| a-27 | ETM8 | PC-A |
| a-28 | ETM28 | PC-A |
| b-1 | ETM1 | R1 |
| b-2 | ETM2 | R1 |
| b-3 | ETM6 | R1 |
| b-4 | ETM7 | R1 |
| b-5 | ETM8 | R1 |
| b-6 | ETM19 | R1 |
| b-7 | ETM22 | R1 |
| b-8 | ETM23 | R1 |
| b-9 | ETM24 | R1 |
| b-10 | ETM28 | R1 |
| b-11 | ETM29 | R1 |
| b-12 | ETM1 | R2 |
| b-13 | ETM1 | R3 |
| b-14 | ETM1 | R4 |
| b-15 | ETM1 | R5 |
| b-16 | ETM1 | R6 |
| b-17 | ETM1 | R7 |
| b-18 | ETM1 | R8 |
| b-19 | ETM1 | R9 |
| b-20 | ETM1 | R10 |
| b-21 | ETM1 | R11 |
| b-22 | ETM1 | R12 |
| b-23 | ETM1 | R13 |
| b-24 | ETM29 | R9 |
| b-25 | ETM6 | R11 |
| b-26 | ETM7 | R9 |
| b-27 | ETM19 | R9 |
| b-28 | ETM6 | R8 |
| b-29 | ETM8 | R9 |
| b-30 | ETM28 | R9 |

TABLE 2

| | n-type | | |
|---|---|---|---|
| No. | pigment | ETM | Resin |
| c-1 | A1 | ETM1 | PC-E |
| c-2 | A1 | ETM2 | PC-E |
| c-3 | A1 | ETM6 | PC-E |
| c-4 | A1 | ETM7 | PC-E |
| c-5 | A1 | ETM8 | PC-E |
| c-6 | A1 | ETM19 | PC-E |
| c-7 | A1 | ETM22 | PC-E |
| c-8 | A1 | ETM23 | PC-E |
| c-9 | A1 | ETM24 | PC-E |
| c-10 | A1 | ETM28 | PC-E |
| c-11 | A1 | ETM29 | PC-E |
| c-12 | A2 | ETM1 | PC-E |
| c-13 | A3 | ETM1 | PC-E |
| c-14 | A4 | ETM1 | PC-E |
| c-15 | A5 | ETM1 | PC-E |
| c-16 | P1 | ETM1 | PC-E |
| c-17 | P2 | ETM1 | PC-E |
| c-18 | P3 | ETM1 | PC-E |
| c-19 | P4 | ETM1 | PC-E |
| c-20 | I1 | ETM1 | PC-E |
| c-21 | I2 | ETM1 | PC-E |
| d-1 | A1 | ETM1 | R1 |
| d-2 | A1 | ETM2 | R1 |
| d-3 | A1 | ETM6 | R1 |
| d-4 | A1 | ETM7 | R1 |
| d-5 | A1 | ETM8 | R1 |
| d-6 | A1 | ETM19 | R1 |
| d-7 | A1 | ETM22 | R1 |
| d-8 | A1 | ETM23 | R1 |
| d-9 | A1 | ETM24 | R1 |
| d-10 | A1 | ETM28 | R1 |
| d-11 | A1 | ETM29 | R1 |
| d-12 | A2 | ETM1 | R1 |
| d-13 | A3 | ETM1 | R1 |
| d-14 | A4 | ETM1 | R1 |
| d-15 | A5 | ETM1 | R1 |
| d-16 | P1 | ETM1 | R1 |
| d-17 | P2 | ETM1 | R1 |
| d-18 | P3 | ETM1 | R1 |
| d-19 | P4 | ETM1 | R1 |
| d-20 | I1 | ETM1 | R1 |
| d-21 | I2 | ETM1 | R1 |
| d-22 | A1 | ETM1 | R2 |
| d-23 | A1 | ETM1 | R3 |

TABLE 3

| | n-type | | |
|---|---|---|---|
| No. | pigment | ETM | Resin |
| c-22 | A1 | ETM1 | PC-F |
| c-23 | A1 | ETM1 | PC-G |
| c-24 | A1 | ETM1 | PC-H |
| c-25 | A1 | ETM1 | PC-I |
| c-26 | A1 | ETM1 | PC-B |
| c-27 | A1 | ETM1 | PC-A |
| c-28 | A1 | ETM1 | PC-C |
| c-29 | A1 | ETM1 | PC-D |
| c-30 | A1 | ETM1 | PC-J |
| c-31 | A1 | ETM1 | PC-K |
| c-32 | A5 | ETM29 | PC-E |
| c-33 | A5 | ETM29 | PC-A |
| c-34 | A1 | ETM6 | PC-D |
| c-35 | P1 | ETM7 | PC-A |
| c-36 | P1 | ETM19 | PC-A |
| d-24 | A1 | ETM1 | R4 |
| d-25 | A1 | ETM1 | R5 |
| d-26 | A1 | ETM1 | R6 |
| d-27 | A1 | ETM1 | R7 |
| d-28 | A1 | ETM1 | R8 |
| d-29 | A1 | ETM1 | R9 |
| d-30 | A1 | ETM1 | R10 |
| d-31 | A1 | ETM1 | R11 |
| d-32 | A1 | ETM1 | R12 |
| d-33 | A1 | ETM1 | R13 |
| d-34 | A5 | ETM29 | R1 |
| d-35 | A5 | ETM29 | R9 |
| d-36 | A1 | ETM6 | R11 |
| d-37 | P1 | ETM7 | R9 |
| d-38 | P1 | ETM19 | R9 |

TABLE 4

| | n-type | | | |
|---|---|---|---|---|
| No. | pigment | HTM | ETM | Resin |
| e-1 | A1 | HTM1 | ETM1 | PC-E |
| e-2 | A1 | HTM1 | ETM2 | PC-E |
| e-3 | A1 | HTM1 | ETM6 | PC-E |
| e-4 | A1 | HTM1 | ETM7 | PC-E |
| e-5 | A1 | HTM1 | ETM8 | PC-E |
| e-6 | A1 | HTM1 | ETM19 | PC-E |
| e-7 | A1 | HTM1 | ETM22 | PC-E |
| e-8 | A1 | HTM1 | ETM23 | PC-E |
| e-9 | A1 | HTM1 | ETM24 | PC-E |
| e-10 | A1 | HTM1 | ETM28 | PC-E |
| e-11 | A1 | HTM1 | ETM29 | PC-E |
| e-12 | A1 | HTM2 | ETM1 | PC-E |
| e-13 | A1 | HTM3 | ETM1 | PC-E |
| e-14 | A1 | HTM4 | ETM1 | PC-E |
| e-15 | A1 | HTM5 | ETM1 | PC-E |
| e-16 | A1 | HTM6 | ETM1 | PC-E |
| e-17 | A1 | HTM7 | ETM1 | PC-E |
| e-18 | A1 | HTM8 | ETM1 | PC-E |
| e-19 | A1 | HTM9 | ETM1 | PC-E |
| e-20 | A1 | HTM10 | ETM1 | PC-E |
| f-1 | A1 | HTM1 | ETM1 | R1 |
| f-2 | A1 | HTM1 | ETM2 | R1 |
| f-3 | A1 | HTM1 | ETM6 | R1 |
| f-4 | A1 | HTM1 | ETM7 | R1 |
| f-5 | A1 | HTM1 | ETM8 | R1 |
| f-6 | A1 | HTM1 | ETM19 | R1 |
| f-7 | A1 | HTM1 | ETM22 | R1 |
| f-8 | A1 | HTM1 | ETM23 | R1 |
| f-9 | A1 | HTM1 | ETM24 | R1 |
| f-10 | A1 | HTM1 | ETM28 | R1 |
| f-11 | A1 | HTM1 | ETM29 | R1 |
| f-12 | A1 | HTM2 | ETM1 | R1 |
| f-13 | A1 | HTM3 | ETM1 | R1 |
| f-14 | A1 | HTM4 | ETM1 | R1 |
| f-15 | A1 | HTM5 | ETM1 | R1 |
| f-16 | A1 | HTM6 | ETM1 | R1 |
| f-17 | A1 | HTM7 | ETM1 | R1 |
| f-18 | A1 | HTM8 | ETM1 | R1 |
| f-19 | A1 | HTM9 | ETM1 | R1 |
| f-20 | A1 | HTM10 | ETM1 | R1 |

TABLE 5

| | n-type | | | |
|---|---|---|---|---|
| No. | pigment | HTM | ETM | Resin |
| e-21 | A2 | HTM1 | ETM1 | PC-E |
| e-22 | A3 | HTM1 | ETM1 | PC-E |
| e-23 | A4 | HTM1 | ETM1 | PC-E |
| e-24 | A5 | HTM1 | ETM1 | PC-E |
| e-25 | P1 | HTM1 | ETM1 | PC-E |
| e-26 | P2 | HTM1 | ETM1 | PC-E |
| e-27 | P3 | HTM1 | ETM1 | PC-E |
| e-28 | P4 | HTM1 | ETM1 | PC-E |
| e-29 | I1 | HTM1 | ETM1 | PC-E |
| e-30 | I2 | HTM1 | ETM1 | PC-E |
| e-31 | A1 | HTM1 | ETM1 | PC-F |
| e-32 | A1 | HTM1 | ETM1 | PC-G |
| e-33 | A1 | HTM1 | ETM1 | PC-H |
| e-34 | A1 | HTM1 | ETM1 | PC-I |
| e-35 | A1 | HTM1 | ETM1 | PC-B |
| e-36 | A1 | HTM1 | ETM1 | PC-A |
| e-37 | A1 | HTM7 | ETM1 | PC-A |
| e-38 | A1 | HTM1 | ETM1 | PC-C |
| e-39 | A1 | HTM1 | ETM1 | PC-D |
| e-40 | A1 | HTM1 | ETM1 | PC-J |
| e-41 | A1 | HTM1 | ETM1 | PC-K |
| e-42 | A5 | HTM8 | ETM29 | PC-E |
| e-43 | A5 | HTM8 | ETM29 | PC-A |
| e-44 | A1 | HTM1 | ETM6 | PC-D |
| e-45 | P1 | HTM7 | ETM7 | PC-A |
| e-46 | P1 | HTM7 | ETM19 | PC-A |
| e-47 | P1 | HTM8 | ETM7 | PC-A |
| e-48 | P1 | HTM8 | ETM19 | PC-A |
| f-21 | A2 | HTM1 | ETM1 | R1 |
| f-22 | A3 | HTM1 | ETM1 | R1 |
| f-23 | A4 | HTM1 | ETM1 | R1 |
| f-24 | A5 | HTM1 | ETM1 | R1 |
| f-25 | P1 | HTM1 | ETM1 | R1 |
| f-26 | P2 | HTM1 | ETM1 | R1 |
| f-27 | P3 | HTM1 | ETM1 | R1 |
| f-28 | P4 | HTM1 | ETM1 | R1 |
| f-29 | I1 | HTM1 | ETM1 | R1 |
| f-30 | I2 | HTM1 | ETM1 | R1 |
| f-31 | A1 | HTM1 | ETM1 | R2 |
| f-32 | A1 | HTM1 | ETM1 | R3 |
| f-33 | A1 | HTM1 | ETM1 | R4 |
| f-34 | A1 | HTM1 | ETM1 | R5 |
| f-35 | A1 | HTM1 | ETM1 | R6 |
| f-36 | A1 | HTM1 | ETM1 | R7 |
| f-37 | A1 | HTM1 | ETM1 | R8 |
| f-38 | A1 | HTM1 | ETM1 | R9 |
| f-39 | A1 | HTM7 | ETM1 | R9 |
| f-40 | A1 | HTM1 | ETM1 | R10 |
| f-41 | A1 | HTM1 | ETM1 | R11 |
| f-42 | A1 | HTM1 | ETM1 | R12 |
| f-43 | A1 | HTM1 | ETM1 | R13 |
| f-44 | A5 | HTM8 | ETM29 | R1 |
| f-45 | A5 | HTM8 | ETM29 | R9 |
| f-46 | A1 | HTM1 | ETM6 | R11 |
| f-47 | P1 | HTM7 | ETM7 | R9 |
| f-48 | P1 | HTM7 | ETM19 | R9 |
| f-49 | P1 | HTM8 | ETM7 | R9 |
| f-50 | P1 | HTM8 | ETM19 | R9 |

TABLE 6

| No. | HTM | ETM | Resin |
|---|---|---|---|
| 2c-1 | HTM1 | ETM1 | PC-E |
| 2c-2 | HTM1 | ETM2 | PC-E |
| 2c-3 | HTM1 | ETM6 | PC-E |
| 2c-4 | HTM1 | ETM7 | PC-E |
| 2c-5 | HTM1 | ETM8 | PC-E |
| 2c-6 | HTM1 | ETM19 | PC-E |
| 2c-7 | HTM1 | ETM22 | PC-E |
| 2c-8 | HTM1 | ETM23 | PC-E |
| 2c-9 | HTM1 | ETM24 | PC-E |
| 2c-10 | HTM1 | ETM28 | PC-E |
| 2c-11 | HTM1 | ETM29 | PC-E |
| 2c-12 | HTM2 | ETM1 | PC-E |
| 2c-13 | HTM3 | ETM1 | PC-E |
| 2c-14 | HTM4 | ETM1 | PC-E |
| 2c-15 | HTM5 | ETM1 | PC-E |
| 2c-16 | HTM6 | ETM1 | PC-E |
| 2c-17 | HTM7 | ETM1 | PC-E |
| 2c-18 | HTM8 | ETM1 | PC-E |
| 2c-19 | HTM9 | ETM1 | PC-E |
| 2c-20 | HTM10 | ETM1 | PC-E |
| 2d-1 | HTM1 | ETM1 | R1 |
| 2d-2 | HTM1 | ETM1 | R2 |
| 2d-3 | HTM1 | ETM1 | R3 |
| 2d-4 | HTM1 | ETM2 | R1 |
| 2d-5 | HTM1 | ETM6 | R1 |
| 2d-6 | HTM1 | ETM7 | R1 |
| 2d-7 | HTM1 | ETM8 | R1 |
| 2d-8 | HTM1 | ETM19 | R1 |
| 2d-9 | HTM1 | ETM22 | R1 |
| 2d-10 | HTM1 | ETM23 | R1 |
| 2d-11 | HTM1 | ETM24 | R1 |
| 2d-12 | HTM1 | ETM28 | R1 |
| 2d-13 | HTM1 | ETM29 | R1 |
| 2d-14 | HTM2 | ETM1 | R1 |
| 2d-15 | HTM3 | ETM1 | R1 |
| 2d-16 | HTM4 | ETM1 | R1 |
| 2d-17 | HTM5 | ETM1 | R1 |
| 2d-18 | HTM6 | ETM1 | R1 |
| 2d-19 | HTM7 | ETM1 | R1 |
| 2d-20 | HTM8 | ETM1 | R1 |
| 2d-21 | HTM9 | ETM1 | R1 |
| 2d-22 | HTM10 | ETM1 | R1 |

TABLE 7

| No. | HTM | ETM | Resin |
|---|---|---|---|
| 2c-21 | HTM1 | ETM1 | PC-F |
| 2c-22 | HTM1 | ETM1 | PC-G |
| 2c-23 | HTM1 | ETM1 | PC-H |
| 2c-24 | HTM1 | ETM1 | PC-I |
| 2c-25 | HTM1 | ETM1 | PC-B |
| 2c-26 | HTM1 | ETM1 | PC-A |
| 2c-27 | HTM7 | ETM1 | PC-A |
| 2c-28 | HTM1 | ETM1 | PC-C |
| 2c-29 | HTM1 | ETM1 | PC-D |
| 2c-30 | HTM1 | ETM1 | PC-J |
| 2c-31 | HTM1 | ETM1 | PC-K |
| 2c-32 | HTM7 | ETM29 | PC-E |
| 2c-33 | HTM1 | ETM6 | PC-B |
| 2c-34 | HTM7 | ETM8 | PC-A |
| 2c-35 | HTM7 | ETM28 | PC-A |
| 2c-36 | HTM8 | ETM8 | PC-A |
| 2c-37 | HTM8 | ETM28 | PC-A |
| 2d-23 | HTM1 | ETM1 | R4 |
| 2d-24 | HTM1 | ETM1 | R5 |
| 2d-25 | HTM1 | ETM1 | R6 |
| 2d-26 | HTM1 | ETM1 | R7 |
| 2d-27 | HTM1 | ETM1 | R8 |
| 2d-28 | HTM1 | ETM1 | R9 |
| 2d-29 | HTM7 | ETM1 | R9 |
| 2d-30 | HTM1 | ETM1 | R10 |
| 2d-31 | HTM1 | ETM1 | R11 |
| 2d-32 | HTM1 | ETM1 | R12 |
| 2d-33 | HTM1 | ETM1 | R13 |
| 2d-34 | HTM7 | ETM29 | R1 |
| 2d-35 | HTM1 | ETM6 | R8 |
| 2d-36 | HTM7 | ETM8 | R9 |
| 2d-37 | HTM7 | ETM28 | R9 |
| 2d-38 | HTM8 | ETM8 | R9 |
| 2d-39 | HTM8 | ETM28 | R9 |

TABLE 8

| No. | Additive | ETM | Resin |
|---|---|---|---|
| 3a-1 | AD1 | ETM1 | PC-E |
| 3a-2 | AD1 | ETM2 | PC-E |
| 3a-3 | AD1 | ETM6 | PC-E |
| 3a-4 | AD1 | ETM7 | PC-E |
| 3a-5 | AD1 | ETM8 | PC-E |
| 3a-6 | AD1 | ETM19 | PC-E |
| 3a-7 | AD1 | ETM22 | PC-E |
| 3a-8 | AD1 | ETM23 | PC-E |
| 3a-9 | AD1 | ETM24 | PC-E |
| 3a-10 | AD1 | ETM28 | PC-E |
| 3a-11 | AD1 | ETM29 | PC-E |
| 3a-12 | AD2 | ETM1 | PC-E |
| 3a-13 | AD3 | ETM1 | PC-E |
| 3a-14 | AD4 | ETM1 | PC-E |
| 3a-15 | AD5 | ETM1 | PC-E |
| 3a-16 | AD6 | ETM1 | PC-E |
| 3b-1 | AD1 | ETM1 | R1 |
| 3b-2 | AD1 | ETM2 | R1 |
| 3b-3 | AD1 | ETM6 | R1 |
| 3b-4 | AD1 | ETM7 | R1 |
| 3b-5 | AD1 | ETM8 | R1 |
| 3b-6 | AD1 | ETM19 | R1 |
| 3b-7 | AD1 | ETM22 | R1 |
| 3b-8 | AD1 | ETM23 | R1 |
| 3b-9 | AD1 | ETM24 | R1 |
| 3b-10 | AD1 | ETM28 | R1 |
| 3b-11 | AD1 | ETM29 | R1 |
| 3b-12 | AD2 | ETM1 | R1 |
| 3b-13 | AD3 | ETM1 | R1 |
| 3b-14 | AD4 | ETM1 | R1 |
| 3b-15 | AD5 | ETM1 | R1 |
| 3b-16 | AD6 | ETM1 | R1 |
| 3b-17 | AD1 | ETM1 | R2 |
| 3b-18 | AD1 | ETM1 | R3 |

TABLE 9

| No. | Additive | ETM | Resin |
|---|---|---|---|
| 3a-17 | AD1 | ETM1 | PC-F |
| 3a-18 | AD1 | ETM1 | PC-G |
| 3a-19 | AD1 | ETM1 | PC-H |
| 3a-20 | AD1 | ETM1 | PC-I |
| 3a-21 | AD1 | ETM1 | PC-B |
| 3a-22 | AD1 | ETM1 | PC-A |
| 3a-23 | AD2 | ETM1 | PC-A |
| 3a-24 | AD1 | ETM1 | PC-C |
| 3a-25 | AD1 | ETM1 | PC-D |
| 3a-26 | AD1 | ETM1 | PC-J |
| 3a-27 | AD1 | ETM1 | PC-K |
| 3a-28 | AD6 | ETM6 | PC-B |
| 3a-29 | AD5 | ETM23 | PC-B |
| 3a-30 | AD5 | ETM23 | PC-A |
| 3b-19 | AD1 | ETM1 | R4 |
| 3b-20 | AD1 | ETM1 | R5 |
| 3b-21 | AD1 | ETM1 | R6 |
| 3b-22 | AD1 | ETM1 | R7 |
| 3b-23 | AD1 | ETM1 | R8 |
| 3b-24 | AD1 | ETM1 | R9 |
| 3b-25 | AD2 | ETM1 | R9 |
| 3b-26 | AD1 | ETM1 | R10 |
| 3b-27 | AD1 | ETM1 | R11 |
| 3b-28 | AD1 | ETM1 | R12 |
| 3b-29 | AD1 | ETM1 | R13 |
| 3b-30 | AD6 | ETM6 | R8 |
| 3b-31 | AD5 | ETM23 | R8 |
| 3b-32 | AD5 | ETM23 | R9 |

TABLE 10

| No. | Additive | HTM | ETM | Resin |
|---|---|---|---|---|
| 3c-1 | AD1 | HTM1 | ETM1 | PC-E |
| 3c-2 | AD1 | HTM1 | ETM2 | PC-E |
| 3c-3 | AD1 | HTM1 | ETM6 | PC-E |
| 3c-4 | AD1 | HTM1 | ETM7 | PC-E |
| 3c-5 | AD1 | HTM1 | ETM8 | PC-E |
| 3c-6 | AD1 | HTM1 | ETM19 | PC-E |
| 3c-7 | AD1 | HTM1 | ETM22 | PC-E |
| 3c-8 | AD1 | HTM1 | ETM23 | PC-E |
| 3c-9 | AD1 | HTM1 | ETM24 | PC-E |
| 3c-10 | AD1 | HTM1 | ETM28 | PC-E |
| 3c-11 | AD1 | HTM1 | ETM29 | PC-E |
| 3c-12 | AD1 | HTM2 | ETM1 | PC-E |
| 3c-13 | AD1 | HTM3 | ETM1 | PC-E |
| 3c-14 | AD1 | HTM4 | ETM1 | PC-E |
| 3c-15 | AD1 | HTM5 | ETM1 | PC-E |
| 3c-16 | AD1 | HTM6 | ETM1 | PC-E |
| 3c-17 | AD1 | HTM7 | ETM1 | PC-E |
| 3c-18 | AD1 | HTM8 | ETM1 | PC-E |
| 3c-19 | AD1 | HTM9 | ETM1 | PC-E |
| 3c-20 | AD1 | HTM10 | ETM1 | PC-E |
| 3d-1 | AD1 | HTM1 | ETM1 | R1 |
| 3d-2 | AD1 | HTM1 | ETM2 | R1 |
| 3d-3 | AD1 | HTM1 | ETM6 | R1 |
| 3d-4 | AD1 | HTM1 | ETM7 | R1 |
| 3d-5 | AD1 | HTM1 | ETM8 | R1 |
| 3d-6 | AD1 | HTM1 | ETM19 | R1 |
| 3d-7 | AD1 | HTM1 | ETM22 | R1 |
| 3d-8 | AD1 | HTM1 | ETM23 | R1 |
| 3d-9 | AD1 | HTM1 | ETM24 | R1 |
| 3d-10 | AD1 | HTM1 | ETM28 | R1 |
| 3d-11 | AD1 | HTM1 | ETM29 | R1 |
| 3d-12 | AD1 | HTM2 | ETM1 | R1 |
| 3d-13 | AD1 | HTM3 | ETM1 | R1 |
| 3d-14 | AD1 | HTM4 | ETM1 | R1 |
| 3d-15 | AD1 | HTM5 | ETM1 | R1 |
| 3d-16 | AD1 | HTM6 | ETM1 | R1 |
| 3d-17 | AD1 | HTM7 | ETM1 | R1 |
| 3d-18 | AD1 | HTM8 | ETM1 | R1 |
| 3d-19 | AD1 | HTM9 | ETM1 | R1 |
| 3d-20 | AD1 | HTM10 | ETM1 | R1 |

TABLE 11

| No. | Additive | HTM | ETM | Resin |
|---|---|---|---|---|
| 3c-21 | AD2 | HTM1 | ETM1 | PC-E |
| 3c-22 | AD3 | HTM1 | ETM1 | PC-E |
| 3c-23 | AD4 | HTM1 | ETM1 | PC-E |
| 3c-24 | AD5 | HTM1 | ETM1 | PC-E |
| 3c-25 | AD6 | HTM1 | ETM1 | PC-E |
| 3c-26 | AD1 | HTM1 | ETM1 | PC-F |
| 3c-27 | AD1 | HTM1 | ETM1 | PC-G |
| 3c-28 | AD1 | HTM1 | ETM1 | PC-H |
| 3c-29 | AD1 | HTM1 | ETM1 | PC-I |
| 3c-30 | AD1 | HTM1 | ETM1 | PC-B |
| 3c-31 | AD1 | HTM1 | ETM1 | PC-A |
| 3c-32 | AD1 | HTM7 | ETM1 | PC-A |
| 3c-33 | AD2 | HTM7 | ETM1 | PC-A |
| 3c-34 | AD1 | HTM1 | ETM1 | PC-C |
| 3c-35 | AD1 | HTM1 | ETM1 | PC-D |
| 3c-36 | AD1 | HTM1 | ETM1 | PC-J |
| 3c-37 | AD1 | HTM1 | ETM1 | PC-K |
| 3c-38 | AD6 | HTM1 | ETM6 | PC-B |
| 3c-39 | AD6 | HTM7 | ETM6 | PC-B |
| 3c-40 | AD5 | HTM7 | ETM23 | PC-B |
| 3c-41 | AD5 | HTM7 | ETM23 | PC-A |
| 3c-42 | AD5 | HTM8 | ETM23 | PC-B |
| 3c-43 | AD5 | HTM8 | ETM23 | PC-A |
| 3d-21 | AD2 | HTM1 | ETM1 | R1 |
| 3d-22 | AD3 | HTM1 | ETM1 | R1 |
| 3d-23 | AD4 | HTM1 | ETM1 | R1 |
| 3d-24 | AD5 | HTM1 | ETM1 | R1 |
| 3d-25 | AD6 | HTM1 | ETM1 | R1 |
| 3d-26 | AD1 | HTM1 | ETM1 | R2 |
| 3d-27 | AD1 | HTM1 | ETM1 | R3 |
| 3d-28 | AD1 | HTM1 | ETM1 | R4 |
| 3d-29 | AD1 | HTM1 | ETM1 | R5 |
| 3d-30 | AD1 | HTM1 | ETM1 | R6 |
| 3d-31 | AD1 | HTM1 | ETM1 | R7 |
| 3d-32 | AD1 | HTM1 | ETM1 | R8 |
| 3d-33 | AD1 | HTM1 | ETM1 | R9 |
| 3d-34 | AD1 | HTM7 | ETM1 | R9 |
| 3d-35 | AD2 | HTM7 | ETM1 | R9 |
| 3d-36 | AD1 | HTM1 | ETM1 | R10 |
| 3d-37 | AD1 | HTM1 | ETM1 | R11 |
| 3d-38 | AD1 | HTM1 | ETM1 | R12 |
| 3d-39 | AD1 | HTM1 | ETM1 | R13 |
| 3d-40 | AD6 | HTM1 | ETM6 | R8 |
| 3d-41 | AD6 | HTM7 | ETM6 | R8 |
| 3d-42 | AD5 | HTM7 | ETM23 | R8 |
| 3d-43 | AD5 | HTM7 | ETM23 | R9 |
| 3d-44 | AD5 | HTM8 | ETM23 | R8 |
| 3d-45 | AD5 | HTM8 | ETM23 | R9 |

(Conductive Substrate)

No specific limitations are placed on the conductive substrate other than being a conductive substrate that can be used as a conductive substrate for a photosensitive member. It is only required that at least a surface portion of the conductive substrate be made of a conductive material. An example of the conductive substrate is a conductive substrate made of a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, indium, stainless steel, and brass. Any one of the conductive materials listed above may be used independently, or two or more of the conductive materials listed above may be used in combination (as an alloy, for example). Of the conductive materials listed above, aluminum or an aluminum alloy is preferable in terms of favorable charge mobility from the photosensitive layer to the conductive substrate.

The conductive substrate is not limited to being in any particular shape and the shape thereof can be selected appropriately according to the configuration of an image forming apparatus in which the conductive substrate is to be used. The conductive substrate is for example sheet-shaped or drum-shaped. The thickness of the conductive substrate is determined as appropriate according to the shape of the conductive substrate.

(Intermediate Layer)

The intermediate layer (undercoat layer) for example contains inorganic particles and a resin for intermediate layer use (intermediate layer resin). Presence of the intermediate layer may facilitate flow of current generated when the photosensitive member is exposed to light and inhibit increasing resistance, while also maintaining insulation to a sufficient degree so as to inhibit leakage current from occurring.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as the examples of the binder resin. In order to favorably form the intermediate layer and the photosensitive layer, the intermediate layer resin preferably differs from the binder resin contained in the photosensitive layer. The intermediate layer may contain an additive. Examples of the additive that may be contained in the intermediate layer are the same as the examples of the additive contained in the photosensitive layer.

(Photosensitive Member Production Method)

The following describes an example of a photosensitive member production method. The photosensitive member production method includes a photosensitive layer formation process. In the photosensitive layer formation process, an application liquid for forming a photosensitive layer (also referred to below as application liquid for photosensitive layer formation) is prepared. The application liquid for photosensitive layer formation is applied onto a conductive substrate. Next, at least a portion of a solvent contained in the applied application liquid for photosensitive layer formation is removed to form a photosensitive layer. The application liquid for photosensitive layer formation contains a charge generating material, an electron transport material, a hole transport material, a binder resin, and the solvent, for example. The application liquid for photosensitive layer formation is prepared by dissolving or dispersing the charge generating material, the electron transport material, the hole transport material, and the binder resin in the solvent. The application liquid for photosensitive layer formation may further contain an n-type pigment and an additive as necessary.

No particular limitations are placed on the solvent contained in the application liquid for photosensitive layer formation, and examples thereof include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide.

The application liquid for photosensitive layer formation is prepared by mixing the respective components to disperse the components in the solvent. Mixing or dispersion can for example be performed using a bead mill, a roll mill, a ball mill, an attritor, a paint shaker, or an ultrasonic disperser.

No particular limitations are placed on a method for applying the application liquid for photosensitive layer formation, and any of dip coating, spray coating, spin coating, and bar coating may be adopted, for example.

Examples of a method for removing at least a portion of the solvent contained in the application liquid for photosensitive layer formation include heating, depressurization, and a combination of heating and depressurization. A specific example of the method involves heat treatment (hot-air drying) using a high-temperature dryer or a reduced pressure dryer. The temperature of the solvent in the heat treatment is for example at least 40° C. and no higher than 150° C. The time period of the heat treatment is for example 3 minutes or longer and 120 minutes or shorter.

Note that the photosensitive member production method may further include an intermediate layer formation process as necessary. Any known method can be selected as appropriate for the intermediate layer formation process.

### Second Embodiment: Image Forming Apparatus

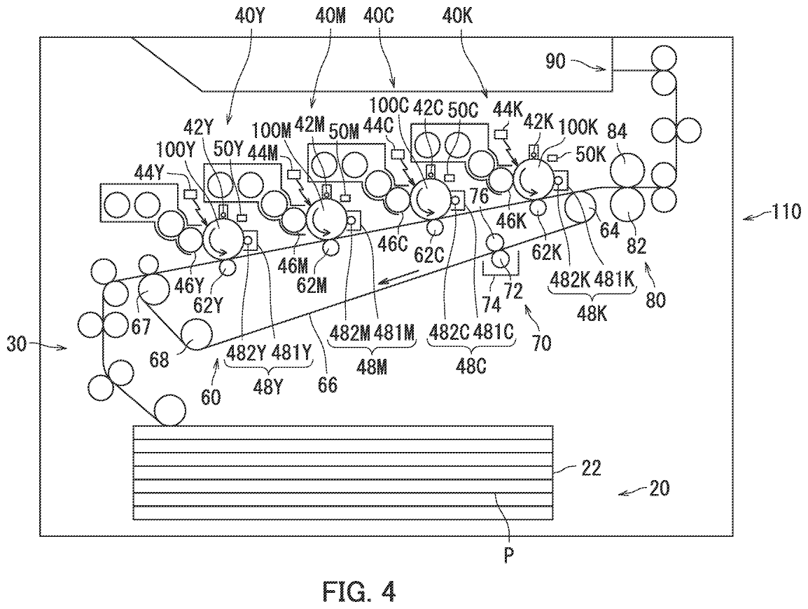

The following describes an image forming apparatus 110, which is an example of an image forming apparatus according to a second embodiment of the present disclosure, with reference to FIG. 4. FIG. 4 is a cross-sectional view of the image forming apparatus 110.

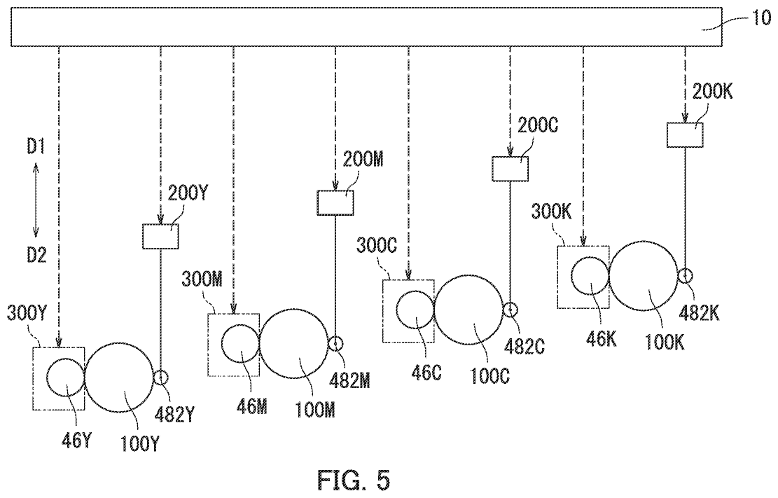

The image forming apparatus 110 illustrated in FIG. 4 includes a controller 10 (see FIG. 5), a feeding section 20, a conveyance section 30, image forming units 40Y, 40M, 40C, and 40K, a transfer section 60, a belt cleaning section 70, a fixing section 80, and a sheet ejection section 90. Note that the belt cleaning section 70 will be described in detail in the description in <Printing Mode and Cleaning Mode> below.

The controller 10 controls operation of each section of the image forming apparatus 110 (more specifically, the feeding section 20, the conveyance section 30, the image forming units 40Y, 40M, 40C, and 40K, the transfer section 60, the belt cleaning section 70, the fixing section 80, and the sheet ejection section 90). The controller 10 is disposed at an appropriate location within the casing of the image forming apparatus 110. The controller 10 includes for example a central processing unit (CPU), random-access memory (RAM), read-only memory (ROM), and an input and output interface, each of which is not illustrated. The controller 10 performs control by executing various arithmetic processing based on results of detection by various sensors and preset programs (non-transitory computer readable storage medium on which the programs have been stored).

The feeding section 20 includes a cassette 22. The cassette 22 houses a plurality of sheets of a recording medium P. The feeding section 20 feeds the recording medium P from the cassette 22 to the conveyance section 30. The recording medium P is made of paper, cloth, or synthetic resin.

The conveyance section 30 conveys the recording medium P to the image forming units 40Y, 40M, 40C, and 40K.

The image forming units 40Y, 40M, 40C, and 40K include corresponding image bearing members 100Y, 100M, 100C, and 100K, corresponding chargers 42Y, 42M, 42C, and 42K, corresponding light exposure devices 44Y, 44M, 44C, and 44K, corresponding development devices 46Y, 46M, 46C, and 46K, corresponding cleaners 48Y, 48M, 48C, and 48K, and corresponding static eliminators 50Y, 50M, 50C, and 50K. In the following, the subscripts “Y”, “M”, “C”, and “K” appended to corresponding components of the image forming apparatus 110 are omitted where there is no need to distinguish between them. For example, each of the image forming units 40Y, 40M, 40C, and 40K is referred to as image forming unit 40 where there is no need to distinguish between them.

The transfer section 60 includes four transfer devices 62Y, 62M, 62C, and 62K, a drive roller 64, an endless transfer belt 66, a driven roller 67, and a tension roller 68. The transfer device 62Y, 62M, 62C, and 62K are each disposed on the inward side of the transfer belt 66 and respectively opposite to the image bearing members 100Y, 100M, 100C, and 100K with the transfer belt 66 therebetween. The transfer belt 66 is wound around the drive roller 64, the driven roller 67, and the tension roller 68. Rotation of the drive roller 64 circulates the transfer belt 66 in the arrow direction (clockwise direction in FIG. 4).

The image bearing member 100 is disposed at the central position of the image forming unit 40. The image bearing member 100 is disposed in a rotatable manner in the arrow direction (anticlockwise direction in FIG. 4). The charger 42, the light exposure device 44, the development device 46, the transfer device 62, the cleaner 48, and the static eliminator 50 are disposed around the image bearing member 100 in the stated order from upstream in the rotational direction of the image bearing member 100.

The image bearing member 100 is the photosensitive member 1 of the first embodiment. As described previously, the photosensitive member 1 of the first embodiment can have excellent abrasion resistance and be favorably charged to the positive polarity even when positive charging and negative charging alternately transition. Therefore, as a result of the image forming apparatus 110 including the photosensitive member 1 such as above as the image bearing member 100, images can be favorably formed on the recording medium P.

The charger 42 charges the surface (e.g., the circumferential surface) of the image bearing member 100 to the positive polarity. The charger 42 is a scorotron charger, for example.

The light exposure device 44 exposes the charged surface of the image bearing member 100 to light. As a result, an electrostatic latent image is formed on the surface of the image bearing member 100. The electrostatic latent image is formed based on image data input to the image forming apparatus 110.

The development device 46 supplies a toner to the surface of the image bearing member 100 to develop the electrostatic latent image into a toner image. The toner is a positively chargeable toner. The development device 46 is in contact with the surface of the image bearing member 100. That is, the image forming apparatus 110 adopts a contact development process. In one example, the development device 46 may be a development roller.

In a case in which a developer used is a one-component developer, the development device 46 supplies a toner that is the one-component developer to the electrostatic latent image formed on the image bearing member 100. In a case in which a developer used is a two-component developer, the development device 46 supplies, of a toner and a carrier contained in the two-component developer, the toner to the electrostatic latent image formed on the image bearing member 100. The image bearing member 100 bears the toner image formed with the supplied toner.

The transfer belt 66 conveys the recording medium P to a location between the image bearing member 100 and the transfer device 62. The transfer device 62 transfers the toner image developed by the development device 46 from the surface of the image bearing member 100 to the recording medium P that is a transfer target. In transfer, the surface of the image bearing member 100 and the recording medium P are in contact with each other. That is, the image forming apparatus 110 adopts a direct transfer process. In one example, the transfer device 62 may be a transfer roller.

Toner images in multiple colors (e.g., four colors of yellow, magenta, cyan, and black) are sequentially superimposed on the recording medium P on the transfer belt 66 by the image forming unit 40Y and the transfer device 62Y, the image forming unit 40M and the transfer device 62M, the image forming unit 40C and the transfer device 62C, and the image forming unit 40K and the transfer device 62K, thereby forming an unfixed toner image.

The cleaners 48Y, 48M, 48C, and 48K include corresponding housings 481Y, 481M, 481C, and 481K and corresponding cleaning members 482Y, 482M, 482C, and 482K. The cleaning member 482 is disposed within the housing 481. The cleaning member 482 is in contact with the surface of the image bearing member 100. The cleaning member 482 polishes the surface of the image bearing member 100 to collect toner attached to the surface of the image bearing member 100 into the housing 481. In a manner as above, the cleaner 48 collects toner attached to the surface of the image bearing member 100. In one example, the cleaning member 482 may be a cleaning roller.

The static eliminator 50 performs static elimination on the surface of the image bearing member 100.

The recording medium P with the unfixed toner image formed thereon is conveyed to the fixing section 80. The fixing section 80 includes a pressure member 82 and a heating member 84. When the recording medium P receives heat and pressure by the pressure member 82 and the heating member 84, the unfixed toner image is fixed to the recording medium P.

The recording medium P with the toner image fixed thereto is ejected from the sheet ejection section 90.

<Printing Mode and Cleaning Mode>

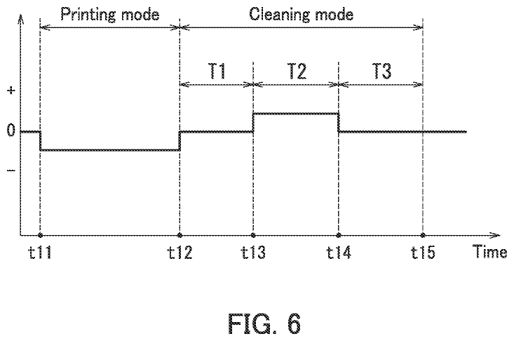

Each operation of the image forming apparatus 110 performed in a printing mode and a cleaning mode is described with reference to FIGS. 5 and 6 in addition to FIG. 4. FIG. 5 is a diagram illustrating the image bearing member 100 and the cleaning member 482 each illustrated in FIG. 4, and the controller 10. FIG. 6 is a time chart illustrating control on the cleaning member 482 in the printing mode and the cleaning mode. In FIG. 6, the horizontal axis indicates time while the vertical axis indicates voltage applied to the cleaning member 482. On the vertical axis in FIG. 6, the sign “+” indicates that positive voltage is applied, “0” indicates that no voltage is applied, and “−” indicates that negative voltage is applied.

As is previously described with reference to FIG. 4, the image forming apparatus 110 includes a controller 10 and a belt cleaning section 70. As also illustrated in FIG. 5, the image forming apparatus 110 further includes voltage applicators 200Y, 200M, 200C, and 200K and moving mechanisms 300Y, 300M, 300C, and 300K. Note that the subscripts “Y”, “M”, “C”, and “K” appended to corresponding components of the image forming apparatus 110 are omitted where there is no need to distinguish between them as described previously.

The controller 10 controls the voltage applicator 200 to control voltage applied to the cleaning member 482.

In the cleaning mode, the belt cleaning section 70 collects toner that has moved from the image bearing member 100 to the transfer belt 66. The belt cleaning section 70 includes a belt cleaning roller 72, a toner collecting container 74, and a backup roller 76. The belt cleaning section 70 is disposed below the transfer belt 66. The belt cleaning roller 72 is in contact with the surface (e.g., the outer circumferential surface) of the transfer belt 66. The backup roller 76 is disposed so as to hold the transfer belt 66 between itself and the belt cleaning roller 72. The belt cleaning roller 72 polishes the surface (the outer circumferential surface that is a contact surface) of the transfer belt 66 to collect toner attached to the surface of the transfer belt 66 into the toner collecting container 74.

The voltage applicators 200Y, 200M, 200C, and 200K are connected to the cleaning members 482Y, 482M, 482C, and 482K, respectively. The voltage applicator 200 applies voltage to the cleaning member 482.

The moving mechanisms 300Y, 300M, 300C, and 300K cause the corresponding image bearing members 100Y, 100M, 100C, and 100K to come into contact with or separate from the corresponding development devices 46Y, 46M, 46C, and 46K.

(Printing Mode)

The following describes control by the controller 10 and the operation of the image forming apparatus 110 in the printing mode. When a print job including image data is input to the image forming apparatus 110 from an external device (e.g., an unillustrated personal computer), the controller 10 executes the printing mode. In the printing mode, an image is formed on a recording medium P.

Specifically, at a time t11 at which printing in the printing mode starts, the controller 10 controls the voltage applicator 200 to apply a negative first voltage to the cleaning member 482 as illustrated in FIG. 6. Also at the time t11, the controller 10 causes the image bearing member 100, the cleaning member 482, and the transfer belt 66 to start rotational driving. Toner (positively charged toner) remaining on the image bearing member 100 after transfer is electrostatically collected by the cleaning member 482 to which the negative first voltage (voltage of opposite polarity to the charged polarity of the toner) is applied.

In detail, the controller 10 causes positive voltage application by the charger 42 in the printing mode. The charger 42 accordingly charges the surface of the image bearing member 100 to the positive polarity. As such, the positively charged toner is collected by being electrostatically moved from the positively charged surface of the image bearing member 100 into the cleaning member 482 to which the first negative voltage is applied.

While the cleaning member 482 to which the negative first voltage is applied continues toner collection, the controller 10 causes charging by the charger 42, light exposure by the light exposure device 44, development by the development device 46, transfer by the transfer device 62, and electrostatic elimination by the static eliminator 50 on the rotationally driven image bearing member 100. After the unfixed toner image is transferred to the recording medium P having been conveyed to each location between the image bearing members 100 and the transfer devices 62, the controller 10 causes the fixing section 80 to fix the unfixed toner image to form an image which corresponds to a fixed toner image on the recording medium P.

At a time at which image formation according to all image data included in the print job is completed, that is, at a time t12 at which the printing mode ends, the controller 10 controls the voltage applicator 200 to stop application of the negative first voltage to the cleaning member 482. Also at the time t12, the controller 10 causes the image bearing member 100, the cleaning member 482, and the transfer belt 66 to stop rotational driving. As a result, the printing mode ends.

As previously described in the first embodiment, the photosensitive member 1 that is the image bearing member 100 is favorably charged to the positive polarity even when positive charging and negative charging alternately transition. Therefore, the photosensitive member 1 that is the image bearing member 100 is favorably charged to a desired positive potential in a charging process even when alternate transition occurs in the printing mode between charging of the surface of the image bearing member 100 to the positive polarity by the charger 42 and decrease in potential of the image bearing member 100 to the negative polarity due to the image bearing member 100 being in contact with the cleaning member 482 to which the negative first voltage is applied. As a result, the image forming apparatus 110, which includes the photosensitive member 1 as the image bearing member 100, can favorably form images even when positive charging and negative charging alternately transition.

(Cleaning Mode)

The following describes control by the controller 10 and the operation of the image forming apparatus 110 in the cleaning mode. Once the printing mode ends, the controller 10 executes the cleaning mode. In the cleaning mode, toner attached to the cleaning member 482 after the end of the printing mode is collected.

In detail, in a first specific time period T1 (time t12 to t13) in the cleaning mode, the controller 10 controls the moving mechanism 300 to move the development device 46 in a separating direction D1, thereby separating the development device 46 from the image bearing member 100. The separating direction D1 is a direction in which the development device 46 separates from the image bearing member 100.

At the time t13 in the cleaning mode after separation of the development device 46, the controller 10 controls the voltage applicator 200 to apply a positive second voltage (voltage of the same polarity as the charge polarity of the toner) to the cleaning member 482. Also at the time t13, the controller 10 causes the image bearing member 100, the cleaning member 482, and the transfer belt 66 to start rotational driving. This electrostatically moves toner (positively charged toner) attached to the cleaning member 482 to the image bearing member 100 from the cleaning member 482 to which the positive second voltage is applied. The toner moved to the image bearing member 100 moves to the transfer belt 66 with the rotation of the image bearing member 100. The toner moved to the transfer belt 66 is collected at the belt cleaning section 70 with the circulation of the transfer belt 66.

During a second specific time period T2 (time t13 to t14) in the cleaning mode, the positive second voltage is applied to the cleaning member 482. At the time t14 thereafter, the controller 10 controls the voltage applicator 200 to stop application of the positive second voltage to the cleaning member 482.

Note that the controller 10 may not allow voltage application by the charger 42 or may allow positive voltage application by the charger 42 in the second specific time period T2 (time t13 to t14) in the cleaning mode. In a case of positive voltage application to the charger 42, the positive voltage applied to the charger 42 is preferably lower than the positive second voltage applied to the cleaning member 482. This is to ensure that the positively charged toner is electrostatically moved from the cleaning member 482 to the charger 42 in a favorable manner.

During a third specific time period T3 (time t14 to t15) in the cleaning mode, the controller 10 maintains rotational driving of the image bearing member 100, the cleaning member 482, and the transfer belt 66. Furthermore, in the third specific time period T3, the controller 10 controls the moving mechanism 300 to move the development device 46 in an approaching direction D2. The approaching direction D2 is a direction in which the development device 46 approaches the image bearing member 100. Then at the time t15, the controller 10 causes the development device 46 to come into contact with the image bearing member 100. Also at the time t15, the controller 10 causes the image bearing member 100, the cleaning member 482, and the transfer belt 66 to stop rotational driving. Note that the time t15 can be a time when a time period has elapsed that is necessary for the toner that has moved from the cleaning member 482 to the image bearing member 100 directly before application of the positive second voltage stops to move from the image bearing member 100 to the transfer belt 66 and be collected at the belt cleaning section 70 from the transfer belt 66. As a result of stoppage of rotational driving of the image bearing member 100, the cleaning member 482, and the transfer belt 66, cleaning mode ends.

As described in the first embodiment, the photosensitive member 1 that is the image bearing member 100 can be favorably charged to the positive polarity even when positive charging and negative charging alternately transition. An image bearing member 100 such as above is not susceptible to surface potential fluctuations. Therefore, even when the photosensitive member is increased in potential to the positive polarity due to being in contact with the cleaning member 482 to which the positive second voltage is applied, the image bearing member 100 can be favorably charged to a desired positive potential in re-execution of the printing mode after the cleaning mode ends.

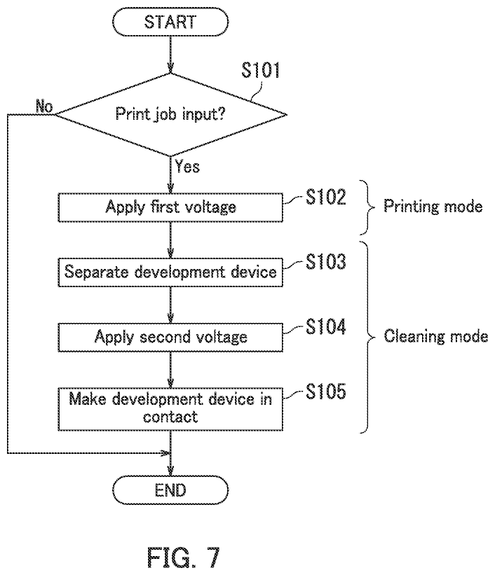

The control by the controller 10 and the operation of the image forming apparatus 110 in the printing mode and the cleaning mode have been described so far. The following describes control by the controller 10 in the printing mode and the cleaning mode further in detail with reference to FIG. 7. FIG. 7 is a flowchart depicting the control on the image forming apparatus 110 illustrated in FIG. 4.

The controller 10 repeatedly executes the processing depicted in the flowchart of FIG. 7. Specifically, the controller 10 determines whether or not a print job has been input (S101). When it is determined that no print jobs have been input (No in S101), the processing depicted in the flowchart of FIG. 7 ends. When it is determined that a print job has been input (Yes in S101), the printing mode is executed. In the printing mode, the controller 10 controls the voltage applicator 200 to apply the negative first voltage to the cleaning member 482 (S102). At this time, as described previously, positively charged toner remaining on the image bearing member 100 is collected by the cleaning member 482 to which the negative first voltage is applied.

After the printing mode ends, the cleaning mode is executed. In the cleaning mode, the controller 10 causes the development device 46 to separate from the image bearing member 100 (S103). Next, the controller 10 controls the voltage applicator 200 to apply the positive second voltage to the cleaning member 482 (S104). At this time, positively charged toner attached to the cleaning member 482 is moved to the image bearing member 100 as described previously. Next, the toner moved to the image bearing member 100 is collected at the belt cleaning section 70 via the transfer belt 66. Next, the controller 10 returns the development device 46 to the original position to cause the development device 46 to come into contact with the image bearing member 100 (S105). Then, the controller 10 terminates the processing depicted in the flowchart of FIG. 7.

### (Variation)

Note that the aforementioned image forming apparatus 110 may be altered as in the following variation. In a multi-color printing mode in which a multi-color image is printed, the previously described printing mode and cleaning mode are executed.

Different from the multi-color printing mode by contrast, monochrome printing in which a monochrome image is printed is executable as follows. In the monochrome printing mode (time period from time t11 to time t12 in FIG. 6), the controller 10 controls the voltage applicator 200K (voltage applicator for black color) to apply the negative first voltage to the cleaning member 482K (cleaning member for black color). In the monochrome printing mode (time period from time t11 to time t12 in FIG. 6), the controller 10 controls the voltage applicators 200Y, 200M, and 200C (voltage applicators for yellow color, magenta color, and cyan color) to respectively apply a positive third voltage to the cleaning members 482Y, 482M, and 482C (cleaning members for yellow color, magenta color, and cyan color). Tiny components (e.g., paper dust) of the negatively charged recording medium P may be attached to the image bearing members 100Y, 100M, and 100C (image bearing members for yellow color, magenta color, and cyan color) that are not used in the monochrome printing mode. In view of the foregoing, the third voltage (positive voltage) is applied to the cleaning members 482Y, 482M, and 482C to electrostatically collect the tiny components of the negatively charged recording medium P by the cleaning members 482Y, 482M, and 482C.

Furthermore, in the second specific time period T2 (time period from time t13 to time 14 in FIG. 6) in the cleaning mode after the monochrome printing mode, the controller 10 controls the voltage applicator 200K to apply the positive second voltage to the cleaning member 482K. Through the above, positively charged toner attached to the cleaning member 482K is moved to the image bearing member 100K (image bearing member for black color). In the second specific time period T2 (period from time t13 to time t14 in FIG. 6) in the cleaning mode after the monochrome printing mode, the controller 10 controls the voltage applicators 200Y, 200M, and 200C to respectively apply a negative fourth voltage to the cleaning members 482Y, 482M, and 482C. Through the above, negatively charged tiny components of the recording medium P attached to the cleaning members 482Y, 482M, and 482C are moved to the image bearing members 100Y, 100M, and 100C, respectively. Next, the toner moved to the image bearing member 100K and the tiny components of the recording medium P moved to the image bearing members 100Y, 100M, and 100C are collected at the belt cleaning section 70 via the transfer belt 66. A variation has been described so far.

Although an example of the image forming apparatus is described, the image forming apparatus is not limited to the aforementioned image forming apparatus 110 and can be further altered in the following aspects, for example. While the image forming apparatus 110 is a color image forming apparatus, the image forming apparatus may be a monochrome image forming apparatus. In this case, it is only required that the image forming apparatus include only one image forming unit, for example. Furthermore, the image forming apparatus 110 is a tandem image forming apparatus, but may be a rotary image forming apparatus, for example. A scorotron charger is used as an example of the charger 42, but the charger may be any charger other than a scorotron charger (e.g., a charging roller, a charging brush, or a corotron charger). Although the image forming apparatus 110 adopts a contact development process, the image forming apparatus may adopt a non-contact development process. Although the image forming apparatus 110 adopts a direct transfer process, the image forming apparatus may adopt an intermediate transfer process.

### Third Embodiment: Process Cartridge

With further reference to FIG. 4, a process cartridge according to a third embodiment of the present disclosure is described next. The process cartridge of the third embodiment corresponds to each of the image forming units 40Y, 40M, 40C, and 40K. The process cartridge includes the image bearing member 100.

The image bearing member 100 is the photosensitive member 1 of the first embodiment. As described previously, the photosensitive member 1 of the first embodiment has excellent abrasion resistance and can be favorably charged to the positive polarity even when positive charging and negative charging alternately transition. Therefore, as a result of the image forming apparatus 110 including the photosensitive member 1 such as above as the image bearing member 100, the process cartridge of the third embodiment can enable favorable image formation on a recording medium P.

The process cartridge may further include at least one selected from the group consisting of the charger 42, the light exposure device 44, the development device 46, the transfer device 62, the cleaning member 482, and the static eliminator 50 in addition to the image bearing member 100. The process cartridge may be designed to be freely attachable to and detachable from the image forming apparatus 110. As such, the process cartridge can be easily handled and the process cartridge including the image bearing member 100 attached thereto can be quickly replaced when the image bearing member 100 degrades in photosensitivity, for example. The process cartridge of the third embodiment has been described so far with reference to FIG. 4.

### EXAMPLES

The following further specifically describes the present disclosure using examples. However, the present disclosure is not limited to the scope of the examples.

The following charge generating material, electron transport materials, hole transport materials, binder resins, and n-type pigments were prepared first as the materials for forming photosensitive layers of photosensitive members.

(Charge Generating Material)

As the charge generating material, Y-form titanyl phthalocyanine described in the first embodiment was prepared.

(Electron Transport Material)

The electron transport materials (ETM1), (ETM2), (ETM6), (ETM7), (ETM8), (ETM19), (ETM22), (ETM23), (ETM24), (ETM28), and (ETM29) described in the first embodiment were each prepared as the electron transport material. Also, compounds represented by the following chemical formulas (ETM32-C) to (ETM37-C) (also referred to below as electron transport materials (ETM32-C) to (ETM37-C), respectively) were prepared as electron transport materials used for comparative examples.

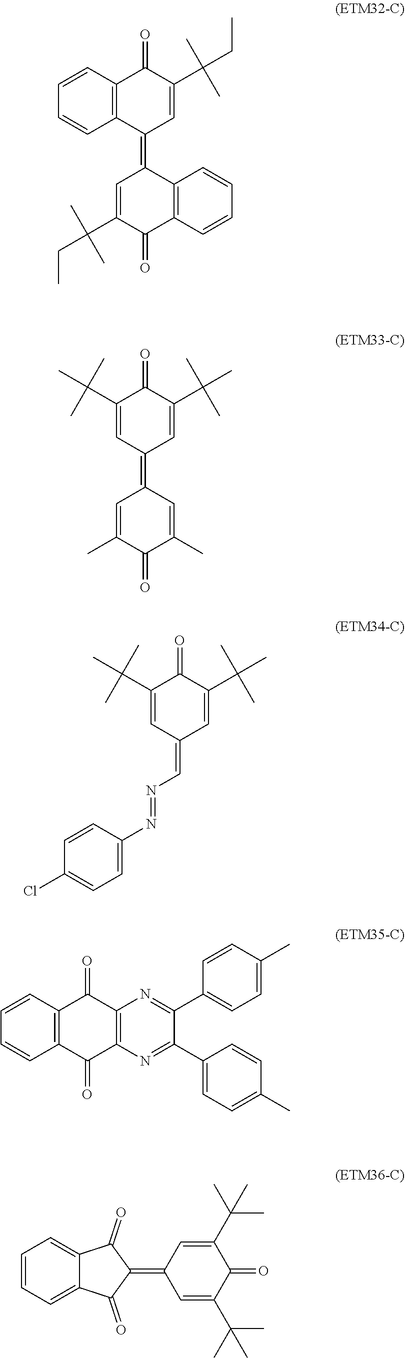 [SMILES: CCC(C)(C)C1=C/C(=C2/C=C(C(C)(C)CC)C(=O)c3ccccc32)c2ccccc2C1=O ; CC1=CC(=C2C=C(C(C)(C)C)C(=O)C(C(C)(C)C)=C2)C=C(C)C1=O ; CC(C)(C)C1=CC(=C/N=N/c2ccc(Cl)cc2)C=C(C(C)(C)C)C1=O ; Cc1ccc(-c2nc3c(nc2-c2ccc(C)cc2)C(=O)c2ccccc2C3=O)cc1 ; CC(C)(C)C1=CC(=C2C(=O)c3ccccc3C2=O)C=C(C(C)(C)C)C1=O]

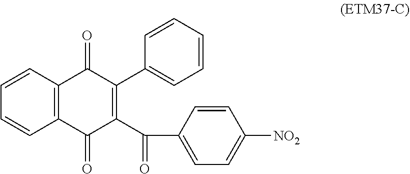 [SMILES: O=C(C1=C(c2ccccc2)C(=O)c2ccccc2C1=O)c1ccc([N+](=O)[O-])cc1]

(Hole Transport Material)

The hole transport materials (HTM1) to (HTM10) described in the first embodiment were each prepared as the hole transport material.

(Binder Resin)

The polycarbonate resins (R1) to (R13) described in the first embodiment were each prepared as the binder resin. In addition, polycarbonate resins represented by chemical formulas (R14-C) and (R15-C) (also referred to below as polycarbonate resins (R14-C) and (R15-C), respectively) were prepared as binder resins used for comparative examples. The polycarbonate resins (R1) to (R13), (R14-C), and (R15-C) each had a viscosity average molecular weight of 35,000.

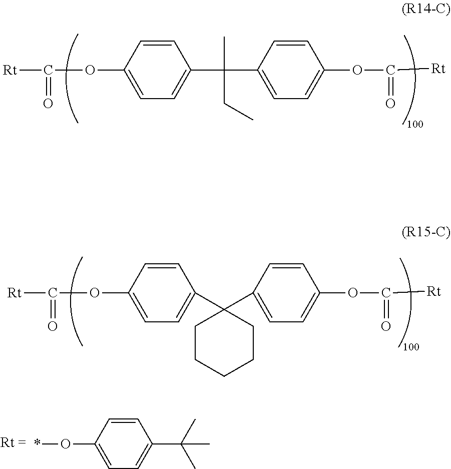

(n-type Pigment)

The azo pigments (A1) to (A5), the perylene pigments (P1) to (P4), and the isoindoline pigments (I1) and (I2) described in the first embodiment were each prepared as the n-type pigment.

(Additive)

The additives (AD1) to (AD6) described in the first embodiment were each prepared as the additive. The melting points (unit: ° C.) of the respective additives are shown in Tables 22 to 25.

<Photosensitive Member Production>

Using the charge generating material, the electron transport materials, the hole transport materials, and the binder resins described above, photosensitive members (A-1) to (A-33) and (B-1) to (B-8) were produced. Also, using the charge generating material, the electron transport materials, the hole transport materials, the binder resins, and the n-type pigments described above, photosensitive members (C-1) to (C-43) and (D-2) to (D-9) were produced. Using the charge generating material, the electron transport materials, the hole transport materials, the binder resins, and the additives described above, photosensitive members (E-1) to (E-39) and (F-3) to (F-10) were produced.

(Production of Photosensitive Member (A-1))

An application liquid for photosensitive layer formation was obtained by mixing 3 parts by mass of Y-form titanyl phthalocyanine being the charge generating material, 70 parts by mass of the hole transport material (HTM1), 100 parts by mass of the polycarbonate resin (R1) being the binder resin, 35 parts by mass of the electron transport material (ETM1), and 800 parts by mass of tetrahydrofuran being a solvent for 50 hours using a boll mill. The application liquid for photosensitive layer formation was applied onto a conductive substrate (drum-shaped aluminum support) by dip coating. After the application, the application liquid for photosensitive layer formation was hot-air-dried at 120° C. for 60 minutes. Through the above, a photosensitive layer (film thickness 30 μm) was formed on the conductive substrate to obtain the photosensitive member (A-1). In the photosensitive member (A-1), a single-layer photosensitive layer was formed directly on the conductive substrate.

(Production of Photosensitive Members (A-2) to (A-33) and (B-1) to (B-8))

The photosensitive members (A-2) to (A-33) and (B-1) to (B-8) were produced according to the same method as that for producing the photosensitive member (A-1) in all aspects other than use of the hole transport materials, the electron transport materials, and the binder resins shown in Tables 12 to 15.

(Production of Photosensitive Member (C-1))

An application liquid for photosensitive layer formation was obtained by mixing 3 parts by mass of Y-form titanyl phthalocyanine being the charge generating material, 70 parts by mass of the hole transport material (HTM1), 100 parts by mass of the polycarbonate resin (R1) being the binder resin, 35 parts by mass of the electron transport material (ETM1), 3 parts by mass of the azo pigment (A1) being the n-type pigment, and 800 parts by mass of tetrahydrofuran being a solvent for 50 hours using a boll mill. The application liquid for photosensitive layer formation was applied onto a conductive substrate (drum-shaped aluminum support) by dip coating. After the application, the application liquid for photosensitive layer formation was hot-air-dried at 120° C. for 60 minutes. Through the above, a photosensitive layer (film thickness 30 μm) was formed on the conductive substrate to obtain the photosensitive member (C-1). In the photosensitive member (C-1), a single-layer photosensitive layer was formed directly on the conductive substrate.

(Production of Photosensitive Members (C-2) to (C-43) and (D-2) to (D-9))

The photosensitive members (C-2) to (C-43) and (D-2) to (D-9) were produced according to the same method as that for producing the photosensitive member (C-1) in all aspects other than use of the n-type pigments, the hole transport materials, the electron transport materials, and the binder resins shown in Tables 16 to 18.

(Production of Photosensitive Member (E-1))

An application liquid for photosensitive layer formation was obtained by mixing 3 parts by mass of Y-form titanyl phthalocyanine being the charge generation material, 70 parts by mass of the hole transport material (HTM1), 100 parts by mass of the polycarbonate resin (R1) being the binder resin, 35 parts by mass of the electron transport material (ETM1), 18 parts by mass of the additive (AD1), and 800 parts by mass of tetrahydrofuran being a solvent for 50 hours using a ball mill. The application liquid for photosensitive layer formation was applied onto a conductive substrate (drum-shaped aluminum support) by dip coating. After the application, the application liquid for photosensitive layer formation was hot-air-dried at 120° C. for 60 minutes. Through the above, a photosensitive layer (film thickness 30 μm) was formed on the conductive substrate to obtain the photosensitive member (E-1). In the photosensitive member (E-1), a single-layer photosensitive layer was formed directly on the conductive substrate.

(Production of Photosensitive Members (E-2) to (E-39) and (F-3) to (F-10))

The photosensitive members (E-2) to (E-39) and (F-3) to (F-10) were produced according to the same method as that for producing the photosensitive member (E-1) in all aspects other than use of the additives, the hole transport materials, the electron transport materials, and the binder resins shown Tables 22 to 25.

<Photosensitivity Evaluation>

With respect to each of the photosensitive members (A-1) to (A-33), (B-1) to (B-8), (C-1) to (C-43), and (D-2) to (D-9), photosensitivity was evaluated. Specifically, the surface of the photosensitive member was charged to +750 V using a drum sensitivity test device (product of Gen-Tech, Inc.) in an environment at a temperature of 10° C. and a relative humidity of 15%. Next, monochromatic light (wavelength: 780 nm, exposure amount: 0.4 μj/cm²) was taken out from light of a halogen lamp using a bandpass filter and the surface of the photosensitive member was irradiated with the taken monochromatic light. The surface potential of the photosensitive member at a time when 70 milliseconds have elapsed from termination of irradiation with the monochromatic light was measured. The measured surface potential was taken to be a post-exposure potential (unit: +V) of the photosensitive member. The measured post-exposure potentials are shown in Tables 12 to 15 and 19 to 21.

<Evaluation of Positive Chargeability when Positive Charging and Negative Charging Alternately Transition>

With respect to each of the photosensitive members (A-1) to (A-33), (B-1) to (B-8), (C-1) to (C-43), (D-2) to (D-9), (E-1) to (E-39), and (F-3) to (F-10), positive chargeability when positive charging and negative charging alternately transition was evaluated. Specifically, positive chargeability of the photosensitive member when positive charging and negative charging alternately transition was evaluated in an environment at a temperature of 25° C. and a relative humidity of 50%. A drum sensitivity test device (product of Gen-Tech, Inc.) was used in this evaluation. The photosensitive member was set in the drum sensitivity test device. The drum sensitivity test device was provided with a first charger, a probe, a second charger, and a static eliminator arranged in the stated order from upstream in the rotational direction of the photosensitive member. The first charger charges the surface of the photosensitive member to the positive polarity. The first charger was a scorotron charger set to have a grid voltage of +700 V. The probe was disposed at a development point to measure the surface potential of the photosensitive member. The second charger was disposed at a cleaning point to charge the surface of the photosensitive member to the negative polarity. The second charger was a corotron charger set to have an application voltage of −5 kV. The static eliminator performs electrostatic elimination on the surface of the photosensitive member.

The photosensitive member was rotated for 10 rotations at a rotational speed of 200 mm/sec in a state in which the first charger for positive charging was turned on, the static eliminator was turned on, and the second charger for negative charging was turned off. In this manner, the positive charging and electrostatic elimination of the photosensitive member were repeated. During the 10 rotations, the surface potential of the photosensitive member was continuously measured using the probe. An average value of the surface potentials of the photosensitive member measured during the 10 rotations was taken to be a charge potential V1 (unit: +V) of the photosensitive member before positive charging and negative charging alternately transitioned.

Next, the photosensitive member was rotated for 200 rotations at a rotational speed of 200 mm/sec in a state in which all of the first charger for positive charging, the static eliminator, and the second charger for negative charging were turned on. In this manner, positive charging, electrostatic elimination, and negative charging of the photosensitive member were repeated. The surface potential of the photosensitive member was continuously measured for 10 rotations from the 191th rotation to the 200th rotation using the probe. An average value of the surface potential of the photosensitive member measured during the 10 rotations was taken to be a charge potential V2 (unit: +V) of the photosensitive member after positive charging and negative charging alternately transitioned.

Then, a charge potential drop (unit: V) of the photosensitive member after positive charging and negative charging alternately transitioned was calculated using an equation “charge potential drop=V1−V2”. According to the calculated charge potential drop, whether or not the photosensitive member was favorably charged to the positive polarity when positive charging and negative charging alternately transitioned was evaluated based on the following criteria. The measured charge potential drops and results of evaluation of positive chargeability when positive charging and negative charging alternately transition are shown in Tables 12 to 15 and 19 to 25.

(Criteria for Positive Chargeability Evaluation when Positive Charging and Negative Charging Alternately Transition)

Evaluation A: charge potential drop of lower than 90 V

Evaluation B: charge potential drop of at least 90 V and no higher than 120 V

Evaluation C: charge potential drop of 12 V or higher

<Abrasion Resistance Evaluation>

With respect to each of the photosensitive members (A-1) to (A-33), (B-1) to (B-8), (C-1) to (C-43), (D-2) to (D-9), (E-1) to (E-39), and (F-3) to (F-10), abrasion resistance was evaluated. Specifically, the application liquid for photosensitive layer formation prepared in <Photosensitive Member Production> described above was applied onto a polypropylene sheet wound around an aluminum pipe. After the application, the applied application liquid for photosensitive layer formation was dried at 120° C. for 60 minutes to produce a polypropylene sheet with a photosensitive layer (film thickness 30 μm) formed thereon. Subsequently, the photosensitive layer was peeled off from the polypropylene sheet. The peeled photosensitive layer was attached to a card-shaped member (“S-36”, product of TABER Industries). The mass MA of the card-shaped member with the photosensitive layer attached thereto was measured. Next, the card-shaped member was mounted on a rotary table of a rotary ablation tester (product of Toyo Seiki Seisaku-sho, Ltd.). Then, the rotary table was rotated for 1000 rotations at a rotational speed of 60 rpm with a 500-gf load wear ring (“CS-10”, product of TABER Industries) placed on the photosensitive layer on the card-shaped member. Through the above, the photosensitive layer on the rotary table was abraded. After the abrasion, the mass MB of the card-shaped member with the photosensitive layer attached thereto was re-measured. Thereafter, an abrasion loss (=MA−MB, unit: mg) was calculated which is a mass change of the photosensitive layer between before and after the abrasion. From the abrasion loss, abrasion resistance of the photosensitive member was evaluated based on the following criteria. The measured abrasion losses and results of abrasion resistance evaluation are shown in Tables 12 to 15 and 19 to 25.

<Criteria for Abrasion Resistance Evaluation>

Evaluation A: abrasion loss of less than 5.0 mg

Evaluation B: abrasion loss of at least 5.0 mg and less than 8.0 mg

Evaluation C: abrasion loss of greater than 8.0 mg

<High-temperature Storability Evaluation>

High-temperature storability was evaluated for each of the photosensitive members (E-1) to (E-39) and (F-3) to (F-10). A cleaning roller with 0.1 g of horse oil applied thereto was pressed against the photosensitive member in an environment at a temperature of 50° C. and a relative humidity of 80%, and stored for 3 days. After the storage, the horse oil on the surface of the photosensitive member was wiped off using ethanol, and the surface of the photosensitive member was visually observed. Through the observation, the presence or absence of cracks or recesses in the surface of the photosensitive member was checked. According to the presence or absence of cracks or recesses, high-temperature storability of the photosensitive member was evaluated based on the following criteria. Results of high-temperature storability evaluation are shown in Tables 22 to 25.

(Criteria for High-temperature Storability Evaluation)

Evaluation A: neither cracks nor recesses were observed.

Evaluation B: at least one of a crack and a recess was somewhat observed but there involved no problems in actual use.

Evaluation C: at least one of a crack and a recess is clearly observed.

Note that the terms in Tables 12 to 25 are defined as follows. “HTM” refers to hole transport material. “ETM” refers to electron transport material. “Resin” refers to binder resin. “Value” under the column titled “Sensitivity” refers to post-exposure potential (unit: +V). “Value” under the column titled “V1−V2” refers to a charge potential drop (unit: V) of the photosensitive member when positive charging and negative charging alternately transitioned. “Evaluation” under the column titled “V1−V2” refers to result of evaluation of positive chargeability when positive charging and negative charging alternately transition. “Value” under the column titled “Abrasion resistance” refers to abrasion loss (unit: mg). “Evaluation” under the column titled “Abrasion resistance” refers to result of abrasion resistance evaluation. “Evaluation” under the column titled “High-temperature storability” refers to result of high-temperature storability evaluation.

TABLE 12

| | | | | | | | | Abrasion | |
|---|---|---|---|---|---|---|---|---|---|
| | Photo- | | | | sensitivity | V1-V2 | | resistance | |
| | sensitive | | | | Value | Value | | Value | |
| | member | HTM | ETM | Resin | [+V] | [V] | Evaluation | [mg] | Evaluation |
| Example 1 | A-1 | HTM1 | ETM1 | R1 | 142 | 77 | A | 4.3 | A |
| Example 2 | A-2 | HTM1 | ETM2 | R1 | 147 | 94 | B | 4.4 | A |
| Example 3 | A-3 | HTM1 | ETM6 | R1 | 153 | 63 | A | 4.3 | A |
| Example 4 | A-4 | HTM1 | ETM7 | R1 | 161 | 89 | A | 4.3 | A |
| Example 5 | A-5 | HTM1 | ETM8 | R1 | 162 | 103 | B | 4.2 | A |
| Example 6 | A-6 | HTM1 | ETM19 | R1 | 160 | 100 | B | 4.4 | A |
| Example 7 | A-7 | HTM1 | ETM22 | R1 | 140 | 81 | A | 4.3 | A |
| Example 8 | A-8 | HTM1 | ETM23 | R1 | 135 | 90 | B | 4.3 | A |
| Example 9 | A-9 | HTM1 | ETM24 | R1 | 135 | 83 | A | 4.5 | A |
| Example 10 | A-10 | HTM1 | ETM28 | R1 | 137 | 80 | A | 4.2 | A |
| Example 11 | A-11 | HTM1 | ETM29 | R1 | 129 | 86 | A | 4.3 | A |

TABLE 13

| | Photo- | | | | Sensitivity | V1−V2 | | Abrasion resistance | |
|---|---|---|---|---|---|---|---|---|---|
| | sensitive | | | | Value | Value | | Value | |
| | member | HTM | ETM | Resin | [+V] | [V] | Evaluation | [mg] | Evaluation |
| Example 12 | A-12 | HTM2 | ETM1 | R1 | 162 | 80 | A | 5.8 | B |
| Example 13 | A-13 | HTM3 | ETM1 | R1 | 172 | 92 | B | 5.2 | B |
| Example 14 | A-14 | HTM4 | ETM1 | R1 | 141 | 84 | A | 4.6 | A |
| Example 15 | A-15 | HTM5 | ETM1 | R1 | 142 | 81 | A | 4.1 | A |
| Example 16 | A-16 | HTM6 | ETM1 | R1 | 148 | 80 | A | 4.2 | A |
| Example 17 | A-17 | HTM7 | ETM1 | R1 | 136 | 86 | A | 3.9 | A |
| Example 18 | A-18 | HTM8 | ETM1 | R1 | 139 | 80 | A | 3.9 | A |
| Example 19 | A-19 | HTM9 | ETM1 | R1 | 143 | 83 | A | 5.6 | B |
| Example 20 | A-20 | HTM10 | ETM1 | R1 | 152 | 86 | A | 4.7 | A |

TABLE 14

| | Photo- | | | | Sensitivity | V1−V2 | | Abrasion resistance | |
|---|---|---|---|---|---|---|---|---|---|
| | sensitive | | | | Value | Value | | Value | |
| | member | HTM | ETM | Resin | [+V] | [V] | Evaluation | [mg] | Evaluation |
| Example 21 | A-21 | HTM1 | ETM1 | R2 | 153 | 79 | A | 3.5 | A |
| Example 22 | A-22 | HTM1 | ETM1 | R3 | 145 | 78 | A | 5.9 | B |
| Example 23 | A-23 | HTM1 | ETM1 | R4 | 148 | 75 | A | 4.5 | A |
| Example 24 | A-24 | HTM1 | ETM1 | R5 | 155 | 83 | A | 5.2 | B |
| Example 25 | A-25 | HTM1 | ETM1 | R6 | 159 | 80 | A | 4.7 | A |
| Example 26 | A-26 | HTM1 | ETM1 | R7 | 158 | 94 | B | 6.4 | B |
| Example 27 | A-27 | HTM1 | ETM1 | R8 | 153 | 73 | A | 3.2 | A |
| Example 28 | A-28 | HTM1 | ETM1 | R9 | 147 | 78 | A | 3.5 | A |
| Example 29 | A-29 | HTM7 | ETM1 | R9 | 147 | 79 | A | 2.8 | A |
| Example 30 | A-30 | HTM1 | ETM1 | R10 | 160 | 95 | B | 4.5 | A |
| Example 31 | A-31 | HTM1 | ETM1 | R11 | 147 | 78 | A | 3.5 | A |
| Example 32 | A-32 | HTM1 | ETM1 | R12 | 148 | 78 | A | 7.6 | B |
| Example 33 | A-33 | HTM1 | ETM1 | R13 | 149 | 80 | A | 7.3 | B |

TABLE 15

| | Photo- | | | | Sensitivity | V1−V2 | | Abrasion resistance | |
|---|---|---|---|---|---|---|---|---|---|
| | sensitive | | | | Value | Value | | Value | |
| | member | HTM | ETM | Resin | [+V] | [V] | Evaluation | [mg] | Evaluation |
| Comparative | B-1 | HTM1 | ETM32-C | R1 | 143 | 138 | C | 4.4 | A |
| Example 1 | | | | | | | | | |
| Comparative | B-2 | HTM1 | ETM33-C | R1 | 148 | 132 | C | 4.6 | A |
| Example 2 | | | | | | | | | |
| Comparative | B-3 | HTM1 | ETM34-C | R1 | 165 | 127 | C | 4.3 | A |
| Example 3 | | | | | | | | | |
| Comparative | B-4 | HTM1 | ETM35-C | R1 | 148 | 129 | C | 4.3 | A |
| Example 4 | | | | | | | | | |
| Comparative | B-5 | HTM1 | ETM36-C | R1 | 148 | 127 | C | 4.1 | A |
| Example 5 | | | | | | | | | |
| Comparative | B-6 | HTM1 | ETM37-C | R1 | 171 | 130 | C | 4.4 | A |
| Example 6 | | | | | | | | | |
| Comparative | B-7 | HTM1 | ETM1 | R14-C | 156 | 89 | A | 11.4 | C |
| Example 7 | | | | | | | | | |
| Comparative | B-8 | HTM1 | ETM1 | R15-C | 142 | 79 | A | 10.0 | C |
| Example 8 | | | | | | | | | |

TABLE 16

| | Photosensitive | n-type | | | |
|---|---|---|---|---|---|
| | member | pigment | HTM | ETM | Resin |
| Example 34 | C-1 | A1 | HTM1 | ETM1 | R1 |
| Example 35 | C-2 | A1 | HTM1 | ETM2 | R1 |
| Example 36 | C-3 | A1 | HTM1 | ETM6 | R1 |
| Example 37 | C-4 | A1 | HTM1 | ETM7 | R1 |
| Example 38 | C-5 | A1 | HTM1 | ETM8 | R1 |
| Example 39 | C-6 | A1 | HTM1 | ETM19 | R1 |
| Example 40 | C-7 | A1 | HTM1 | ETM22 | R1 |
| Example 41 | C-8 | A1 | HTM1 | ETM23 | R1 |
| Example 42 | C-9 | A1 | HTM1 | ETM24 | R1 |
| Example 43 | C-10 | A1 | HTM1 | ETM28 | R1 |
| Example 44 | C-11 | A1 | HTM1 | ETM29 | R1 |
| Example 45 | C-12 | A1 | HTM2 | ETM1 | R1 |
| Example 46 | C-13 | A1 | HTM3 | ETM1 | R1 |
| Example 47 | C-14 | A1 | HTM4 | ETM1 | R1 |
| Example 48 | C-15 | A1 | HTM5 | ETM1 | R1 |
| Example 49 | C-16 | A1 | HTM6 | ETM1 | R1 |
| Example 50 | C-17 | A1 | HTM7 | ETM1 | R1 |
| Example 51 | C-18 | A1 | HTM8 | ETM1 | R1 |
| Example 52 | C-19 | A1 | HTM9 | ETM1 | R1 |
| Example 53 | C-20 | A1 | HTM10 | ETM1 | R1 |

TABLE 17

| | Photosensitive | n-type | | | |
|---|---|---|---|---|---|
| | member | pigment | HTM | ETM | Resin |
| Example 54 | C-21 | A2 | HTM1 | ETM1 | R1 |
| Example 55 | C-22 | A3 | HTM1 | ETM1 | R1 |
| Example 56 | C-23 | A4 | HTM1 | ETM1 | R1 |
| Example 57 | C-24 | AS | HTM1 | ETM1 | R1 |
| Example 58 | C-25 | P1 | HTM1 | ETM1 | R1 |
| Example 59 | C-26 | P2 | HTM1 | ETM1 | R1 |
| Example 60 | C-27 | P3 | HTM1 | ETM1 | R1 |
| Example 61 | C-28 | P4 | HTM1 | ETM1 | R1 |
| Example 62 | C-29 | I1 | HTM1 | ETM1 | R1 |
| Example 63 | C-30 | I2 | HTM1 | ETM1 | R1 |
| Example 64 | C-31 | A1 | HTM1 | ETM1 | R2 |
| Example 65 | C-32 | A1 | HTM1 | ETM1 | R3 |
| Example 66 | C-33 | A1 | HTM1 | ETM1 | R4 |
| Example 67 | C-34 | A1 | HTM1 | ETM1 | R5 |
| Example 68 | C-35 | A1 | HTM1 | ETM1 | R6 |
| Example 69 | C-36 | A1 | HTM1 | ETM1 | R7 |
| Example 70 | C-37 | A1 | HTM1 | ETM1 | R8 |
| Example 71 | C-38 | A1 | HTM1 | ETM1 | R9 |
| Example 72 | C-39 | A1 | HTM7 | ETM1 | R9 |
| Example 73 | C-40 | A1 | HTM1 | ETM1 | R10 |
| Example 74 | C-41 | A1 | HTM1 | ETM1 | R11 |
| Example 75 | C-42 | A1 | HTM1 | ETM1 | R12 |
| Example 76 | C-43 | A1 | HTM1 | ETM1 | R13 |

TABLE 18

| | Photo- | | | | |
|---|---|---|---|---|---|
| | sensitive | n-type | | | |
| | member | pigment | HTM | ETM | Resin |
| Comparative | D-2 | A1 | HTM1 | ETM32-C | R1 |
| Example 9 | | | | | |
| Comparative | D-3 | A1 | HTM1 | ETM33-C | R1 |
| Example 10 | | | | | |
| Comparative | D-4 | A1 | HTM1 | ETM34-C | R1 |
| Example 11 | | | | | |
| Comparative | D-5 | A1 | HTM1 | ETM35-C | R1 |
| Example 12 | | | | | |
| Comparative | D-6 | A1 | HTM1 | ETM36-C | R1 |
| Example 13 | | | | | |
| Comparative | D-7 | A1 | HTM1 | ETM37-C | R1 |
| Example 14 | | | | | |
| Comparative | D-8 | A1 | HTM1 | ETM1 | R14-C |
| Example 15 | | | | | |
| Comparative | D-9 | A1 | HTM1 | ETM1 | R15-C |
| Example 16 | | | | | |

TABLE 19

| | Photo- | Sensitivity | V1−V2 | | Abrasion resistance | |
|---|---|---|---|---|---|---|
| | sensitive | Value | Value | | Value | |
| | Member | [+V] | [V] | Evaluation | [mg] | Evaluation |
| Example 34 | C-1 | 112 | 76 | A | 4.2 | A |
| Example 35 | C-2 | 119 | 88 | A | 4.2 | A |
| Example 36 | C-3 | 125 | 61 | A | 4.4 | A |
| Example 37 | C-4 | 128 | 87 | A | 4.1 | A |
| Example 38 | C-5 | 132 | 98 | B | 4.5 | A |
| Example 39 | C-6 | 132 | 96 | B | 4.1 | A |
| Example 40 | C-7 | 110 | 82 | A | 4.3 | A |
| Example 41 | C-8 | 107 | 88 | A | 4.5 | A |
| Example 42 | C-9 | 108 | 79 | A | 4.2 | A |
| Example 43 | C-10 | 111 | 81 | A | 4.2 | A |
| Example 44 | C-11 | 104 | 84 | A | 4.2 | A |
| Example 45 | C-12 | 134 | 80 | A | 5.5 | B |
| Example 46 | C-13 | 145 | 93 | B | 5.2 | B |
| Example 47 | C-14 | 117 | 80 | A | 4.6 | A |
| Example 48 | C-15 | 116 | 79 | A | 4.1 | A |
| Example 49 | C-16 | 118 | 80 | A | 4.2 | A |
| Example 50 | C-17 | 111 | 88 | A | 3.9 | A |
| Example 51 | C-18 | 109 | 79 | A | 3.8 | A |
| Example 52 | C-19 | 115 | 80 | A | 5.6 | B |
| Example 53 | C-20 | 125 | 77 | A | 4.8 | A |

TABLE 20

| | | | | | Abrasion | |
|---|---|---|---|---|---|---|
| | Photo- | Sensitivity | V1-V2 | | resistance | |
| | sensitive | Value | Value | | Value | |
| | member | [+V] | [V] | Evaluation | [mg] | Evaluation |
| Example 54 | C-21 | 115 | 77 | A | 4.3 | A |
| Example 55 | C-22 | 113 | 81 | A | 4.3 | A |
| Example 56 | C-23 | 124 | 88 | A | 4.2 | A |
| Example 57 | C-24 | 111 | 79 | A | 4.2 | A |
| Example 58 | C-25 | 122 | 88 | A | 4.1 | A |
| Example 59 | C-26 | 122 | 87 | A | 4.2 | A |
| Example 60 | C-27 | 118 | 97 | B | 4.4 | A |
| Example 61 | C-28 | 131 | 90 | B | 4.3 | A |
| Example 62 | C-29 | 118 | 89 | A | 4.2 | A |
| Example 63 | C-30 | 125 | 88 | A | 4.3 | A |
| Example 64 | C-31 | 124 | 77 | A | 3.6 | A |
| Example 65 | C-32 | 117 | 79 | A | 5.7 | B |
| Example 66 | C-33 | 117 | 77 | A | 4.3 | A |
| Example 67 | C-34 | 127 | 79 | A | 5.2 | B |
| Example 68 | C-35 | 130 | 77 | A | 4.7 | A |
| Example 69 | C-36 | 128 | 79 | A | 6.5 | B |
| Example 70 | C-37 | 121 | 77 | A | 3.2 | A |
| Example 71 | C-38 | 113 | 79 | A | 3.4 | A |
| Example 72 | C-39 | 112 | 88 | A | 2.8 | A |
| Example 73 | C-40 | 135 | 77 | A | 4.5 | A |
| Example 74 | C-41 | 118 | 74 | A | 3.5 | A |
| Example 75 | C-42 | 119 | 79 | A | 7.6 | B |
| Example 76 | C-43 | 119 | 77 | A | 7.3 | B |

TABLE 21

| | | | | | Abrasion | |
|---|---|---|---|---|---|---|
| | Photo- | Sensitivity | V1-V2 | | resistance | |
| | sensitive | Value | Value | | Value | |
| | member | [+V] | [V] | Evaluation | [mg] | Evaluation |
| Comparative | D-2 | 114 | 138 | C | 4.0 | A |
| Example 9 | | | | | | |
| Comparative | D-3 | 119 | 129 | C | 4.6 | A |
| Example 10 | | | | | | |
| Comparative | D-4 | 122 | 125 | C | 4.4 | A |
| Example 11 | | | | | | |
| Comparative | D-5 | 137 | 138 | C | 4.8 | A |
| Example 12 | | | | | | |
| Comparative | D-6 | 140 | 138 | C | 4.7 | A |
| Example 13 | | | | | | |
| Comparative | D-7 | 145 | 142 | C | 4.4 | A |
| Example 14 | | | | | | |
| Comparative | D-8 | 121 | 81 | A | 11.2 | C |
| Example 15 | | | | | | |
| Comparative | D-9 | 113 | 75 | A | 9.5 | C |
| Example 16 | | | | | | |

TABLE 22

| | | Additive | | | | | | | High- | Abrasion | |
|---|---|---|---|---|---|---|---|---|---|---|---|
| | Photo- | | Melting | | | | V1-V2 | | temperature | resistance | |
| | sensitive | | point | | | | Value | | storability | Value | |
| | member | Type | [° C.] | HTM | ETM | Resin | [V] | Evaluation | Evaluation | [mg] | Evaluation |
| Example 77 | E-1 | AD1 | 117 | HTM1 | ETM1 | R1 | 80 | A | A | 4.7 | A |
| Example 78 | E-2 | AD1 | 117 | HTM1 | ETM2 | R1 | 94 | B | A | 4.9 | A |
| Example 79 | E-3 | AD1 | 117 | HTM1 | ETM6 | R1 | 67 | A | A | 4.9 | A |
| Example 80 | E-4 | AD1 | 117 | HTM1 | ETM7 | R1 | 91 | B | A | 4.8 | A |
| Example 81 | E-5 | AD1 | 117 | HTM1 | ETM8 | R1 | 100 | B | A | 4.8 | A |
| Example 82 | E-6 | AD1 | 117 | HTM1 | ETM19 | R1 | 90 | B | A | 4.7 | A |
| Example 83 | E-7 | AD1 | 117 | HTM1 | ETM22 | R1 | 82 | A | A | 4.6 | A |
| Example 84 | E-8 | AD1 | 117 | HTM1 | ETM23 | R1 | 90 | B | A | 4.5 | A |
| Example 85 | E-9 | AD1 | 117 | HTM1 | ETM24 | R1 | 84 | A | A | 4.8 | A |
| Example 86 | E-10 | AD1 | 117 | HTM1 | ETM28 | R1 | 85 | A | A | 4.7 | A |
| Example 87 | E-11 | AD1 | 117 | HTM1 | ETM29 | R1 | 89 | A | A | 4.8 | A |

TABLE 23

| | | | | | | | | | High- | | |
|---|---|---|---|---|---|---|---|---|---|---|---|
| | Photo- | Additive | | | | | V1−V2 | | temperature | Abrasion resistance | |
| | sensitive | | Melting | | | | Value | | storability | Value | |
| | member | Type | point [° C.] | HTM | ETM | Resin | [V] | Evaluation | Evaluation | [mg] | Evaluation |
| Example 88 | E-12 | AD1 | 117 | HTM2 | ETM1 | R1 | 85 | A | A | 4.9 | A |
| Example 89 | E-13 | AD1 | 117 | HTM3 | ETM1 | R1 | 97 | B | A | 5.7 | B |
| Example 90 | E-14 | AD1 | 117 | HTM4 | ETM1 | R1 | 85 | A | A | 5.1 | B |
| Example 91 | E-15 | AD1 | 117 | HTM5 | ETM1 | R1 | 83 | A | A | 4.5 | A |
| Example 92 | E-16 | AD1 | 117 | HTM6 | ETM1 | R1 | 85 | A | A | 4.5 | A |
| Example 93 | E-17 | AD1 | 117 | HTM7 | ETM1 | R1 | 80 | A | A | 4.3 | A |
| Example 94 | E-18 | AD1 | 117 | HTM8 | ETM1 | R1 | 81 | A | A | 4.2 | A |
| Example 95 | E-19 | AD1 | 117 | HTM9 | ETM1 | R1 | 85 | A | B | 6.1 | B |
| Example 96 | E-20 | AD1 | 117 | HTM10 | ETM1 | R1 | 81 | A | A | 5.2 | B |
| Example 97 | E-21 | AD2 | 139 | HTM1 | ETM1 | R1 | 81 | A | A | 4.7 | A |
| Example 98 | E-22 | AD3 | 129 | HTM1 | ETM1 | R1 | 89 | A | A | 4.8 | A |
| Example 99 | E-23 | AD4 | 122 | HTM1 | ETM1 | R1 | 94 | B | A | 4.5 | A |
| Example 100 | E-24 | AD5 | 173 | HTM1 | ETM1 | R1 | 83 | A | A | 4.1 | A |
| Example 101 | E-25 | AD6 | 127 | HTM1 | ETM1 | R1 | 79 | A | A | 4.8 | A |

TABLE 24

| | | Additive | | | | | | | High- | Abrasion | |
|---|---|---|---|---|---|---|---|---|---|---|---|
| | Photo- | | Melting | | | | V1-V2 | | temperature | resistance | |
| | sensitive | | point | | | | Value | | storability | Value | |
| | member | Type | [° C.] | HTM | ETM | Resin | [V] | Evaluation | Evaluation | [mg] | Evaluation |
| Example 102 | E-26 | AD1 | 117 | HTM1 | ETM1 | R2 | 82 | A | A | 4.0 | A |
| Example 103 | E-27 | AD1 | 117 | HTM1 | ETM1 | R3 | 83 | A | A | 6.2 | B |
| Example 104 | E-28 | AD1 | 117 | HTM1 | ETM1 | R4 | 80 | A | A | 4.9 | A |
| Example 105 | E-29 | AD1 | 117 | HTM1 | ETM1 | R5 | 87 | A | A | 5.7 | B |
| Example 106 | E-30 | AD1 | 117 | HTM1 | ETM1 | R6 | 84 | A | A | 5.1 | B |
| Example 107 | E-31 | AD1 | 117 | HTM1 | ETM1 | R7 | 94 | B | A | 6.6 | B |
| Example 108 | E-32 | AD1 | 117 | HTM1 | ETM1 | R8 | 76 | A | A | 3.7 | A |
| Example 109 | E-33 | AD1 | 117 | HTM1 | ETM1 | R9 | 82 | A | A | 3.8 | A |
| Example 110 | E-34 | AD1 | 117 | HTM7 | ETM1 | R9 | 84 | A | A | 3.2 | A |
| Example 111 | E-35 | AD2 | 117 | HTM7 | ETM1 | R9 | 80 | A | A | 3.3 | A |
| Example 112 | E-36 | AD1 | 117 | HTM1 | ETM1 | R10 | 95 | B | A | 4.9 | A |
| Example 113 | E-37 | AD1 | 117 | HTM1 | ETM1 | R11 | 82 | A | A | 3.9 | A |
| Example 114 | E-38 | AD1 | 117 | HTM1 | ETM1 | R12 | 82 | A | A | 7.8 | B |
| Example 115 | E-39 | AD1 | 117 | HTM1 | ETM1 | R13 | 84 | A | A | 7.6 | B |

TABLE 25

| | | | | | | | | | High- | | |
|---|---|---|---|---|---|---|---|---|---|---|---|
| | Photo- | Additive | | | | | V1−V2 | | temperature | Abrasion resistance | |
| | sensitive | | Melting | | | | Value | | storability | Value | |
| | member | Type | point [° C.] | HTM | ETM | Resin | [V] | Evaluation | Evaluation | [mg] | Evaluation |
| Comparative | F-3 | AD1 | 117 | HTM1 | ETM32-C | R1 | 138 | C | A | 4.8 | A |
| Example 17 | | | | | | | | | | | |
| Comparative | F-4 | AD1 | 117 | HTM1 | ETM33-C | R1 | 129 | C | A | 4.9 | A |
| Example 18 | | | | | | | | | | | |
| Comparative | F-5 | AD1 | 117 | HTM1 | ETM34-C | R1 | 125 | C | A | 4.6 | A |
| Example 19 | | | | | | | | | | | |
| Comparative | F-6 | AD1 | 117 | HTM1 | ETM35-C | R1 | 124 | C | A | 4.5 | A |
| Example 20 | | | | | | | | | | | |
| Comparative | F-7 | AD1 | 117 | HTM1 | ETM36-C | R1 | 122 | C | A | 4.5 | A |
| Example 21 | | | | | | | | | | | |
| Comparative | F-8 | AD1 | 117 | HTM1 | ETM37-C | R1 | 131 | C | A | 4.7 | A |
| Example 22 | | | | | | | | | | | |
| Comparative | F-9 | AD1 | 117 | HTM1 | ETM1 | R14-C | 90 | B | A | 11.6 | C |
| Example 23 | | | | | | | | | | | |
| Comparative | F-10 | AD1 | 117 | HTM1 | ETM1 | R15-C | 82 | A | A | 10.2 | C |
| Example 24 | | | | | | | | | | | |

As shown in Table 15, the photosensitive layers of the photosensitive members (B-1) to (B-6) did not contain the electron transport material (1). As such, positive chargeability of each of the photosensitive members (B-1) to (B-6) when positive charging and negative charging alternately transition was poor and evaluated as C as shown in Table 15.

The photosensitive layers of the photosensitive members (B-7) and (B-8) did not contain the polycarbonate resin (PC) as shown in Table 15. Specifically, in the polycarbonate resins (R14-C) and (R15-C) respectively contained in the photosensitive layers of the photosensitive members (B-7) and (B-8), the end groups each were not the first end group having a halogen atom when n in general formula (10) represents 100. As such, abrasion resistance of each of the photosensitive members (B-7) and (B-8) was poor and evaluated as C as shown in Table 15.

By contrast, as shown in Tables 12 to 14, the photosensitive layers of the photosensitive members (A-1) to (A-33) contained the electron transport material (1) (more specifically, the electron transport material (ETM1), (ETM2), (ETM6), (ETM7), (ETM8), (ETM19), (ETM22), (ETM23), (ETM24), (ETM28), or (ETM29)) and the polycarbonate resin (PC) (more specifically, any one of the polycarbonate resins (R1) to (R13)). As such, positive chargeability of each of the photosensitive members (A-1) to (A-33) when positive charging and negative charging alternately transition was good and evaluated as A or B. Furthermore, abrasion resistance of each of the photosensitive members (A-1) to (A-33) was good and evaluated as A or B.

As shown in Table 18, the photosensitive layers of the photosensitive members (D-2) to (D-7) did not contain the electron transport material (1). As such, positive chargeability of each of the photosensitive members (D-2) to (D-7) when positive charging and negative charging alternately transition was poor and evaluated as C as shown in Table 21.

As shown in Table 18, the photosensitive layers of the photosensitive members (D-8) and (D-9) did not contain the polycarbonate resin (PC). Specifically, in the polycarbonate resins (R14-C) and (R15-C) respectively contained in the photosensitive layers of the photosensitive members (D-8) and (D-9), the end groups each were not the first end group having a halogen atom when n in general formula (10) represents 100. As such, abrasion resistance of each of the photosensitive members (D-8) and (D-9) was poor and evaluated as C as shown in Table 21.

By contrast, as shown in Tables 16 and 17, the photosensitive layers of the photosensitive members (C-1) to (C-43) contained the electron transport material (1) (more specifically, the electron transport material (ETM1), (ETM2), (ETM6), (ETM7), (ETM8), (ETM19), (ETM22), (ETM23), (ETM24), (ETM28), or (ETM29)) and the polycarbonate resin (PC) (more specifically, any one of the polycarbonate resins (R1) to (R13)). As such, positive chargeability of each of the photosensitive members (C-1) to (C-43) when positive charging and negative charging alternately transition was good and evaluated as A or B. Furthermore, abrasion resistance of each of the photosensitive members (C-1) to (C-43) was good and evaluated as A or B.

As shown in Table 25, the photosensitive layers of the photosensitive members (F-3) to (F-8) did not contain the electron transport material (1). As such, positive chargeability of each of the photosensitive members (F-3) to (F-8) when positive charging and negative charging alternately transition was poor and evaluated as C as shown in Table 25.

As shown in Table 25, the photosensitive layers of the photosensitive members (F-9) and (F-10) did not contain the polycarbonate resin (PC). Specifically, in the polycarbonate resins (R14-C) and (R15-C) respectively contained in the photosensitive layers of the photosensitive members (F-9) and (F-10), the end groups each were not the first end group having a halogen atom when n in general formula (10) represents 100. As such, abrasion resistance of each of the photosensitive members (F-9) and (F-10) was poor and evaluated as C as shown in Table 25.

By contrast, as shown in Tables 22 to 24, the photosensitive layers of the photosensitive members (E-1) to (E-39) contained the electron transport material (1) (more specifically, the electron transport material (ETM1), (ETM2), (ETM6), (ETM7), (ETM8), (ETM19), (ETM22), (ETM23), (ETM24), (ETM28), or (ETM29)) and the polycarbonate resin (PC) (more specifically, any one of the polycarbonate resins (R1) to (R13)). As such, abrasion resistance and positive chargeability of each of the photosensitive members (C-1) to (C-39) when positive charging and negative charging alternately transition were good and evaluated as A or B.

From the above, it was demonstrated that the photosensitive member according to the present disclosure, which encompasses the photosensitive members (A-1) to (A-33), (C-1) to (C-43), and (E-1) to (E-39), can be favorably charged to the positive polarity even when negative charging and positive charging alternately transition, and have excellent abrasion resistance. Furthermore, it can be accordingly determined that the process cartridge and the image forming apparatus according to the present disclosure each including a photosensitive member such as above can favorably form images.

What is claimed is:

1. An electrophotographic photosensitive member comprising:
a conductive substrate and a photosensitive layer, wherein
the photosensitive layer is a single layer, and contains a charge generating material, an electron transport material, a binder resin, and a hole transport material,
the electron transport material includes a compound represented by general formula (1), and
the binder resin includes a polycarbonate resin having an end group and a main chain represented by general formula (10), 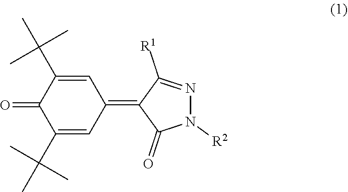
where in the general formula (1), R¹ and R² each represent, independently of one another, a hydrogen atom, an alkyl group, a heterocyclic group, an alkoxy group, an aralkyl group, an allyl group, or an aryl group optionally substituted with at least 1 and no more than 5 substituents selected from the group consisting of a halogen atom, an alkyl group, and an alkoxy group, 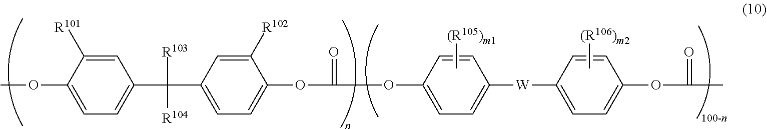
in the general formula (10),
R¹⁰¹, R¹⁰², R¹⁰³, and R¹⁰⁴ each represent, independently of one another, a hydrogen atom, an alkyl group having a carbon number of at least 1 and no greater than 3 that is optionally substituted with a halogen atom, or an aryl group having a carbon number of at least 6 and no greater than 14,
R¹⁰³ and R¹⁰⁴ may be bonded to each other to represent a bivalent group represented by general formula (X),
R¹⁰⁵ and R¹⁰⁶ each represent an alkyl group having a carbon number of at least 1 and no greater than 3,
m1 and m2 each represent, independently of one another, 0 or 1,
W represents a single bond, —O—, or —CO—,
n represents a number of greater than 0 and no greater than 100,
when n represents 100, the end group is a first end group having a halogen atom, and
when n represents a number of greater than 0 and less than 100, the end group is the first end group having a halogen atom or a second end group having no halogen atom, and 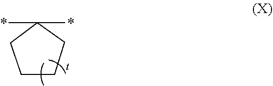
where in the general formula (X), t represents an integer of at least 1 and no greater than 3.

2. The electrophotographic photosensitive member according to claim 1, wherein
the compound represented by the general formula (1) is a compound represented by chemical formula (ETM1), (ETM2), (ETM6), (ETM7), (ETM8), (ETM19), (ETM22), (ETM23), (ETM24), (ETM28), or (ETM29),

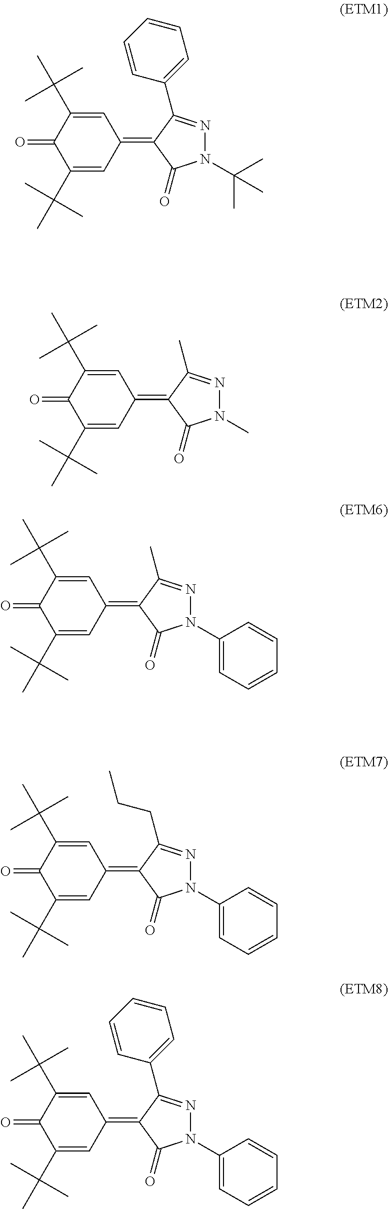

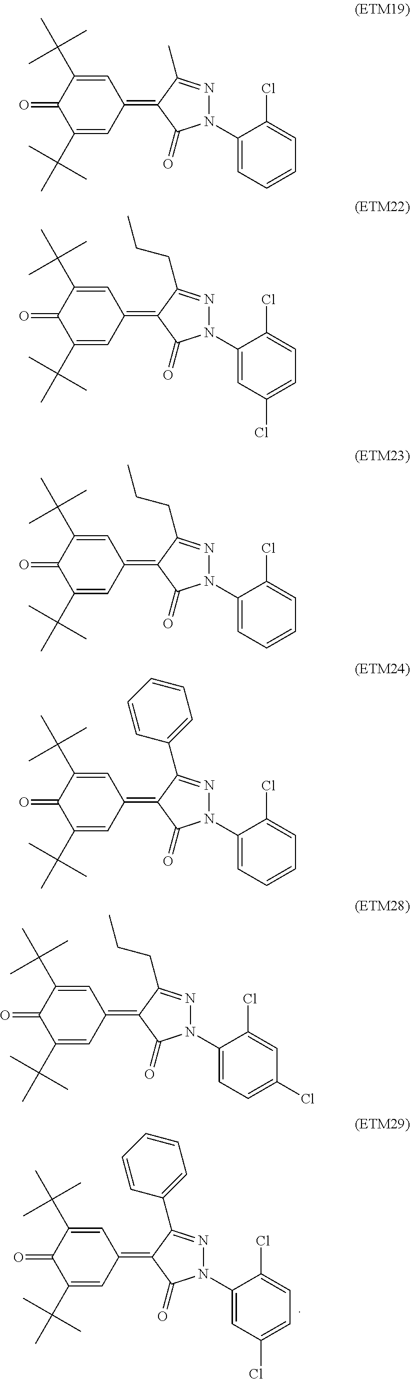

3. The electrophotographic photosensitive member according to claim 1, wherein
the end group is the first end group, and
the halogen atom of the first end group is a fluorine atom.

4. The electrophotographic photosensitive member according to claim 1, wherein
the end group is the first end group, and
the first end group is an end group represented by general formula (T1), 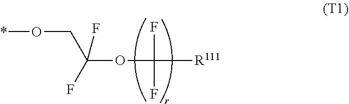
where in the general formula (T1), R¹¹¹ represents a hydrogen atom, a fluorine atom, or a methyl group, and r represents an integer of at least 1 and no greater than 10.

5. The electrophotographic photosensitive member according to claim 1, wherein
the end group is the first end group, and
the first end group is an end group represented by general formula (T2), 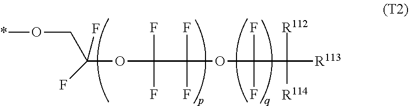
where in the general formula (T2), R¹¹², R¹¹³, and R¹¹⁴ each represent, independently of one another, a hydrogen atom, a fluorine atom, a methyl group, or a trifluoromethyl group, and p and q each represent, independently of one another, an integer of at least 1 and no greater than 10.

6. The electrophotographic photosensitive member according to claim 1, wherein
the main chain is a main chain represented by general formula (10-1), (10-2), or (10-3),
the end group is the first end group, and
the first end group is an end group represented by chemical formula (T2-1), 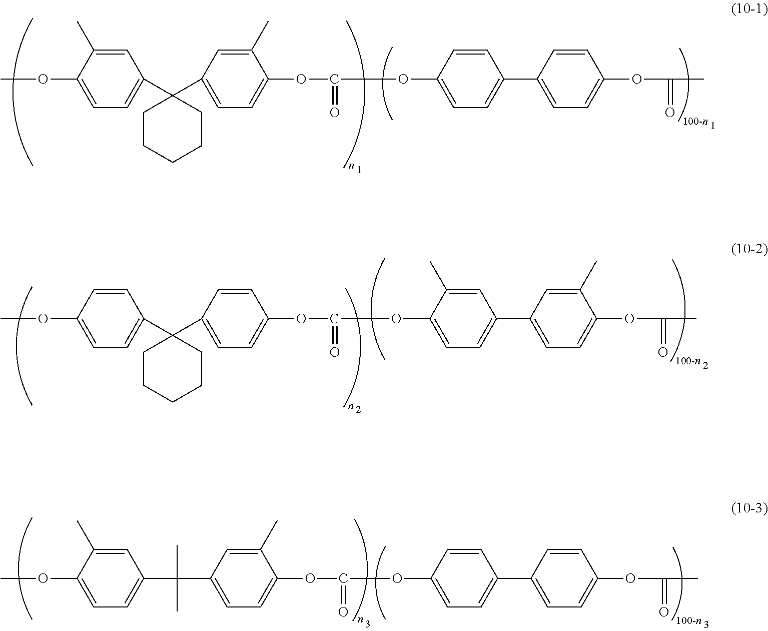
where in the general formula (10-1), n₁ represents a number of greater than 0 and less than 100, in the general formula (10-2), n₂ represents a number of greater than 0 and less than 100, and in general formula (10-3), n₃ represents a number of greater than 0 and less than 100,

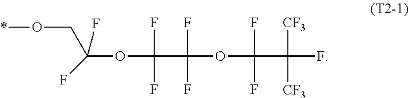

7. The electrophotographic photosensitive member according to claim 1, wherein
the main chain is a main chain represented by general formula (10-1), and
the end group is the first end group, the first end group being an end group represented by chemical formula (T1-1), 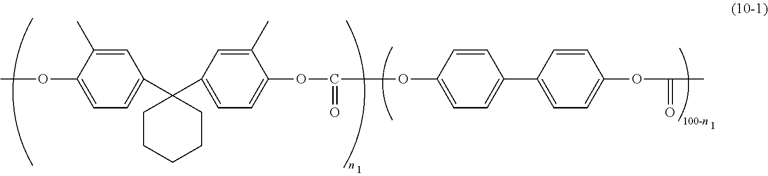
where in the general formula (10-1), n₁ represents a number of greater than 0 and less than 100,

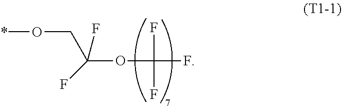

8. The electrophotographic photosensitive member according to claim 1, wherein
the main chain is a main chain represented by general formula (10-1), (10-2), (10-4), (10-5), or (10-6), and
the end group is the second end group, the second end group being an end group represented by chemical formula (T3), 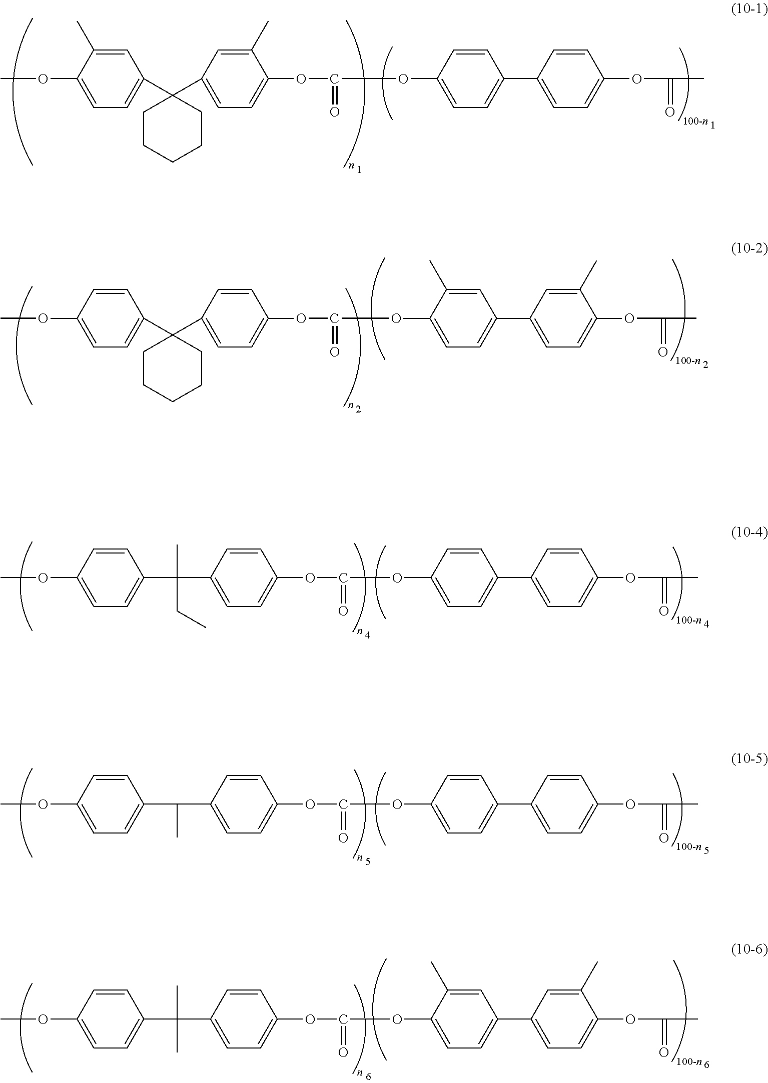
where in the general formula (10-1), n₁ represents a number of greater than 0 and less than 100, in the general formula (10-2), n₂ represents a number of greater than 0 and less than 100, in the general formula (10-4), n₄ represents a number of greater than 0 and less than 100, in the general formula (10-5), n₅ represents a number of greater than 0 and less than 100, and in the general formula (10-6), n₆ represents a number of greater than 0 and less than 100,

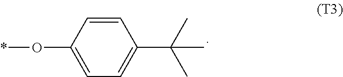

9. The electrophotographic photosensitive member according to claim 1, wherein
the photosensitive layer further contains an n-type pigment.

10. The electrophotographic photosensitive member according to claim 9, wherein
the n-type pigment includes an azo pigment, the azo pigment being a compound represented by chemical formula (A1), (A2), (A3), (A4), or (A5); or
the n-type pigment includes a perylene pigment, the perylene pigment being a compound represented by chemical formula (P1), (P2), (P3), or (P4); or
the n-type pigment includes an isoindoline pigment, the isoindoline pigment being a compound represented by chemical formula (I1) or (I2),

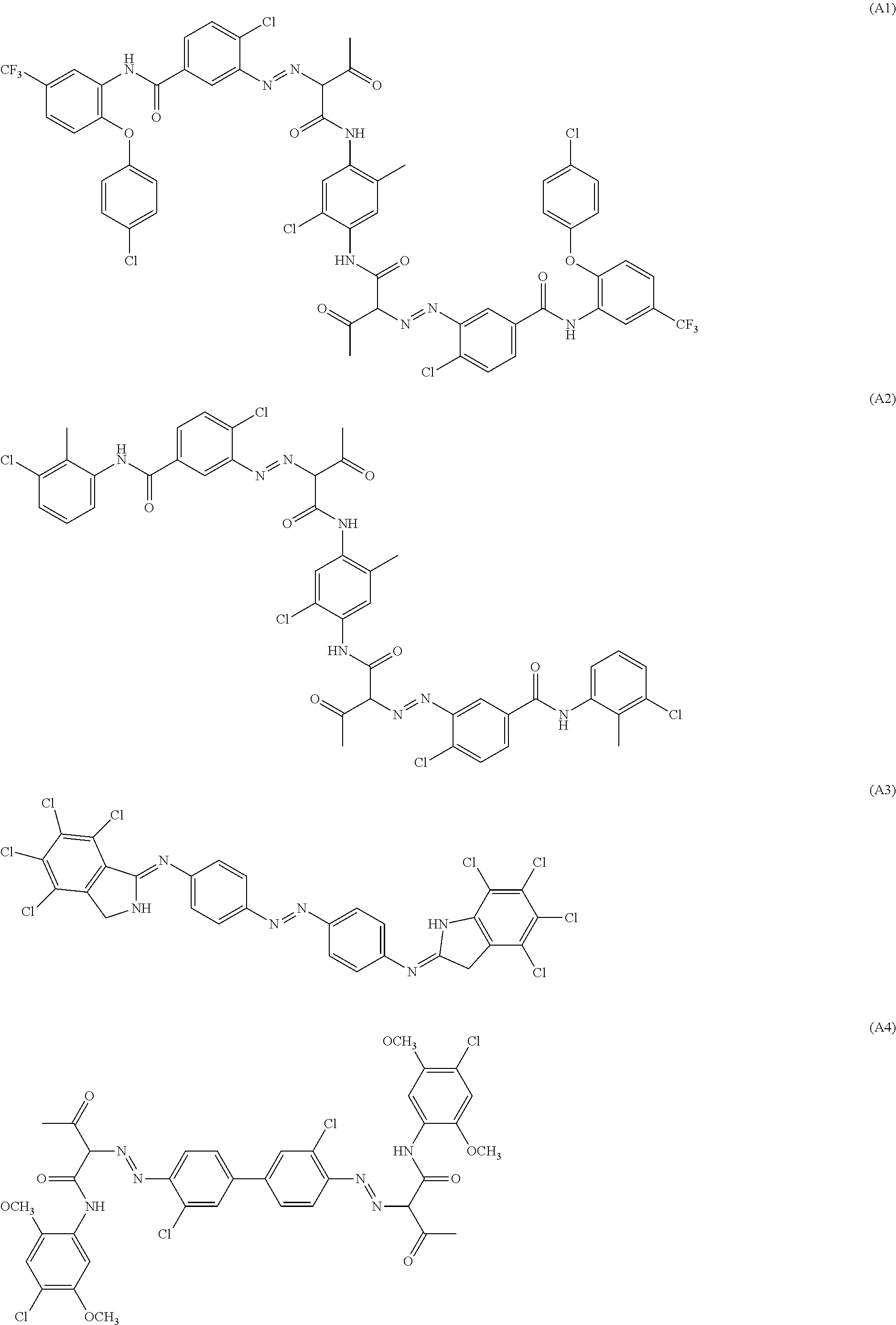 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C ; Clc1c(Cl)c(Cl)c2c(c1Cl)C/C(=N/c1ccc(/N=N/c3ccc(/N=C4\NCc5c(Cl)c(Cl)c(Cl)c(Cl)c54)cc3)cc1)N2 ; COc1cc(NC(=O)C(/N=N/c2ccc(-c3ccc(/N=N/C(C(C)=O)C(=O)Nc4cc(OC)c(Cl)cc4OC)c(Cl)c3)cc2Cl)C(C)=O)c(OC)cc1Cl]

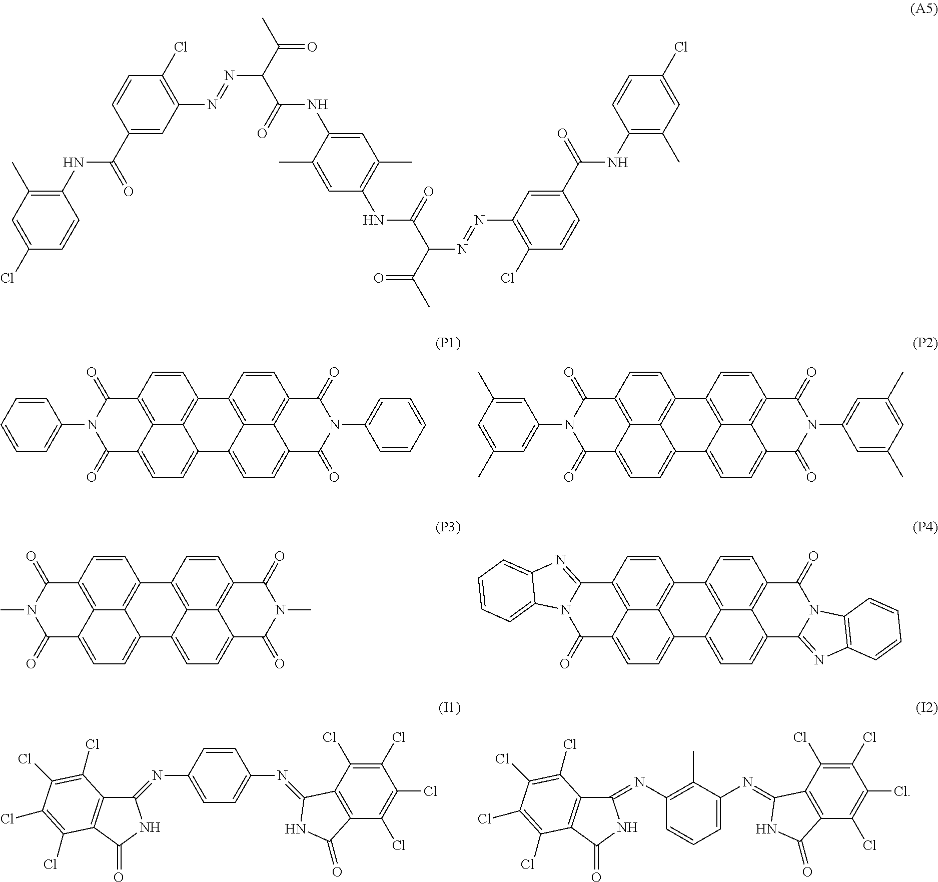

11. The electrophotographic photosensitive member according to claim 1, wherein
the photosensitive layer further contains an additive, the additive being a compound represented by general formula (31), (32), or (33), 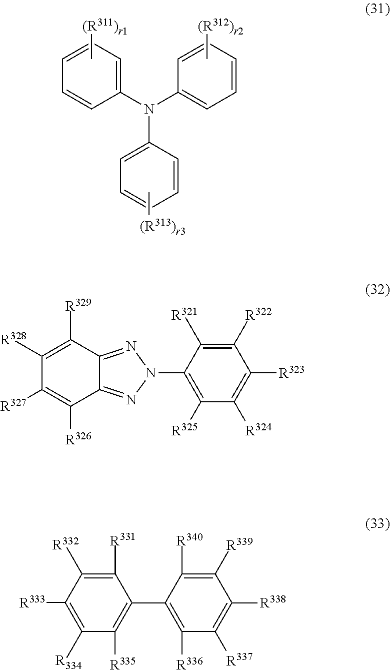
where in the general formula (31), R³¹¹, R³¹², and R³¹³ each represent, independently of one another, an alkyl group having a carbon number of at least 1 and no greater than 6 or an alkoxy group having a carbon number of at least 1 and no greater than 6, and r1, r2, and r3 each represent, independently of one another, an integer of at least 0 and no greater than 5,
in the general formula (32), R³²¹, R³²², R³²³, R³²⁴, R³²⁵, R³²⁶, R³²⁷, R³²⁸, and R³²⁹ each represent, independently of one another, a hydrogen atom, a hydroxy group, a halogen atom, or an alkyl group having a carbon number of at least 1 and no greater than 6, and
in the general formula (33), R³³¹, R³³⁵, R³³⁶, and R³⁴⁰ each represent, independently of one another, a hydrogen atom, a nitro group, or an alkyl group having a carbon number of at least 1 and no greater than 6 that is optionally substituted with an aryl group having a carbon number of at least 6 and no greater than 14, and R³³², R³³³, R³³⁴, R³³⁷, R³³⁸, and R³³⁹ each represent, independently of one another, a hydrogen atom, a nitro group, an alkyl group having a carbon number of at least 1 and no greater than 6 that is optionally substituted with an aryl group having a carbon number of at least 6 and no greater than 14, or an aryl group having a carbon number of at least 6 and no greater than 14.

12. The electrophotographic photosensitive member according to claim 11, wherein
the compound represented by the general formula (31) is a compound represented by chemical formula (AD1) or (AD6),
the compound represented by the general formula (32) is a compound represented by chemical formula (AD2) or (AD3), and
the compound represented by the general formula (33) is a compound represented by chemical formula (AD4) or (AD5),

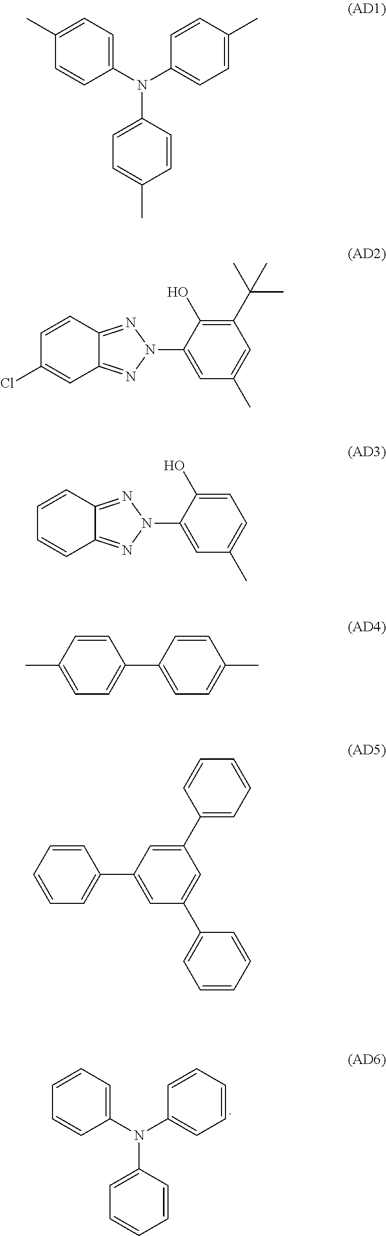

13. The electrophotographic photosensitive member according to claim 11, wherein
the additive has a melting point of at least 90° C. and no higher than 300° C.

14. The electrophotographic photosensitive member according to claim 1, wherein
the hole transport material includes a compound represented by general formula (21), (22), (23), (24), (25), (26), or (27), 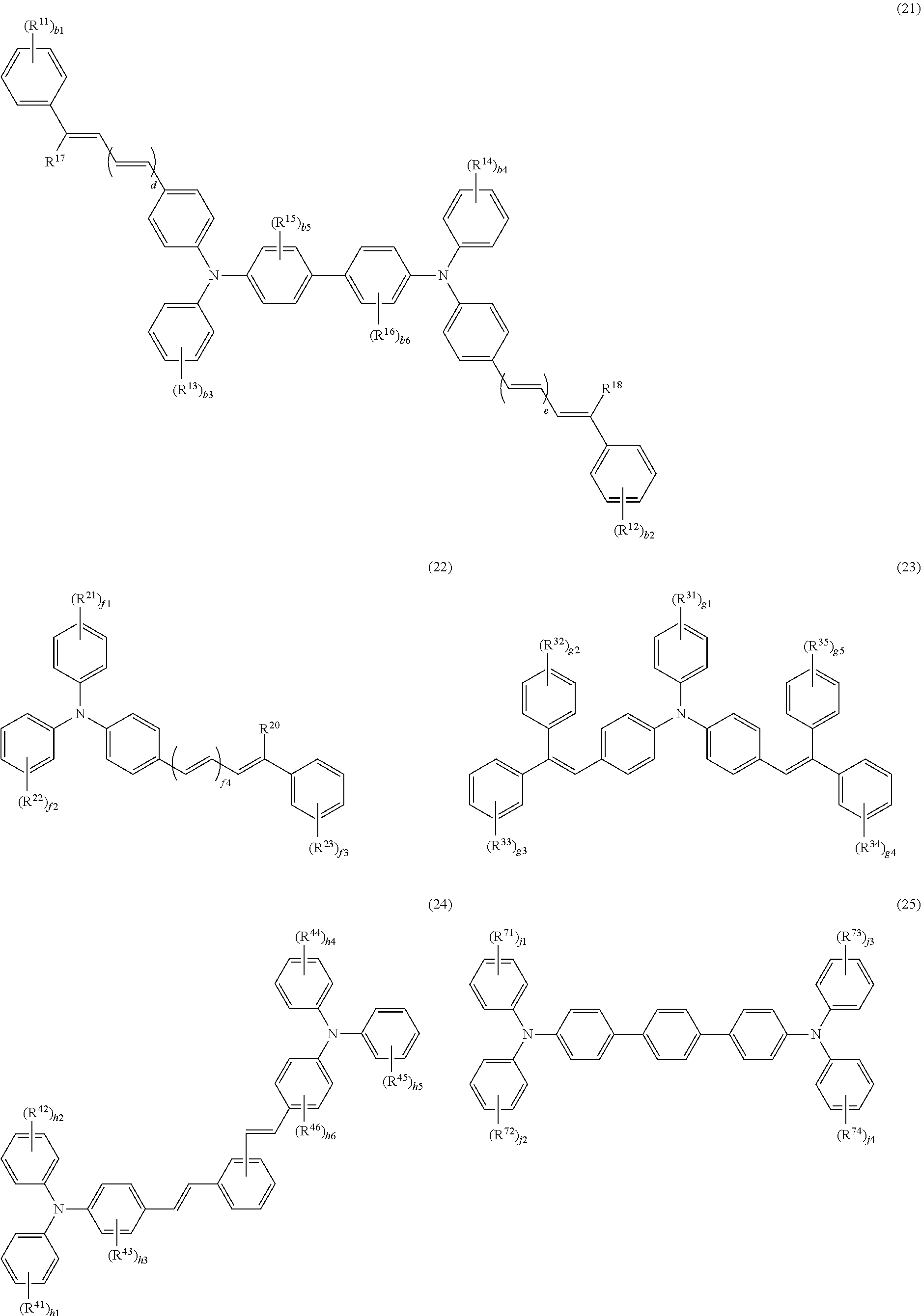 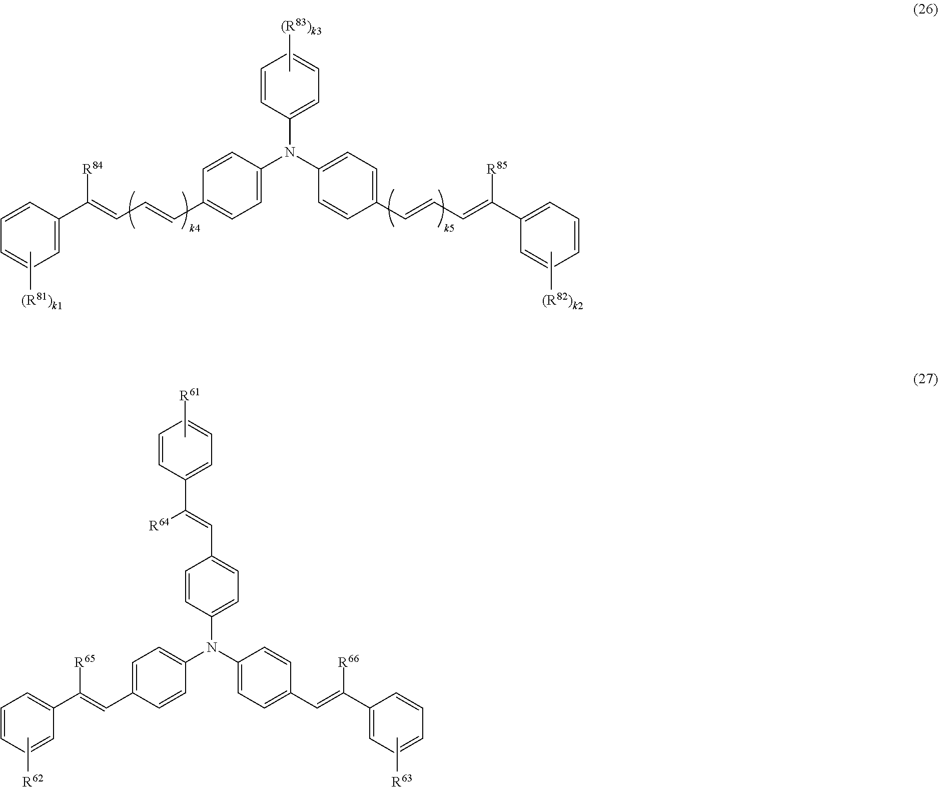
where in the general formula (21), R¹¹, R¹², R¹³, R¹⁴, R¹⁵, and R¹⁶ each represent, independently of one another, a phenyl group or an alkyl group having a carbon number of at least 1 and no greater than 8, R¹⁷ and R¹⁸ each represent, independently of one another, a hydrogen atom, a phenyl group, or an alkyl group having a carbon number of at least 1 and no greater than 8, b1, b2, b3, and b4 each represent, independently of one another, an integer of at least 0 and no greater than 5, b5 and b6 each represent, independently of one another, an integer of at least 0 and no greater than 4, and d and e each represent, independently of one another, 0 or 1,
in the general formula (22), R²⁰ represents a hydrogen atom, an alkyl group having a carbon number of at least 1 and no greater than 8, an alkoxy group having a carbon number of at least 1 and no greater than 8, or a phenyl group optionally substituted with an alkyl group having a carbon number of at least 1 and no greater than 8, R²¹, R²², and R²³ each represent, independently of one another, an alkyl group having a carbon number of at least 1 and no greater than 8 or an alkoxy group having a carbon number of at least 1 and no greater than 8, f1, f2, and f3 each represent, independently of one another, an integer of at least 0 and no greater than 5, and f4 represents 0 or 1,
in the general formula (23), R³¹, R³², R³³, R³⁴, and R³⁵ each represent, independently of one another, an alkyl group having a carbon number of at least 1 and no greater than 8 or alkoxy group having a carbon number of at least 1 and no greater than 8, and g1, g2, g3, g4, and g5 each represent, independently of one another, an integer of at least 0 and no greater than 5,
in the general formula (24), R⁴¹, R⁴², R⁴³, R⁴⁴, R⁴⁵, and R⁴⁶ each represent, independently of one another, a phenyl group, an alkyl group having a carbon number of at least 1 and no greater than 8, or an alkoxy group having a carbon number of at least 1 and no greater than 8, h1, h2, h4, and h5 each represent, independently of one another, an integer of at least 0 and no greater than 5, and h3 and h6 each represent, independently of one another, an integer of at least 0 and no greater than 4,
in the general formula (25), R⁷¹, R⁷², R⁷³, and R⁷⁴ each represent, independently of one another, an alkyl group having a carbon number of at least 1 and no greater than 8, and j1, j2, j3, and j4 each represent, independently of one another, an integer of at least 0 and no greater than 5,
in the general formula (26), R⁸¹, R⁸², and R⁸³ each represent, independently of one another, a phenyl group, an alkyl group having a carbon number of at least 1 and no greater than 8, or an alkoxy group having a carbon number of at least 1 and no greater than 8, R⁸⁴ and R⁸⁵ each represent, independently of one another, a hydrogen atom, a phenyl group optionally substituted with an alkyl group having a carbon number of at least 1 and no greater than 8, an alkyl group having a carbon number of at least 1 and no greater than 8, or an alkoxy group having a carbon number of at least 1 and no greater than 8, k1, k2, and k3 each represent, independently of one another, an integer of at least 0 and no greater than 5, and k4 and k5 each represent, independently of one another, 1 or 2, and
in the general formula (27), R⁶¹, R⁶², and R⁶³ each represent, independently of one another, an alkyl group having a carbon number of at least 1 and no greater than 8, and R⁶⁴, R⁶⁵, and R⁶⁶ each represent, independently of one another, a hydrogen atom or an alkyl group having a carbon number of at least 1 and no greater than 8.

15. The electrophotographic photosensitive member according to claim 1, wherein
the hole transport material includes a compound represented by chemical formula (HTM1), (HTM2), (HTM3), (HTM4), (HTM5), (HTM6), (HTM7), (HTM8), (HTM9), or (HTM10),

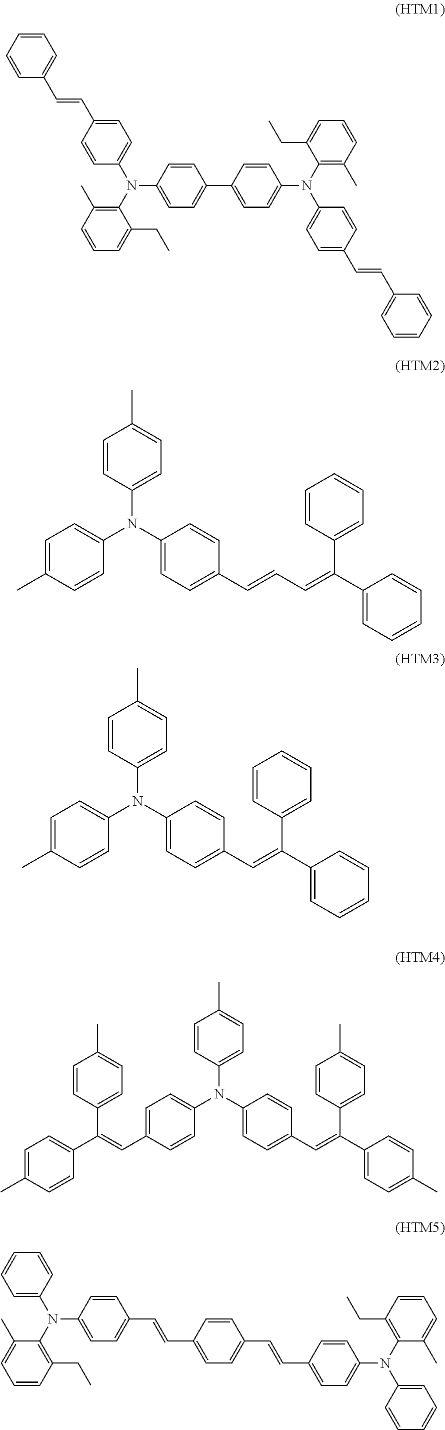

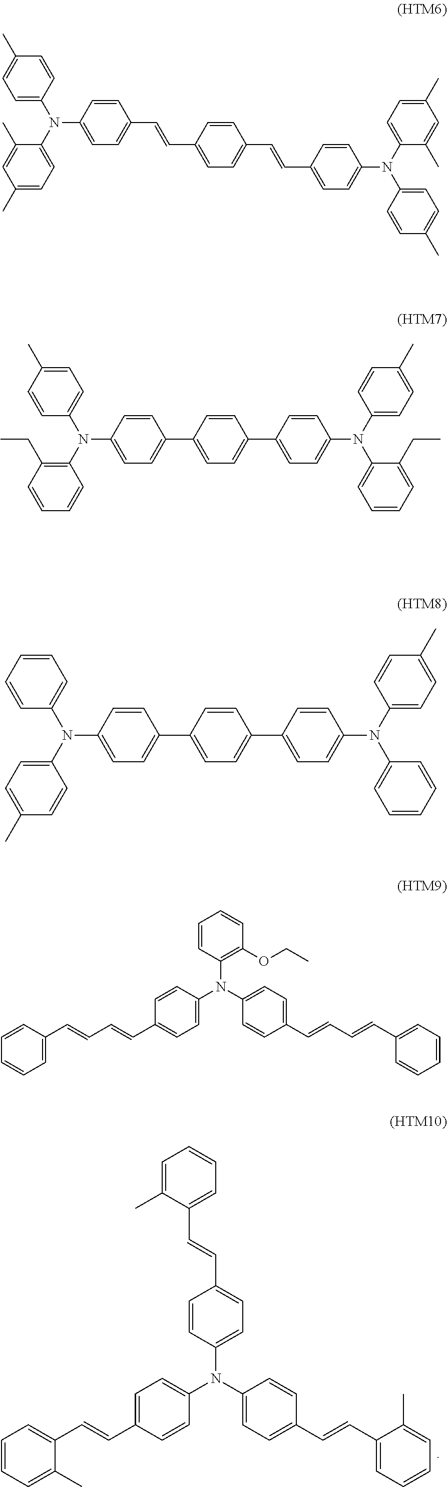

16. The electrophotographic photosensitive member according to claim 1, wherein
the charge generating material includes titanyl phthalocyanine having a Y-form crystal structure.

17. A process cartridge comprising:
at least one selected from the group consisting of a charger, a light exposure device, a development device, a transfer device, a cleaning member, and a static eliminator; and
the electrophotographic photosensitive member according to claim 1.

18. An image forming apparatus comprising:
an image bearing member;
a charger configured to charge a surface of the image bearing member to a positive polarity;
a light exposure device configured to expose the charged surface of the image bearing member to light to form an electrostatic latent image on the surface of the image bearing member;
a development device configured to develop the electrostatic latent image into a toner image; and
a transfer device configured to transfer the toner image from the image bearing member to a transfer target, wherein
the image bearing member is the electrophotographic photosensitive member according to claim 1.

19. The image forming apparatus according to claim 18, further comprising:
a cleaning member configured to collect toner attached to the surface of the image bearing member by being in contact with the surface of the image bearing member; and
a controller configured to control voltage to be applied to the cleaning member, wherein
the controller cause application of a negative first voltage to the cleaning member in a printing mode.

20. The image forming apparatus at claim 19, wherein
the controller causes application of a positive second voltage to a cleaning member in a cleaning mode.
